(19) United States
(12) Patent Application Publication
(10) Pub. No.: US 2022/0008867 A1
(43) Pub. Date: Jan. 13, 2022

(54) MEMBRANES FOR FORWARD OSMOSIS AND MEMBRANE DISTILLATION AND PROCESS OF TREATING FRACKING WASTEWATER

(71) Applicant: VALORBEC, S.E.C., Montréal (CA)

(72) Inventors: Saifur RAHAMAN, Montréal (CA); Tiantian CHEN, Montréal (CA); Md. Shahidul ISLAM, Montréal (CA); Wen MA, Montréal (CA)

(21) Appl. No.: 17/250,871

(22) PCT Filed: Sep. 18, 2019
(86) PCT No.: PCT/CA2019/051324

§ 371 Date: Mar. 16, 2021

Related U.S. Application Data
(60) Provisional application No. 62/732,781, filed on Sep. 18, 2018.

(51) Int. Cl. B01D 61/58; B01D 61/36; B01D 71/02; B01D 69/02; B01D 61/00; B01D 67/00; C02F 9/00; B01D 61/14

(52) U.S. Cl. CPC B01D 61/58; B01D 61/364; B01D 71/021; B01D 69/02; C02F 2103/10; B01D 67/0079; C02F 9/00; B01D 61/145; B01D 61/147; B01D 61/005

(57) ABSTRACT

Membranes for membrane distillation (MD) and forward osmosis (FO) are provided with methods of manufacture and use thereof. The MD membrane comprises a microporous mat of electrospun nanofibers made of a nanocomposite comprising reduced graphene oxide dispersed in a hydrophobic polymer with their surface grafted with a silane coupling agent or with hydrophobic nanoparticles. The FO membrane comprises a microporous support layer and a rejection layer formed on one side of the support layer, wherein the support layer is a microporous mat of electrospun nanofibers made of a nanocomposite of hydrophilic nanoparticles dispersed in a hydrophilic polymer, and the rejection layer is made of nanocomposite of hydrophilic nanoparticles dispersed in a crosslinked meta-aramid of formula (I). There is also provided a process for treating a high-salinity and/or high-strength feed, such as fracking wastewater, comprising microfiltration or ultrafiltration, followed by forward osmosis, and then membrane distillation.

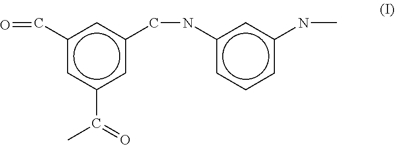

### CROSS REFERENCE TO RELATED APPLICATIONS

This application claims benefit, under 35 U.S.C. § 119(e), of U.S. provisional application Ser. No. 62/732,781, filed on Sep. 18, 2018. All documents above are incorporated herein in their entirety by reference.

### FIELD OF THE INVENTION

The present invention relates to a membrane for membrane distillation, a membrane for forward osmosis, and a process for treating a high salinity feed. More specifically, the present invention is concerned with a membrane for membrane distillation comprising a microporous surface-modified mat of electrospun nanocomposite nanofibers; a thin film composite membrane for forward osmosis comprising a mat of electrospun nanocomposite nanofibers as a support layer and a nanocomposite rejection layer; and a process for treating a high salinity feed, such as fracking wastewater, combining microfiltration or ultrafiltration, followed by forward osmosis, and then followed by membrane distillation.

### BACKGROUND OF THE INVENTION

A massive source of natural gas, called “shale gas”, exists in pockets of underground porous rocks. Hydraulic fracturing made these underground porous rocks a viable natural gas source. Hydraulic fracturing, also called “fracking”, is a process comprising drilling and injecting fluid into the ground at high pressure in order to crack shale rocks, releasing the natural gas. In this process, a sand/water suspension and proppants (chemicals) are pumped, at high pressure, into the shale layer. As a result, natural gas is released and flows back up to the surface with the drilling fluids.

Currently shale gas is being produced in many regions of the United States. The production of shale gas through hydraulic fracturing has been criticized because of its negative environmental impacts and of the management implications of used hydraulic fracturing fluids, also known as “fracking wastewater”. High-salinity is the main characteristic of fracking wastewater, which contains different types of inorganic salts obtained from underground brines. Shale gas wastewater also contains dissolved organic compounds, oil, and sand. The discharge of such highly saline fracking wastewater is of great concern. The management of fracking wastewater is crucial to shale gas development and to the preservation of the environment and human health. A possible solution to these issues is to treat fracking wastewater before discharge/reuse. The treatment of highly saline fracking wastewater is both challenging and energy intensive.

On another subject, various desalination techniques are known in the art.

For example, forward osmosis (FO) is a desalination process in which a feed solution is treated by osmotic pressure rather than hydraulic pressure. The primary principle behind this process is osmosis, the natural diffusion of water (water flux) through a semi-permeable membrane from a low salinity feed solution into a high salinity draw solution due to the osmotic pressure gradient between these two solutions. This technique exploits the natural process of osmosis, which is the diffusion of salt due to different salinities on either side of a semi-permeable membrane. In contrast, the reverse osmosis process uses hydraulic pressure as the driving force for separation, which serves to counteract the osmotic pressure gradient that would otherwise favor water flux from the permeate to the feed. Hence significantly more energy is required for reverse osmosis compared to forward osmosis.

Another desalination technique is membrane distillation (MD), which is a thermally driven, membrane-based technology. MD is an emerging technology that utilizes low-grade heat or industrial waste-heat at a temperature of ˜50° C. to drive separation. MD is a thermally driven process in which water vapor transport occurs across a non-wetted microporous hydrophobic membrane. The driving force behind the MD process is the vapor pressure gradient, which is generated by a temperature difference across the membrane. Compared with reverse osmosis (RO) membrane process, which is the most popular water purification membrane technology, there is no need in MD to exert high operation pressure. Therefore, the energy cost of MD can be significantly reduced. In MD, a hydrophobic microporous membrane is used, which lets water vapors pass through, but repels liquid water. The driving force in MD is the vapor pressure gradient across the membrane derived from temperature difference between the hot feed and cold permeate streams. Low working temperature (30-80° C.) distinguishes MD from conventional thermal distillation, making it possible to utilize low-grade heat such as waste heat or solar thermal energy.

Despite such attractive advantages, MD is still in its embryonic stage and has not been widely applied in industrial and commercial development due to unresolved challenges. Membrane fouling and wetting are two major obstacles leading to MD operation failures when treating challenging wastewater sources. The potential membrane fouling and wetting constraint conventional hydrophobic MD membranes to the treatment of relatively clean feed solutions that are free of hydrophobic and amphiphilic substances. First, membrane fouling is a serious problem that affects MD performance and can cause major damage and costs, especially over long-term operation. The foulant layer formed on the hydrophobic membrane surface can block the membrane pores, and consequently cause significant decrease in water vapor flux and membrane wetting. Generally, humic acid, proteins and oily substances can easily attach on the membrane through hydrophobic-hydrophobic interaction. Moreover, deposition of inorganic species (scaling) on the membrane surface causes pores plugging. In addition to fouling, membrane wetting is another challenge that affects stable flux performance and salt rejection. Membrane wetting occurs when the feed liquids penetrate the pores, for example when the trans-membrane pressure exceeds the liquid entry pressure (LEP), which is affected by liquid surface tension, membrane hydrophobicity, pore size and pore shape. To avoid pore wetting, the hydrostatic pressure must be lower than the LEP. However, even though the operating pressure is lower than the LEP, MD membranes can be easily wetted by low surface tension contaminants (oil, alcohols, and surfactants) which are widely present in feeds, thus contaminating the distillate and undermining their rejection properties.

### SUMMARY OF THE INVENTION

In accordance with the present invention, there is provided:
1. A membrane for membrane distillation comprising a microporous mat of electrospun nanofibers,
   wherein the nanofibers are made of a nanocomposite comprising reduced graphene oxide dispersed in a hydrophobic polymer, and
   wherein the surface of the nanofibers is grafted with a silane coupling agent or with hydrophobic nanoparticles.
2. The membrane of embodiment 1, wherein the microporous mat has a surface presenting asperities and reentrant structures, the mat comprising the nanofibers randomly arranged in an interconnected open microporous structure.
3. The membrane of embodiment 1 or 2, being in the shape of a sheet, either flat or curved, preferably flat.
4. The membrane of any one of embodiments 1 to 3, wherein the hydrophobic polymer is polyvinylidene fluoride (PVDF), polytetrafluoroethylene (PTFE), polypropylene (PP), or poly (vinylidene fluoride-co-hexafluoropropylene) (PVDF-HFP), preferably poly (vinylidene fluoride-co-hexafluoropropylene) (PVDF-HFP).
5. The membrane of any one of embodiments 1 to 4, wherein the hydrophobic polymer has a molecular weight (Mw) of about 400 kDa.
6. The membrane of any one of embodiments 1 to 5, wherein the reduced graphene oxide is in the form of single-layer reduced graphene oxide nanosheets, preferably with a thickness of 0.7-1.2 nm and length of 300-800 nm.
7. The membrane of any one of embodiments 1 to 6, wherein the concentration of reduced graphene oxide in the nanocomposite is between about 0.15 and about 0.25 wt %, preferably about 0.15 wt %, based on the total weight of the nanocomposite.
8. The membrane of any one of embodiments 1 to 7, wherein the hydrophobic nanoparticles are titanium dioxide, silver, alumina, or silica nanoparticles, preferably silica nanoparticles, that have been surface-modified as needed to have a hydrophobic surface.
9. The membrane of embodiment 8, wherein the nanoparticles have been surface-modified by grafting a silane coupling agent on the surface of the nanoparticles.
10. The membrane of any one of embodiments 1 to 9, wherein the hydrophobic nanoparticles are silica nanoparticles with a silane coupling agent grafted on the surface of the silica nanoparticles.
11. The membrane of any one of embodiments 1 to 10, wherein the silane coupling agent, grafted on the surface of the nanofibers or on to the surface of the nanoparticles, is of formula Rₘ—Si—Xₙ, wherein:
   R is alkyl, alkenyl, haloalkyl, or haloalkenyl,
   X is alkoxy or halogen, and
   m and n are integers between 1 and 4, such that m+n=4.
12. The membrane of embodiment 11, wherein R is alkyl, alkenyl, perhaloalkyl, or perhaloalkenyl; preferably alkyl, alkenyl, perfluoroalkyl, or perfluoroalkenyl; more preferably alkyl, alkenyl, perhaloalkyl, and yet more preferably methyl, vinyl, or perfluorododecyl or perfluorododecyl.
13. The membrane of embodiment 11 or 12, wherein X is methoxy, ethyoxy or chloro.
14. The membrane of any one of embodiments 11 to 13, wherein m is 1 or 2 and n is 2 or 3, preferably m is 1 and n is 3.
15. The membrane of any one of embodiments 1 to 14, wherein the silane coupling agent, grafted on the surface of the nanofibers or on to the surface of the nanoparticles, is a haloalkyltrialkoxysilane, a dialkyldihalosilane, alkenyltrialkoxysilane, or alkyltrialkoxysilane, preferably a haloalkyltrialkoxysilane, and more preferably a perhaloalkyltrialkoxysilane.
16. The membrane of any one of embodiments 1 to 15, wherein the silane coupling agent is perfluorooctyltriethoxysilane (POTS), dimethyldichlorosilane (DDS), vinyltrimethoxysilane (VTS), methyltriethoxysilane (MTES), perfluorododecyltrichlorosilane, or perfluorodecyltrimethoxysilane, preferably perfluorooctyltriethoxysilane.
17. A method of manufacturing the membrane for membrane distillation of any one of embodiments 1 to 16, the method comprising:
   a) electrospinning a dope solution of the hydrophobic polymer in which the reduced graphene oxide is suspended to produce the mat of electrospun nanofibers, and
   b) grafting the silane coupling agent or the hydrophobic nanoparticles on the surface of the nanofibers.
18. The method of embodiment 17, further comprising before step a), the step of preparing the dope solution by:
   dissolving the hydrophobic polymer in a solvent,
   separately, suspending the reduced graphene oxide in a solvent, preferably the same solvent as the hydrophobic polymer solution, and
   mixing together the reduced graphene oxide suspension and the hydrophobic polymer solution.
19. The method of embodiment 17 or 18, wherein step b) comprises:
   immersing the mat of electrospun nanofibers in a solution of the silane coupling agent or in a suspension of the hydrophobic nanoparticles and allowing grafting on the surface of the nanofibers,
   rinsing, and
   heating to complete grafting on the surface of the nanofibers.
20. The method of embodiment 19, further comprising before step b), the step of preparing the suspension of hydrophobic surface-modified nanoparticles by:
   providing a suspension of nanoparticles,
   adding the silane coupling agent to the suspension, and
   allowing the grafting of the silane coupling agent to the nanoparticles.
21. A membrane distillation process comprising the steps of:
   a) providing a membrane for membrane distillation as defined in any one of embodiments 1 to 16,
   b) contacting a heated feed containing water with the membrane, thereby causing diffusion of water vapor from the feed through the membrane into a condensation chamber, and
   c) condensing the water vapor in the condensation chamber.
22. A forward osmosis membrane comprising a microporous support layer and a rejection layer formed on one side of the support layer,
   wherein the support layer is a microporous mat of electrospun nanofibers,
   wherein the nanofibers are made of a nanocomposite of hydrophilic nanoparticles dispersed in a hydrophilic polymer, and
   wherein the rejection layer is made of nanocomposite of hydrophilic nanoparticles dispersed in a crosslinked meta-aramid of formula (I):

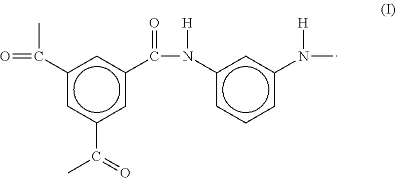

23. The forward osmosis membrane of embodiment 22, wherein the rejection layer is interfacially polymerized on the support membrane.
24. The forward osmosis membrane of embodiment 22 or 23, being in the shape of a sheet, either flat or curved, preferably flat.
25. The forward osmosis membrane of any one of embodiments 22 to 24, wherein the support layer has a porosity of more than 90%, preferably of about 95%.
26. The forward osmosis membrane of any one of embodiments 22 to 25, wherein the hydrophilic polymer is polyacrylic acid, polyvinyl alcohol, nylon 6, nylon 6.6, a protein, cellulose, a polyethylene glycol ether, or a polyacrylic amide, preferably nylon 6, more preferably a semi-crystalline nylon 6 polymer containing crystals of nylon 6 α and γ-forms.
27. The forward osmosis membrane of any one of embodiments 22 to 26, wherein the concentration of hydrophilic nanoparticles in the nanocomposite with the hydrophilic polymer is between 10 wt % and 20 wt %, preferably of about 20 wt %, based on the total weight of the nanocomposite.
28. The forward osmosis membrane of any one of embodiments 22 to 27, wherein the concentration of hydrophilic nanoparticles in the nanocomposite with the crosslinked meta-aramid of formula (I) is between 1 wt % and 6 wt %, preferably of about 4 wt %, based on the total weight of the nanocomposite.
29. The forward osmosis membrane of any one of embodiments 22 to 28, wherein the hydrophilic nanoparticles are graphene oxide, montmorillonite, carboxylated gold, carboxylated silver, zinc oxide, titanium dioxide, or silica nanoparticles, preferably silica nanoparticles.
30. The forward osmosis membrane of any one of embodiments 22 to 29, wherein the hydrophilic nanoparticles range in size from about 10 to about 80 nm.
31. A method of manufacture of the forward osmosis membrane of any one of embodiments 22 to 30, the method comprising:
   a) electrospinning a dope solution of the hydrophilic polymer in which the hydrophilic nanoparticles are suspended, thereby forming the support layer, and
   b) forming the rejection layer on one side of the support layer by interfacial polymerization of one or more aromatic di- or polyfunctional amines and one or more aromatic di- or polyfunctional acyl chlorides in the presence of the hydrophilic nanoparticles.
32. The method of embodiment 31, further comprising before step a), the step of preparing the dope solution by:
   dissolving the hydrophilic polymer in a solvent,
   separately, suspending the hydrophilic nanoparticles in a solvent, preferably the same solvent as the hydrophilic polymer solution, and
   mixing together the hydrophilic nanoparticles suspension and the hydrophilic polymer solution.
33. The method of embodiment 31 or 32, wherein step b) comprises,
   b.1) protecting one side and the edges of the support layer,
   b.2) immersing the protected support layer in a solution of a first monomer precursor of the meta-aramid of formula (I), for example one or more aromatic di- or polyfunctional amines, preferably m-phenylenediamine (MPD), in which the hydrophilic nanoparticles are suspended,
   b.3) withdrawing the protected support layer from the solution of the first monomer and removing any excess solution,
   b.4) immersing the protected support layer in a solution of a second monomer precursor of the meta-aramid of formula (I), for example one or more aromatic di- or polyfunctional acyl chlorides, preferably 1,3,5-benzenetricarbonyl trichloride (TMC),
   b.5) withdrawing the protected support layer from the solution of the second monomer and removing any excess solution, and
   b.6) heating the support layer to complete the crosslinking of the meta-aramid of formula (I).
34. A forward osmosis process comprising the steps of:
   a) providing a forward osmosis membrane as defined in any one of embodiments 22 to 30, the forward osmosis membrane having an active layer side and a support layer side,
   b) contacting a feed containing water with the rejection layer side of the forward osmosis membrane, and
   c) contacting a draw solution having a salinity higher than the salinity of the feed with the support layer side of the forward osmosis membrane, thereby causing diffusion of water from the feed through the forward osmosis membrane into the draw solution.
35. The forward osmosis process further comprising a step of separating water from the diluted draw solution resulting from step c).
36. A process for treating a high-salinity and/or high-strength feed, such as fracking wastewater, comprising:
   a) subjecting the high-salinity and/or high-strength feed to microfiltration or ultrafiltration to produce a pre-treated feed as a filtrate,
   b) subjecting the pre-treated feed to forward osmosis using a draw solution to produce a water-diluted draw solution, and
   c) subjecting the water-diluted draw solution to membrane distillation to produce water and regenerate the draw solution.
37. The process of embodiment 36, wherein step a) comprises:
   a.1) providing a microfiltration or ultrafiltration membrane, and
   a.2) contacting the high-salinity and/or high-strength feed with one side of the microfiltration or ultrafiltration membrane and applying pressure to the feed so that materials to be separated from the feed pass through said microfiltration or ultrafiltration membrane as said filtrate.
38. The process of embodiment 36 or 37, wherein step a) comprises subjecting the high-salinity and/or high-strength feed to microfiltration.
39. The process of any one of embodiments 36 to 38, wherein step b) comprises:
   b.1) providing a forward osmosis membrane having a rejection layer side and a support layer side, and
   b.2) contacting the pre-treated feed with the rejection layer side of the forward osmosis membrane, and
   b.3) contacting a draw solution having a salinity higher than the salinity of the pre-treated feed with the support layer side of the forward osmosis membrane, thereby causing diffusion of water from the feed through the forward osmosis membrane into the draw solution and producing the water-diluted draw solution.
40. The process of any one of embodiments 36 to 39, wherein the forward osmosis membrane is a forward osmosis membrane as defined in any one of embodiments 22 to 30.
41. The process of any one of embodiments 36 to 40, wherein the draw solution is an aqueous 4.0 M NaCl solution or an aqueous 4.6 M NaP solution, preferably an aqueous 4.6 M NaP solution.
42. The process of any one of embodiments 36 to 41, wherein step c) comprises:
   c.1) providing a membrane for membrane distillation,
   c.2) heating the water-diluted draw solution,
   c.3) contacting the water-diluted draw solution with the membrane for membrane distillation, thereby causing diffusion of water vapor from the water-diluted draw solution through the membrane into a condensation chamber, thereby regenerating the draw solution, and
   c.4) condensing the water vapor in the condensation chamber, thereby producing water.
43. The process of any one of embodiments 36 to 42, wherein the membrane for membrane distillation is as defined in any one of embodiments 1 to 16.
44. The process of any one of embodiments 36 to 43, further comprising the step of reusing the draw solution regenerated in step c) in the forward osmosis treatment of step b).

### BRIEF DESCRIPTION OF THE DRAWINGS

In the appended drawings:

FIG. 1 shows a typical membrane distillation process.

FIG. 2 shows a typical forward osmosis process.

FIG. 3 shows a typical microfiltration or ultrafiltration process.

FIG. 4 is a scheme of the preparation procedure of a functionalized membrane grafted with fluorinated silane-perfluorooctyltriethoxysilane (POTS): PH-rGO-POTS.

FIG. 5 is a scheme of the preparation procedure of a functionalized membrane grafted with hydrophobic silica nanoparticles: PH-rGO-SiNPs.

FIG. 6 is a schematic of the setup for LEP measurements.

FIG. 7 is a schematic of the DCMD experimental setup.

FIG. 8 is a Scanning Electron Microscopy (SEM) image of a PH-rGO membrane.

FIG. 9 is a SEM image at higher magnification of a PH-rGO membrane.

FIG. 10 is a SEM image of a PH-rGO-POTS membrane.

FIG. 11 is a SEM image of a PH-rGO-SiNPs membrane.

FIG. 12 shows the XPS survey scan of a nanofiber mat.

FIG. 13 shows the XPS survey scan of a PH-rGO-POTS membrane.

FIG. 14 shows the XPS survey scan of a PH-rGO-SiNPs membrane.

FIG. 15 shows the FTIR spectrum of the nanofiber mat.

FIG. 16 shows the FTIR spectrum of the PH-rGO-POTS membrane.

FIG. 17 shows the FTIR spectrum of the PH-rGO-SiNPs membrane.

FIG. 18 shows a possible mechanism of silanization.

FIG. 19 shows the oxygen spectrun of the nanofiber mat.

FIG. 20 shows the oxygen spectrun of the PH-rGO-POTS membrane.

FIG. 21 shows the oxygen spectrun of the PH-rGO-SiNPs membrane.

FIG. 22 shows the EDS mapping image of Si on the PH-rGO-POTS membrane.

FIG. 23 shows the EDS mapping image of Si on the PH-rGO-SiNPs membrane.

FIG. 24 shows the water contact angles and sliding angles of membranes modified with POTS (PH-rGO-POTS membrane) and hydrophobic SiO2 nanoparticles (PH-rGO-SiNPs membrane).

FIG. 25 shows diiodomethane contact angles for membranes modified with POTS (PH-rGO-POTS membrane) and hydrophobic SiO2 nanoparticles (PH-rGO-SiNPs membrane).

FIG. 26 shows glycerol contact angles of membranes modified with POTS (PH-rGO-POTS membrane) and hydrophobic SiO2 nanoparticles (PH-rGO-SiNPs membrane).

FIG. 27 shows the water contact angle of PH-rGO-POTS (full line) and PH-rGO-SiNPs (dotted line) membranes after being challenged by exposure to boiling water for up to 4 h.

FIG. 28 shows the water contact angle of PH-rGO-POTS (full line) and PH-rGO-SiNPs (dotted line) membranes after being challenged by sonication for up to 60 min.

FIG. 29 shows the water contact angle of PH-rGO-POTS (full line) and PH-rGO-SiNPs (dotted line) membranes after being challenged by exposure to a strong acid (HCI, pH 2) for up to 110 h.

FIG. 30 shows the water contact angle of PH-rGO-POTS (full line) and PH-rGO-SiNPs (dotted line) membranes after being challenged by exposure to a base solution (NaOH, pH 12) for up to 110 h.

FIG. 31 shows the diiodomethane contact angle of PH-rGO-POTS (full line) and PH-rGO-SiNPs (dotted line) membranes after being challenged by exposure to boiling water for up to 4 h.

FIG. 32 shows the diiodomethane contact angle of PH-rGO-POTS (full line) and PH-rGO-SiNPs (dotted line) membranes after being challenged by sonication for up to 60 min.

FIG. 33 shows the diiodomethane contact angle of PH-rGO-POTS (full line) and PH-rGO-SiNPs (dotted line) membranes after being challenged by exposure to a strong acid (HCI, pH 2) for up to 110 h.

FIG. 34 shows the diiodomethane contact angle of PH-rGO-POTS (full line) and PH-rGO-SiNPs (dotted line) membranes after being challenged by exposure to a base solution (NaOH, pH 12) for up to 110 h.

FIG. 35 shows the pore size distribution of the membrane PH-rGO.

FIG. 36 shows the pore size distribution of the membrane PH-rGO-POTS.

FIG. 37 shows the pore size distribution of the membrane PH-rGO-SiNPs.

FIG. 38 shows the permeate flux with time for PH-rGO-POTS (full line) and PH-rGO-SiNPs (dotted line) membranes under various temperature difference.

FIG. 39 shows the permeate flux with time for PH-rGO-POTS (full line) and PH-rGO-SiNPs (dotted line) membranes under different NaCl concentrations.

FIG. 40 shows the water flux and permeate conductivity of PH-rGO-SiNPs membranes in DCMD process.

FIG. 41 shows the water flux of pristine PVDF-HFP-rGO and amphiphobic PH-rGO-SiNPs membranes in DCMD process.

FIG. 42 shows the permeate conductivity of pristine PH-rGO and amphiphobic PH-rGO-SiNPs membranes in DCMD process.

FIG. 43 is a schematic representation of the experimental setup of the FO process.

FIG. 44 is a FE-SEM image of an electrospun substrate of N6.

FIG. 45 is a FE-SEM image of an electrospun substrate of N6/SiO₂ (20 wt. %) composite.

FIG. 46 is the SEM-EDX spectrum of an electrospun substrate of N6.

FIG. 47 is the SEM-EDX spectrum of an electrospun substrate of N6/SiO₂ composite.

FIG. 48 is a TEM image of an electrospun substrate of N6.

FIG. 49 is a TEM image of an electrospun substrate of N6/SiO₂ composite. The Cu grid and Si detector were used when capturing the TEM images of the electrospun substrates shown in FIGS. 8 and 9.

FIG. 50 shows the XRD spectra of the electrospun N6 and N6/SiO₂ composite substrates. The X-ray source was copper and equipped with a Vantec area detector.

FIG. 51 shows the FTIR spectra of the electrospun N6 and N6/SiO₂ composite substrates.

FIG. 52 shows the wettability of the electrospun substrates of N6.

FIG. 53 shows the wettability of the electrospun substrates of N6/SiO₂ composite.

FIG. 54 is a FE-SEM image of the casted N6 substrate.

FIG. 55 shows the water contact angle of the casted N6 substrate.

FIG. 56 is a FE-SEM image of the top surface of an electrospun N6/SiO₂composite supported TFC membrane with a PA/SiO₂composite active layer with SiO₂ concentrations of 0%.

FIG. 57 is a FE-SEM image of the top surface of an electrospun N6/SiO₂composite supported TFC membrane with a PA/SiO₂composite active layer with SiO₂ concentrations of 1%.

FIG. 58 is a FE-SEM image of the top surface of an electrospun N6/SiO₂composite supported TFC membrane with a PA/SiO₂ composite active layer with SiO₂ concentrations of 2%.

FIG. 59 is a FE-SEM image of the top surface of an electrospun N6/SiO₂ composite supported TFC membrane with a PA/SiO₂ composite active layer with SiO₂ concentrations of 4%.

FIG. 60 is a FE-SEM image of the top surface of an electrospun N6/SiO₂ composite supported TFC membrane with a PA/SiO₂ composite active layer with SiO₂ concentrations of 6%.

FIG. 61 is a FE-SEM image of a cross-section of the TFC membrane with 4% SiO₂ nanoparticles incorporated in the PA active layer.

FIG. 62 is a FE-SEM image of the top surface of an electrospun N6 supported TFC membrane with a PA/SiO₂ composite active layer with a SiO₂ concentration of 0%.

FIG. 63 is a FE-SEM image of the top surface of an electrospun N6 supported TFC membrane with a PA/SiO₂ composite active layer with a SiO₂ concentration of 4%.

FIG. 64 is the SEM-EDX spectrum of the electrospun N6/SiO₂ composite supported TFC membrane with a PA active layer. This spectrum was taken in a region in FIG. 56.

FIG. 65 is the SEM-EDX spectrum of the electrospun N6/SiO₂ composite supported TFC membrane with a PA/SiO₂ composite active layer. This spectrum was taken in a region in FIG. 59.

FIG. 66 is a AFM image of the TFC membrane of electrospun N6/SiO₂-PA and.

FIG. 67 is a AFM image of the TFC membrane of (B) electrospun N6/SiO₂-PA/SiO₂ composite with 4% SiO₂ content in the PA active layer.

FIG. 68 is an AFM image of electrospun substrate of N6.

FIG. 69 is an AFM image of electrospun substrate of N6/SiO₂ composite.

FIG. 70 shows the reverse salt flux of the membranes.

FIG. 71 shows the specific reverse salt flux of the membranes.

FIG. 72 shows the decline of water flux when 1 M NaCl was used as draw solution against DI water as feed.

FIG. 73 shows the fouling behavior of the membrane when 1 M NaCl was used as draw solution against DI water with foulant, SA, as feed solution.

FIG. 74 shows the decline of water flux after cleaning the membrane fouled by SA (Draw solution: 1 M NaCl, Feed solution: DI water).

FIG. 75 shows the fouling behavior of the membrane when 1 M NaCl was used as draw solution against DI water with foulant, CaSO₄, as feed solution.

FIG. 76 shows the decline of water flux after cleaning of the membrane fouled by CaSO₄ (Draw solution: 1 M NaCl, Feed solution: DI water).

FIG. 77 shows the initial water flux recovery for the membranes fouled by SA and CaSO₄.

FIG. 78 is a schematic representation of the fracking wastewater treatment process composed of microfiltration, forward osmosis, and membrane distillation.

FIG. 79 shows the pure water permeability of nanocomposite and PSf MF membranes (in each pack of two columns: left columns=Nanocomposite membrane and right columns=PSf membrane).

FIG. 80 shows the permeability of nanocomposite and PSf MF membranes as a function of time for fracking wastewater: 0 to 750 minutes.

FIG. 81 is a close-up view of FIG. 80 between 0 to 200 minutes.

FIG. 82 shows the dt/dV versus V filtration curves for fouling stage of the nanocomposite membrane in the microfiltration of fracking wastewater.

FIG. 83 shows the dt/dV versus V filtration curves for fouling stage of the PSf membrane in the microfiltration of fracking wastewater.

FIG. 84 shows the specific cake resistance for the fouling stage for MF membranes in the microfiltration of fracking wastewater.

FIG. 85 shows the flux recovery for MF membranes in the microfiltration of fracking wastewater.

FIG. 86 shows the water flux as a function of time for raw fracking wastewaters using the nanocomposite membrane.

FIG. 87 shows the water flux as a function of time for raw fracking wastewaters using the PA membrane.

FIG. 88 shows the water flux as a function of time for pre-treated fracking wastewaters using the nanocomposite membrane.

FIG. 89 shows the water flux as a function of time for pre-treated fracking wastewaters using the PA membrane.

FIG. 90 is a FE-SEM image of a virgin nanocomposite membrane.

FIG. 91 is a FE-SEM image of a virgin PA membrane.

FIG. 92 is a FE-SEM image of a fouled nanocomposite membranes when raw fracking wastewaters were employed as feed while NaP was used as draw solution.

FIG. 93 is a FE-SEM image of a fouled PA membranes when raw fracking wastewaters were employed as feed while NaP was used as draw solution.

FIG. 94 is a FE-SEM image of a fouled nanocomposite membranes when pre-treated fracking wastewaters were employed as feed while NaP was used as draw solution.

FIG. 95 is a FE-SEM image of a fouled PA membranes when pre-treated fracking wastewaters were employed as feed while NaP was used as draw solution.

FIG. 96 is a FE-SEM image of a fouled nanocomposite membrane when raw fracking wastewaters were employed as feed solution, while NaCl was used as draw solution.

FIG. 97 is a FE-SEM image of a fouled PA membrane when raw fracking wastewaters were employed as feed solution, while NaCl was used as draw solution.

FIG. 98 is a FE-SEM image of a fouled nanocomposite membrane when pre-treated fracking wastewaters were employed as feed solution, while NaCl was used as draw solution.

FIG. 99 is a FE-SEM image of a fouled PA membrane when pre-treated fracking wastewaters were employed as feed solution, while NaCl was used as draw solution.

FIG. 100 shows the SEM-EDX spectrum of a virgin nanocomposite membrane. The spectrum was taken from the region in a rectangle in FIG. 90.

FIG. 101 shows the SEM-EDX spectrum of a virgin PA membrane. The spectrum was taken from the region in a rectangle in FIG. 91.

FIG. 102 shows the SEM-EDX spectrum of a fouled nanocomposite membrane when raw fracking wastewaters was employed as feed while NaP was used as draw solution. The spectrum was taken from the region in a rectangle in FIG. 92.

FIG. 103 shows the SEM-EDX spectrum of a fouled PA membrane when raw fracking wastewaters was employed as feed while NaP was used as draw solution. The spectrum was taken from the region in a rectangle in FIG. 93.

FIG. 104 shows the SEM-EDX spectrum of a fouled nanocomposite membrane when pre-treated fracking wastewaters were employed as feed while NaP was used as draw solution. The spectrum was taken from the region in a rectangle in FIG. 94.

FIG. 105 shows the SEM-EDX spectrum of a fouled PA membrane when pre-treated fracking wastewaters were employed as feed while NaP was used as draw solution. The spectrum was taken from the region in a rectangle in FIG. 95.

FIG. 106 shows the decline of water flux for the pristine nanocomposite and PA membranes when 4.6 M NaP is used as draw solution against pre-treated fracking wastewater.

FIG. 107 shows the decline of water flux after cleaning the nanocomposite and PA membranes fouled by the pre-treated fracking wastewater.

FIG. 108 shows the initial FO water flux recovery after cleaning the nanocomposite and PA membranes fouled by the pre-treated fracking wastewater.

FIG. 109 shows the decline of water flux for the pristine nanocomposite and PA membranes when pre-treated fracking wastewater was used as feed and 4.0 M NaCl was used as draw solution.

FIG. 110 shows the decline of water flux after cleaning of the nanocomposite and PA membranes fouled by the pre-treated fracking wastewater.

FIG. 111 shows the initial FO water flux recovery after cleaning the nanocomposite and PA membranes fouled by the pre-treated fracking wastewater.

FIG. 112 shows the permeate flux as a function of time in MD process in which the pre-treated fracking wastewater was used as feed with nanocomposite membrane.

FIG. 113 shows the permeate quality as a function of time in MD process in which the pre-treated fracking wastewater was used as feed with nanocomposite membrane (in each pack of two columns: left columns=NaCl and right columns=NaP).

FIG. 114 shows the feed concentration as a function of time in MD process in which the pre-treated fracking wastewater was used as feed with nanocomposite membrane.

### DETAILED DESCRIPTION OF THE INVENTION

### Membrane for Membrane Distillation (MD Membrane)

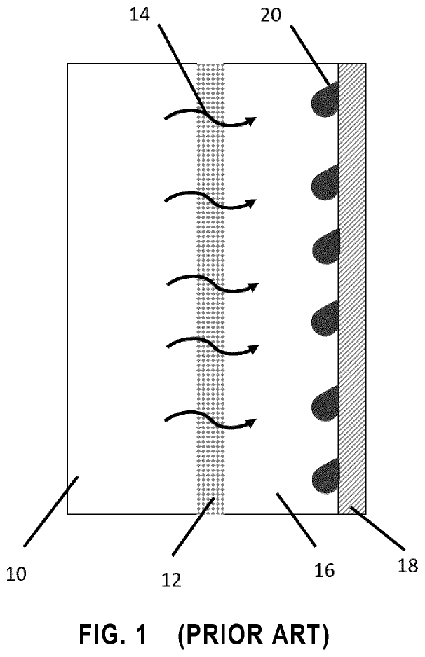

Membrane distillation (MD) is a thermally driven, membrane-based desalination technology. Typically, MD is carried out as shown in FIG. 1. A hot feed (10) is in contact with a DM membrane (12), which only allows water vapor (14) through and into a condensation chamber (16). In the condensation chamber (16), the water vapor comes into contact with a cooled plate (18) and condenses as liquid water (20). The driving force in this process is the vapor pressure gradient generated by the temperature difference across the membrane.

MD membranes are microporous and hydrophobic. Indeed, MD membranes must repel liquid water and only allow water vapor through. In other words, the MD membrane must remain non-wetted during use. Membrane wetting occurs when the feed liquids penetrate the membrane pores. Unfortunately, conventional MD membranes are rather easily wetted when low surface tension contaminants (oil, alcohols, and surfactants) are present in the feed. Another problem of MD membrane is membrane fouling in which foulants deposit on the membrane surface and block the membrane pores thus undesirably decreasing water vapor flux and favoring membrane wetting. As a result of the above, conventional MD membranes are limited to the treatment of relatively clean feeds that are free of hydrophobic and amphiphilic substances (e.g. low surface tension contaminants).

The present inventors aimed to produce a MD membrane that could be used to treat more challenging feeds, such feeds containing low surface tension contaminants, hydrophobic and amphiphilic substances, etc. They therefore sought to produce a membrane less prone to fouling and wetting. Conventionally, most efforts to achieve this goal aimed to modify the surface of existing membranes (more specifically membranes previously used for microfiltration and having a structure and surface not designed for MD) to make them superhydrophobic. Others have sough to produce amphiphobic MD membranes. However, these efforts have led to membranes suffering from one or more drawbacks such as:
undesirably reduced water vapor flux,
limited anti-wetting performances,
limited anti-fouling performances,
limited robustness/stability (i.e. the membrane degrades upon use, for example it becomes less hydrophobic or amphiphobic),
undesirably increased permeate conductivity (i.e. the membrane has lower salt rejection and allows more conductive species through), or
simply being difficult or requiring extra steps to produce.
   It is still a great challenge to fabricate a stable anti-wetting and anti-fouling MD membrane with good water vapor flux and permeate conductivity by a straightforward and cost-effective method.

In a first aspect of the invention, there is provided a membrane for membrane distillation. As shown in Example 1, the MD membrane of the invention is superhydrophobic and amphiphobic, exhibits enhanced stability and durability, presents low fouling and low wetting without compromising permeation (water vapor) flux and salt rejection, and which can therefore be used for treating highly saline feeds containing low surface tension substances. Further, the MD membrane of the invention can easily be manufactured by electrospinning followed by dip-coating.

Herein, “superhydrophobicity” (synonym of “ultrahydrophobicity”) means having a static water contact angle greater than 150°. Additionally, the superhydrophobic membranes of the invention have a water sliding angle of less than 10°. This helps maintaining an air gap between liquid droplets and the surface. This air gap provides an opportunity to increase allowable pore sizes prior to pore wetting occurrence, consequently allowing higher flux. Moreover, superhydrophobicity is believed to reduce the interaction between the feed and the membrane surface thereby reducing the fouling propensity. Because they repulse water, nearly spherical droplets form on the membrane surface and roll away, possibly taking foulants away.

Herein, amphiphobicity means having contact angles larger than 90° with both water and low surface tension liquids. Amphiphobicity allows the membranes of the invention to more effectively prevent contact between contaminants and membrane surface.

The membrane for membrane distillation of the invention comprises a microporous mat of electrospun nanofibers, wherein the nanofibers are made of a nanocomposite of reduced graphene oxide dispersed in a hydrophobic polymer, and wherein the surface of the nanofibers is grafted with:
a silane coupling agent, and/or
hydrophobic nanoparticles,

Herein, a “mat of electrospun nanofibers” is a mat made by electrospinning. In the case of the above composite, electrospinning produces a mat with a surface presenting asperities and reentrant structures, the mat comprising nanofibers randomly arranged in an interconnected open microporous structure. Herein, a “open microporous structure” is a structure presenting micropores that are connected to each of other through the material.

In embodiments, the membrane for membrane distillation is in the shape of a sheet, either flat or curved, preferably flat.

In preferred embodiments, the hydrophobic polymer is polyvinylidene fluoride (PVDF), polytetrafluoroethylene (PTFE), polypropylene (PP), or poly (vinylidene fluoride-co-hexafluoropropylene) (PVDF-HFP). In more preferred embodiments, the hydrophobic polymer is poly (vinylidene fluoride-co-hexafluoropropylene) (PVDF-HFP).

In embodiments, the hydrophobic polymer has a molecular weight (Mw) of about 400 kDa.

In preferred embodiments, the reduced graphene oxide (rGO) is in the form of single-layer reduced graphene oxide nanosheets, preferably with a thickness of 0.7-1.2 nm and length of 300-800 nm.

In preferred embodiments, the concentration of reduced graphene oxide in the nanocomposite is between about 0.15 and about 0.25 wt %, preferably about 0.15 wt %, based on the total weight of the nanocomposite.

In preferred embodiments, the hydrophobic nanoparticles are titanium dioxide, silver, alumina, or silica nanoparticles that have been surface-modified as needed to have a hydrophobic surface. Such surface treatments include, for example, grafting a silane coupling agent on the surface of the nanoparticles. In preferred embodiments, the hydrophobic nanoparticles are surface-modified silica nanoparticles, for example silica nanoparticles with a silane coupling agent grafted on the surface of the silica nanoparticles

In embodiments, the silane coupling agent (which coats the mat, or which is grafted to the surface of the nanoparticles) is of formula Rₘ—Si—Xₙ, wherein:

R is alkyl, alkenyl, haloalkyl, or haloalkenyl,

X is alkoxy or halogen, and

m and n are integers between 1 and 4, such that m+n=4.

In preferred embodiments, R is alkyl, alkenyl, perhaloalkyl, or perhaloalkenyl; preferably alkyl, alkenyl, perfluoroalkyl, or perfluoroalkenyl; more preferably alkyl, alkenyl, perhaloalkyl, and yet more preferably methyl, vinyl, or perfluorododecyl or perfluorododecyl.

In preferred embodiments, X is methoxy, ethyoxy or chloro.

In preferred embodiments, m is 1 or 2 and n is 2 or 3, preferably m is 1 and n is 3.

In preferred embodiments, the silane coupling agent is a haloalkyltrialkoxysilane, a dialkyldihalosilane, alkenyltrialkoxysilane, or alkyltrialkoxysilane, preferably a haloalkyltrialkoxysilane, and more preferably a perhaloalkyltrialkoxysilane. In more preferred embodiments, the silane coupling agent is perfluorooctyltriethoxysilane (POTS), dimethyldichlorosilane (DDS), vinyltrimethoxysilane (VTS), methyltriethoxysilane (MTES), perfluorododecyltrichlorosilane, or perfluorodecyltrimethoxysilane, preferably perfluorooctyltriethoxysilane.

### Manufacture of the MD Membrane

The MD membrane can be manufactured in two easy steps.

First, a mat of electrospun nanofibers is produced by electrospinning a dope solution of the hydrophobic polymer in which the rGO is suspended. This dope solution can be prepared by:
dissolving the hydrophobic polymer in a solvent,
separately, suspending the rGO in a solvent, preferably the same solvent as the hydrophobic polymer solution, and
mixing together the rGO suspension and the hydrophobic polymer solution.

At this stage, a highly hydrophobic nanofiber mat is produced. In addition, Example 1 shows that the PVDF-HFP membranes with rGO exhibited improved stability and durability with satisfactory distillate quality compared with pristine PVDF-HFP membranes.

Then, surface superhydrophobicity and amphiphobicity are further constructed surface modification, i.e. grafting of the silane coupling agent, and/or hydrophobic nanoparticles. Indeed, the surface of the nanofibers can be easily modified by dip-coating to achieve the desired grafting.

For example, the nanofibers mat can be immersed in a solution of the silane coupling agent thus allowing reaction of the silane coupling agent with the surface of the nanofibers to achieve the desired grafting, rinsing, and then heating (for example at 120° C. for 4 h) to complete the reaction of the silane coupling agent with the surface of the nanofibers.

Alternatively, the nanofibers mat can be immersed in a suspension of the hydrophobic nanoparticles, such as the abovementioned surface-modified silica nanoparticles, thus allowing the grafting of the hydrophobic nanoparticles on the surface of the nanofibers, rinsing, and then heating (for example at 120° C. for 4 h) to complete the reaction of the silane coupling agent with the surface of the nanofibers. The suspension of hydrophobic surface-modified nanoparticles can be prepared by providing a suspension of nanoparticles, adding the silane coupling agent to the suspension and allowing the grafting of the silane coupling agent to the nanoparticles (via a Si—O—Si covalent bond). The nanofibers mat can be immersed directly into this reaction mixture, which will lead to a coating comprising the hydrophobic surface-modified nanoparticles, and optionally remaining unreacted silane coupling agent (which, after the above immersion step, will be either rinsed away, or react during the heat treatment).

It should be noted that the nanofibers mat is not simply coated with the silane coupling agent, and/or the hydrophobic surface-modified nanoparticles. Rather, these are grafted, i.e. attached, to the surface of the nanofibers. Without being limited by theory, it is believed that a condensation reaction occurs between the silane molecules (either free or attached to the surface of the SiO₂ nanoparticles) and oxides functions at the surface of the nanofibers. The Si—OR bonds of these silane molecules hydrolyze readily with water to form silanol Si—OH groups, which could then condense with each other and with hydroxyl groups on the nanofiber surface surface to form polymeric structures. Similarly, the unreacted Si—OH on the SiO₂ nanoparticles could form new Si—O bond on the nanofiber surface.

No matter with mechanism is at work, possibly in part because of the fact that the silane coupling agent, and/or the hydrophobic surface-modified silica nanoparticles are grafted on the surface of the nanofibers, the MD membrane of the invention exhibit robust chemical and mechanical stability and enhanced durability as shown in Example 1.

### Membrane Distillation Process

There is also provided a membrane distillation process using the above membrane for membrane distillation.

More specifically, this process comprises the steps of:
a) providing a membrane for membrane distillation as defined above,
b) contacting a heated feed containing water with the membrane, thereby causing diffusion of water vapor from the feed through the membrane into a condensation chamber, and
c) condensing the water vapor in the condensation chamber.

### Membrane for Forward Osmosis (FO Membrane)

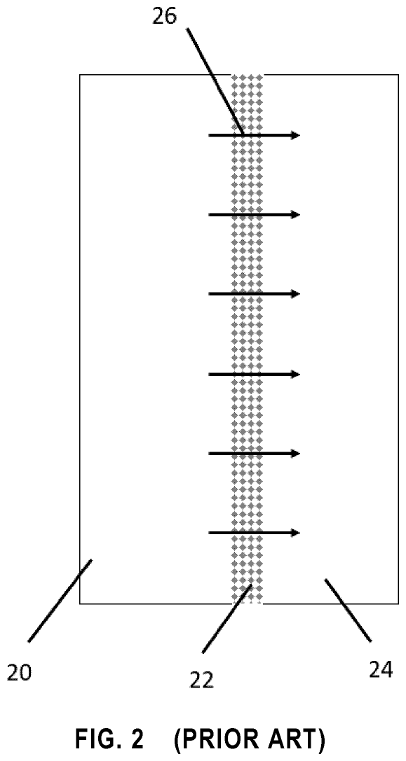

Forward osmosis (FO) is a membrane-based technology that allows separating water from dissolved solutes. Typically, FO is carried out as shown in FIG. 2. A feed (20) containing water and dissolved solutes is in contact with a semi-permeable FO membrane (22), which only allows water (in liquid form) through. On its other side, the FO membrane (22) is in contact with a draw solution (24) that has a higher salinity than the feed (20). This salinity difference generates an osmotic pressure gradient, which induces a net flow of liquid water (26) from the feed (20) through the membrane into the draw solution (24), thereby separating water from the dissolved solutes in the feed (20), effectively concentrating the feed (20) and diluting the draw solution (24). The draw solution (24) can comprise a single simple salt or multiple simple salts or a substance specifically tailored for forward osmosis applications. The water-diluted draw solution resulting from the FO process can then be treated to recover the water.

An ideal FO membrane has high liquid water permeability, high solute rejection, and high chemical and mechanical stability with a low propensity toward fouling. However, conventional FO membranes, some being somewhat hydrophobic, others being somewhat hydrophilic, have serious disadvantages including:
low permeability selectively,
low stability, especially long-term stability and/or in harsh acidic or basic conditions,
low mechanical strength,
low water flux, and/or
propensity towards fouling.
   In particular, efforts to promote antifouling coating has often adversely impacted the permeability selectively and the stability of conventional FO membranes. Moreover, some FO membranes suffer from the deleterious internal concentration polarization (ICP) effect, which is the build-up of concentration gradients both inside and around the FO membrane. Because of these gradients, ICP severely limits the effective osmotic pressure gradient across the membrane and thus limit attainable water flux.

In another aspect of the invention, there is provided a forward osmosis membrane. As shown in Example 2, the thin-film composite FO membrane of the invention exhibits a high water flux with enhanced water permeability, improved antifouling properties and reduced ICP effect as well as high mechanical strength (compared to commercial FO membranes). This combination of properties is highly desirable for a FO membrane and crucial for successful application in the forward osmosis process.

It is believed that the support layer possesses high mechanical strength due to the synergistic effect between the interconnected (chemical connected) spider-web like structure of the electrospun N6 nanofiber mat and the integrated network structure of SiO₂ nanoparticles. The interconnected spider-web like structure is unexpected in electrospun mats; rather a random stack of fiber is expected.

It is believed that the enhanced water permeability (high water flux), the improved antifouling properties, high porosity of the support layer, and the reduced ICP effects are due at least in part to the presence of SiO₂ nanoparticles in both the support and rejection layers and to the electrospun nature of the support layer.

The FO membrane of the invention can be easily manufacture by electrospinning technique followed by interfacial polymerization on the surface of electrospun nanofiber mat.

The membrane for forward osmosis of the invention comprises a microporous support layer and a rejection layer formed on one side of the support layer, wherein:
the support layer is a microporous mat of electrospun nanofibers,
the nanofibers are made of a nanocomposite of hydrophilic nanoparticles dispersed in a hydrophilic polymer, and
the rejection layer is made of nanocomposite of hydrophilic nanoparticles dispersed in a crosslinked meta-aramid of formula (I):

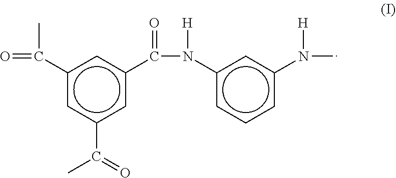

Membranes comprising a support layer with a rejection layer formed on one side of the support layer are conventionally referred to as “thin film composite” FO membranes. One interesting feature of the membrane for forward osmosis of the invention is that both its support layer and its rejection layer advantageously comprise hydrophilic nanoparticles.

Since the rejection layer is formed on one side of the support layer, the forward osmosis membrane can be said to have an rejection layer side (i.e. the side of membrane where the rejection layer is formed) and a support layer side (i.e. the opposite side of the membrane).

In the present invention (and as described in the next section), the rejection layer is formed by interfacial polymerization of precursors to form the crosslinked meta-aramid of formula (I) on the support layer. Thus, it can be said that the rejection is interfacially polymerized on the support membrane. The rejection layer, while formed on the microporous support layer, is not porous. Rather, it is dense with few or no pores. The rejection layer allows water through via dissolution and diffusion of the water in the crosslinked meta-aramid of formula (I) of the rejection layer. Then, the water reaches the support layer where is migrates through the pores to reach the support layer side of the membrane. The salts and other solutes do not dissolve in the rejection layer cannot cross the membrane.

In embodiments, the membrane for forward osmosis is in the shape of a sheet, either flat or curved, preferably flat.

In embodiments, the support layer has a porosity of more than 90%, preferably of about 95%.

In preferred embodiments, the hydrophilic polymer is polyacrylic acid, polyvinyl alcohol, nylon 6, nylon 6.6, a proteins, cellulose, a polyethylene glycol ether, or a polyacrylic amide. In more preferred embodiments, the hydrophilic polymer is nylon 6. Herein, “nylon 6” refers to the polymer also known as polycaprolactam, polyamide 6, and poly(hexano-6-lactam) (IUPAC name), which has the following formula:

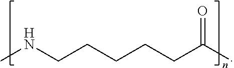

In yet more preferred embodiments, the nylon 6 is present in the nanofibers as a semi-crystalline polymer containing crystals of α and γ-form.

Herein, a “mat of electrospun nanofibers” is a mat made by electrospinning. In the case of the above hydrophilic nanoparticles/hydrophilic polymer composite, electrospinning produces a support layer that is a mat of highly interconnected nanofibers forming a spiderweb-like open microporous structure. Herein, a “spiderweb-like” structure is a network of fibers interconnected with each other via chemical interactions, for example ionic and/or hydrogen bonds, so as to form a web.

Herein, “aramid” has is usual meaning in the art, i.e. it designates aromatic polyamides, which are polymers with repeat units in which amide groups (—CO—NH—) directly bind two aromatic rings together (i.e. —Ar1-CO—NH—Ar2-CO—NH—). Aramids can be categorized as meta or para aramids depending on the attachment of the amide groups on the aromatic rings. A well-known meta aramid is poly(m-phenylene isophthalamide) (MPIA, Nomex™) which has the following formula:

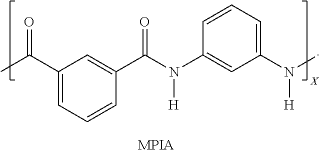

The above crosslinked meta-aramid of formula (I) is quite similar to MPIA, except that the phenyl ring of the isophthalamide bears an extra functional group allowing crosslinking. Note that in formula (I), as per usual for crosslinked polymers, the open bonds indicate crosslinks to other repeat units of the crosslinked polymer.

In preferred embodiments, the concentration of silica nanoparticles in the nanocomposite with the hydrophilic polymer is between 10 wt % and 20 wt %, preferably of about 20 wt % (based on the total weight of the N6/silica nanoparticles nanocomposite).

In preferred embodiments, the concentration of silica nanoparticles in the nanocomposite with the crosslinked meta-aramid of formula (I) is between 1 wt % and 6 wt %, preferably of about 4 wt % (based on the total weight of the aramid/silica nanoparticles nanocomposite).

The hydrophilic nanoparticles in the support layer and in the rejection layer may be the same or different, preferably they are the same. In preferred embodiments, the hydrophilic nanoparticles are graphene oxide, montmorillonite, carboxylated gold, carboxylated silver, zinc oxide, titanium dioxide, or silica nanoparticles. In more preferred embodiments, the hydrophilic nanoparticles are silica nanoparticles.

In embodiments, silica nanoparticles range in size from about 10 to about 80 nm. Typically, the silica nanoparticles are smaller than a) the nanofiber diameter and b) the thickness of rejection layer. Preferably, the silica nanoparticles are about 10 to about 30 nm in size.

### Manufacture of the FO Membrane

The FO membrane can be manufactured in two easy steps. First, the support layer is manufacture and then, the rejection layer is formed on one side of the support layer.

First, a mat of electrospun nanofibers is produced by electrospinning a dope solution of the hydrophilic polymer in which the hydrophilic nanoparticles are suspended. This dope solution can be prepared by:
dissolving the hydrophilic polymer in a solvent,
separately, suspending the hydrophilic nanoparticles in a solvent, preferably the same solvent as the hydrophilic polymer solution, and
mixing together the hydrophilic nanoparticles suspension and the hydrophilic polymer solution.

The mat of electrospun nanofibers is the support layer. Then, the rejection layer is formed on one side of this mat by interfacial polymerization. The crosslinked meta-aramid of formula (I) can indeed be produced by polymerization between one or more aromatic di- or polyfunctional amines and one or more aromatic di- or polyfunctional acyl chlorides. This polymerization is carried out in the presence of silica nanoparticles, which result in the incorporation of the silica nanoparticles in the rejection layer.

For example, the rejection layer can be produced by:
a) protecting one side and the edge of the support layer (for example by placing the support layer on a glass plate and taping each edge to the plate),
b) immersing the protected support layer in a solution of a first monomer precursor of crosslinked meta-aramid of formula (I), for example one or more aromatic di- or polyfunctional amines, preferably m-phenylenediamine (MPD), in which the hydrophilic nanoparticles are suspended,
c) withdrawing the protected support layer from the solution of the first monomer and removing any excess solution,
d) immersing the protected support layer in a solution of a second monomer precursor of crosslinked meta-aramid of formula (I), for example one or more aromatic di- or polyfunctional acyl chlorides, preferably 1,3,5-benzenetricarbonyl trichloride (TMC),
e) withdrawing the protected support layer from the solution of the second monomer and removing any excess solution, and
f) heating the support layer to complete the crosslinking of the crosslinked meta-aramid of formula (I),

Note that above, in step a), one side and the edge of the support layer are protected so that during steps b) and d), only the unprotected side of the support layer is in contact with the solutions of the first and second monomers.

Both m-phenylenediamine (MPD) and 1,3,5-benzenetricarbonyl trichloride (TMC) are precursors of the crosslinked meta-aramid of formula (I). Steps b) and c results in a support layer with MPD and silica particles deposited on its exposed side. In step d), this MPD reacts with the TMC to form the crosslinked meta-aramid of formula (I)—reaction presented in Example 2. The purpose of step f) is to complete internal cross-linking of the remaining un-reacted precursors. After step f), a rejection layer comprising silica nanoparticles dispersed in crosslinked meta-aramid of formula (I) (i.e. a nanocomposite) is formed.

### Forward Osmosis Process

There is also provided a forward osmosis process using the above membrane for forward osmosis.

More specifically, this process comprises the steps of:
a) providing a forward osmosis membrane as defined above, the forward osmosis membrane having an active layer side and a support layer side,
b) contacting a feed containing water with the rejection layer side of the forward osmosis membrane, and
c) contacting a draw solution having a salinity higher than the salinity of the feed with the support layer side of the forward osmosis membrane, thereby causing diffusion of water from the feed through the forward osmosis membrane into the draw solution.

Optionally, the process can comprise a further step of separating water from the diluted draw solution resulting from step c).

Process for Treating a High-Salinity and/or High-Strength Feed, Such As Fracking Wastewater

As noted above, the discharge of highly saline fracking wastewater produced by hydraulic fracturing is of great concern due to both human health and environmental effects. However, the high salinity and the contaminants present in the fracking wastewater make its treatment quite challenging. Therefore, in another aspect of the invention, there is provided a process for treating high-salinity and/or high-strength feeds, such as fracking wastewater. This process combines microfiltration, forward osmosis and membrane distillation. This process allows producing fresh water from high-salinity and/or high-strength feeds.

Indeed, as shown in Example 3, the process of the invention was successfully applied for the first time to treat fracking wastewater. Microfiltration as a pre-treatment removed ˜52% of total organic carbon (TOC) and ˜98.5% of turbidity. High average water fluxes (19.98 LMH for NaCl and 30.97 LMH for NaP draw solutions) with high solute rejection were obtained via the FO process using a nanocomposite membrane. In addition, 98.5% of the initial water flux was recovered with the nanocomposite membrane after desalination of the fracking wastewater. Membrane distillation as a downstream separator allowed recycling the FO draw solution, along with the production of pure water.

The process of the invention is thus a process for treating a high-salinity and/or high-strength feed, such as fracking wastewater, comprising:
a) subjecting the high-salinity and/or high-strength feed to microfiltration or ultrafiltration to produce a pre-treated feed as a filtrate,
b) subjecting the pre-treated feed to forward osmosis using a draw solution to produce a water-diluted draw solution, and
c) subjecting the water-diluted draw solution to membrane distillation to produce water and regenerate the draw solution.

Herein, a “high-salinity feed” is a feed that that a salinity of about 35 g/kg or more (i.e. about 35 g or more of salts in 1 kg of feed). Note that the “salinity” of a feed or solution is defined as the concentration of all the salts dissolved in the feed or solution and that the average ocean salinity is about 35 g/kg. Non-limiting examples of high-salinity feeds include fracking wastewater, textile and lather industry effluents, effluents from the petroleum refinery industry, and effluents from the agro-food industry.

Herein, a “high-strength feed” is a feed that that a chemical oxygen demand (COD) of about 10,000 mg/L or more. Note that the “chemical oxygen demand” is an indicative measure of the amount of oxygen that can be consumed by reactions in a measured solution. It is commonly expressed in mass of oxygen consumed over volume of solution which in SI units is milligrams per litre (mg/L). COD is as well-known test that easily quantifies the amount of organics in water. In fact, the most common application of COD is in quantifying the amount of oxidizable pollutants found in surface water. Non-limiting examples of high-strength feeds include fracking wastewater.

The first step of the process is the microfiltration or ultrafiltration of the high-salinity and/or high-strength feed to produce a pre-treated feed as a filtrate. Pre-treatment of fracking wastewater (or other high-salinity and/or high-strength feeds) was found to increase the efficiency and life expectancy of the FO membrane by minimizing fouling. It also removed sand particles and oil from fracking wastewater (or other high-salinity and/or high-strength feeds) thus producing as a filtrate, a pre-treated feed more suitable for FO.

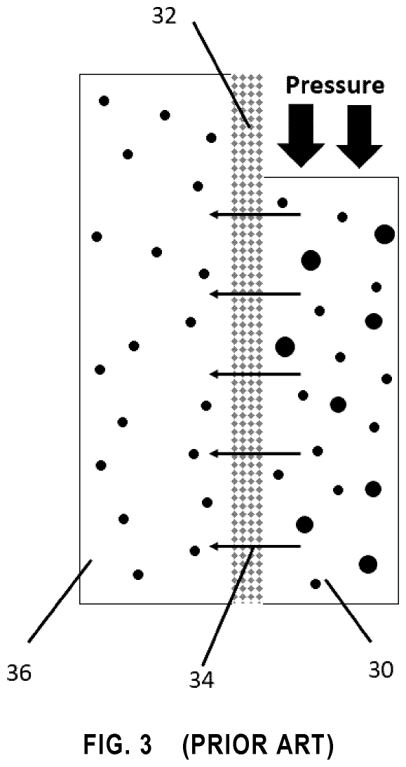

Microfiltration (MF) and ultrafiltration are both size exclusion-based filtration technologies. Typically, MF and UF are carried out as shown in FIG. 3. Pressure is applied to a feed (30) that is in contact with a MF or UF membrane (32). The MF or UF membrane only allows through solutes that are below a certain size (34). As a result, a permeate (36) containing these solutes is formed on the side of the MF or UF membrane opposite the feed.

More specifically, step a) of the process of the invention comprises the sub-steps of:
b.1) providing a microfiltration or ultrafiltration membrane, and
b.2) contacting the high-salinity and/or high-strength feed with one side of a microfiltration or ultrafiltration membrane and applying pressure to the feed so that materials to be separated from the feed pass through said microfiltration or ultrafiltration membrane as said filtrate.

MF and UF membranes are porous semipermeable membranes that allow various particle sizes to either flow through or be trapped by the membrane, and the degree of separation largely depends on particle size. The main difference between MF and UF membranes is pore size with microfiltration membranes having a pore size ranging from 0.1 to 10 μm, while ultrafiltration membranes have a pore size ranging from 0.1 to 0.01 μm.

The MF and UF membranes used in the process of the invention prevents particles such as sediment, algae, protozoa or large bacteria from passing through. Depending on the non-dissolved contaminants—such as sand and oil—in the high-salinity and/or high-strength feed, ultrafiltration or microfiltration will be used as pre-treatment technology. In general, MF, with its larger pore-sized membrane, allows water, monovalent and multivalent ions, and viruses through its barrier while blocking certain bacteria and suspended solids. In contrast, ultrafiltration, with its smaller pore size, blocks everything microfiltration can in addition to viruses, silica, proteins, plastics, endotoxins, and smog and/or fumes. The pore size of the MF or UF membrane used will also be selected depending on the non-dissolved contaminants in the feed.

In preferred embodiments, step a) of the process of the invention comprises subjecting the high-salinity and/or high-strength feed to microfiltration. Indeed, microfiltration can be more convenient than ultrafiltration, since it typically requires lower pressures and has typically higher permeability. Thus, unless the nature of the contaminants in the high-salinity and/or high-strength requires the use of ultrafiltration, microfiltration is preferred. In particular, it has been shown in Example 3 below that microfiltration could successfully be used when treating fracking wastewater.

The exact nature of the MF and UF membranes is no crucial to the invention. Commercial MF and UF membranes can be used. MF and UF membranes can be constructed with polymers, such as polypropylene, cellulose acetate, and polysulfone, but they can also be constructed of ceramic or stainless steel. In preferred embodiments, the MF membrane is an electrospun Nylon 6 nanocomposite membrane as described in Example 3, or a commercial polysulfone (PSf) membrane such as the HT 200 membrane (Pall Corporation, USA). In more preferred embodiments, the MF membrane is an electrospun Nylon 6 nanocomposite membrane as described in Example 3.

The next step of the process is to subject the pre-treated feed (filtrate) obtained from step a) to forward osmosis. Indeed, forward osmosis can desalinate the pre-treated feed using fairly straightforward and economic, low-pressure equipment.

The forward osmosis process has been generally described above and this general description applies here. As noted in the previous sections, forward osmosis requires the use of a draw solution and results in a water-diluted draw solution.

More specifically, step b) of the process of the invention comprises the sub-steps of:
b.1) providing a forward osmosis membrane having a rejection layer side and a support layer side, and
b.2) contacting the pre-treated feed with the rejection layer side of the forward osmosis membrane, and
b.3) contacting a draw solution having a salinity higher than the salinity of the pre-treated feed with the support layer side of the forward osmosis membrane, thereby causing diffusion of water from the feed through the forward osmosis membrane into the draw solution and producing the water-diluted draw solution.

The exact nature of the FO membrane is no crucial to the invention. Commercial FO membranes can be used. In embodiments, the FO membrane is cellulose triacetate membrane or a thin-film composite polyamide membrane. In preferred embodiments, the FO membrane is a membrane for forward osmosis as described in the previous sections, preferably as described in Example 2 hereinbelow, or a commercial polyamide membrane such as that provided by Hydration Technology Innovations (HTI, Albany, Oreg., USA), such as 40161507 Filter membranes, Basic TFC Forward Osmosis Membranes kit. In more preferred embodiments, the FO membrane is a membrane for forward osmosis as described in the previous sections, preferably as described in Example 2 hereinbelow.

The draw solution can comprise a single simple salt or multiple simple salts or a substance specifically tailored for forward osmosis applications. In embodiments, the draw solution is an aqueous NaCl or NaP solution. In more preferred embodiments, the draw solution is an aqueous 4.0 M NaCl solution from an aqueous 4.6 M NaP solution, as long as the draw solution has a salinity higher than the salinity of the pre-treated feed. In yet more preferred embodiments, the draw solution is an aqueous 4.6 M NaP solution.

The next step of the process is to subject the water-diluted draw solution to membrane distillation to produce water. Membrane distillation is indeed used as a separator downstream of the FO process to recycle the water-diluted draw solution produced by the forward osmosis process. Indeed, since membrane distillation removes water from the water-diluted draw solution, it regenerates the (more concentrate) draw solution and produces water. This renders the process more economical.

The membrane distillation process has been generally described above and this general description applies here. More specifically, membrane distillation step c) of the process of the invention comprises the sub-steps of:
c.1) providing a membrane for membrane distillation,
c.2) heating the water-diluted draw solution,
c.3) contacting the water-diluted draw solution with the membrane for membrane distillation, thereby causing diffusion of water vapor from the water-diluted draw solution through the membrane into a condensation chamber, and
c.4) condensing the water vapor in the condensation chamber.

The exact nature of the MD membrane is no crucial to the invention. Commercial MD membranes can be used. Highly hydrophobic membranes are nevertheless preferred. In embodiments, the MD membrane is a membrane for membrane distillation as described in the previous sections, preferably as described in Example 1 hereinbelow, a commercial poly(vinylidene fluoride) (PVDF) membrane, such as Durapore®, Millipore, USA (mean pore size 0.22 μm, porosity 75%). In more preferred embodiments, the MD membrane is a membrane for membrane distillation as described in the previous sections, preferably as described in Example 1 hereinbelow.

In embodiments, the process further comprises the step of reusing the draw solution regenerated in step c) in the forward osmosis treatment of step b).

### Definitions

The use of the terms “a” and “an” and “the” and similar referents in the context of describing the invention (especially in the context of the following claims) are to be construed to cover both the singular and the plural, unless otherwise indicated herein or clearly contradicted by context.

The terms “comprising”, “having”, “including”, and “containing” are to be construed as open-ended terms (i.e., meaning “including, but not limited to”) unless otherwise noted.

Recitation of ranges of values herein are merely intended to serve as a shorthand method of referring individually to each separate value falling within the range, unless otherwise indicated herein, and each separate value is incorporated into the specification as if it were individually recited herein. All subsets of values within the ranges are also incorporated into the specification as if they were individually recited herein.

Herein, the terms “alkyl”, “alkenyl” and their derivatives (such as alkoxy, etc.) have their ordinary meaning in the art. For more certainty, herein:

| Term | Definition |
|---|---|
| alkyl | monovalent saturated aliphatic hydrocarbon radical of |
| | general formula CₙH₂ₙ₊₁ |
| alkenyl | monovalent aliphatic hydrocarbon radical similar to an |
| | alkyl, but comprising at least one double bond |
| haloalkyl | alkyl substituted with one or more halogen atom |
| haloalkenyl | alkenyl substituted with one or more halogen atom |
| perhaloalkyl | alkyl in which all hydrogen atoms have been substituted |
| | with halogen atoms |
| perhaloalkenyl | alkenyl in which all hydrogen atoms have been |
| | substituted with halogen atoms |
| alkyloxy or | monovalent radical of formula —O-alkyl |
| alkoxy | |

It is to be noted that, unless otherwise specified, the hydrocarbon chains of the above groups can be linear or branched. Further, unless otherwise specified, these groups can contain between 1 and 18 carbon atoms, more specifically between 1 and 12 carbon atoms, between 1 and 6 carbon atoms, between 1 and 3 carbon atoms, or contain 1 or 2, preferably 1, or preferably 2 carbon atoms.

All methods described herein can be performed in any suitable order unless otherwise indicated herein or otherwise clearly contradicted by context.

The use of any and all examples, or exemplary language (e.g., “such as”) provided herein, is intended merely to better illuminate the invention and does not pose a limitation on the scope of the invention unless otherwise claimed.

No language in the specification should be construed as indicating any non-claimed element as essential to the practice of the invention.

Herein, the term “about” has its ordinary meaning. In embodiments, it may mean plus or minus 10% or plus or minus 5% of the numerical value qualified.

Unless otherwise defined, all technical and scientific terms used herein have the same meaning as commonly understood by one of ordinary skill in the art to which this invention belongs.

Other objects, advantages and features of the present invention will become more apparent upon reading of the following non-restrictive description of specific embodiments thereof, given by way of example only with reference to the accompanying drawings.

### DESCRIPTION OF ILLUSTRATIVE EMBODIMENTS

The present invention is illustrated in further details by the following non-limiting examples.

### EXAMPLE 1

### Membranes for Membrane Distillation—Reduced Graphene Oxide in Poly (vinylidene fluoride-co-hexafluoropropylene)

We developed two easy-to-produce superhydrophobic and amphiphobic nanofibrous membranes for membrane distillation. These membranes comprise a nanocomposite of reduced graphene oxide in poly (vinylidene fluoride-co-hexafluoropropylene).

In fact, two superhydrophobic and amphiphobic membranes, which could repel both water and low surface tension liquids (e.g. oil), were produced by electrospinning followed by surface modification.

First, highly hydrophobic nanofiber mats were prepared by electrospinning a blend polymer of poly (vinylidene fluoride-co-hexafluoropropylene) (PVDF-HFP) and reduced graphene oxide (rGO). The rGO incorporated membranes exhibited improved stability and durability with satisfactory distillate quality compared with pristine PVDF-HFP membranes.

Surface superhydrophobicity and amphiphobicity were further increased by grafting a fluoroalkylsilane of low surface energy or silica nanoparticles to the rGO incorporated membranes. Indeed, perfluorooctyltriethoxysilane (POTS) and hydrophobic SiNPs were grafted on the membrane surface through a simple dip-coating process. The functionalization of the membranes with POST and SiNPs is shown in FIGS. 4 and 5.

We investigated the morphology, surface robustness and anti-wetting properties of the modified nanofibrous membranes and examined the impacts of surface modification on permeate flux and salt rejection in the direct contact membrane distillation (DCMD) process.

Various techniques such as SEM, AFM, XPS, liquid entry pressure (LEP) and contact angle measurement were used to explore the effects of surface modification on the morphology and structure of the membranes. The analysis results revealed changes in the electrospun nanofiber diameters, surface roughness, elemental composition and hydrophobicity.

The membranes produced showed excellent superhydrophobicity and amphiphobicity, as demonstrated by their wetting resistance with water and low surface tension organic solvents. In particular, both the hydrophobic SiO₂ nanoparticles grafted membrane (PH-rGO-SiNPs membrane) and POTS-grafted membrane (PH-rGO-POTS membrane) modified membrane displayed superhydrophobicity with water contact angle larger than 150° and sliding angle lower than 2°, indicating their self-cleaning properties. Moreover, two as-prepared membranes exhibit large diiodomethane contact angles of 146.5° and 145.5°, respectively. These two membranes also exhibited excellent amphiphobic chemical, thermal and mechanical stability even after the challenging treatments including 4 h boiling in DI water, 110 h etching in strong HCI and NaOH solution, and sonication for 1 h demonstrating that POTS and SiO₂ could adhere to PVDF-HFP/rGO nanofibers firmly and withstand various harsh treatment.

The novel nanofibrous membranes also exhibited excellent anti-wetting and anti-fouling performances in membrane distillation. Indeed, we challenged the stability of the amphiphobic nanofibrous membrane with a model surfactant—sodium dodecyl sulfate (SDS) containing feed saline solution. We demonstrated the membrane properties during dynamic membrane distillation operation, in which the membranes were used to purify water from a 35 g/L sodium chloride solution in the presence of SDS. The modified membranes exhibited enhanced stability and durability of MD performance in both high permeation flux and salt rejection. The SiO₂ nanoparticles-grafted amphiphobic membrane presented a robust dynamic performance with a relatively higher water flux and desired permeate conductivity in the presence of 0.3 mM SDS during the DCMD process, compared with the pristine membrane without SiO₂ nanoparticles grafting, demonstrating the outstanding anti-wetting property of amphiphobic membranes.

### REFERENCES FOR THIS EXAMPLE

The present Example refers to the following documents, all of which are incorporated herein by reference.
1.1. H. Zhou et al., Adv. Funct. Mater., 23 (2013), 1664-1670.
1.2. S. M. Kang et al., Soft Matter 8 (2012) 8563-8568.
1.3. Leng, B. et al., Langmuir 2009, 25, 2456-2460.
1.4. X. Li, et al., ACS Appl. Mater. Interfaces 2015, 7, 21919-21930
1.5. D. Hou, et al., Separation and Purification Technology 189 (2017) 82-89
1.6. M. S. Islam et al., J. Membr. Sci. 537 (2017) 297-309.
1.7. J. Xu et al., Molecules 2014, 19(8), 11465-11486.
1.8. V. V. Tomina et al., J. Fluor. Chem. 132 (2011) 1146-1151
1.9. Y. Liao et al., ACS Appl. Mater. Interfaces 2014, 6, 16035-16048.
1.10. M. Tao et al., Adv. Mater. 26 (2014) 2943-2948.
1.11. F. A. Banat et al., J. Membrane Sci., 163, pp 333-348, 1999.
1.12. M. Bhadra et al., Desalination 378 (2016) 37-43.
1.13. E. Fontananova et al., Desalination 192 (1-3) (2006) 190-197
1.14. C. Chiam et al., Chem. Eng. Process. Process Intensif. 74 (2013) 27-54.
1.15. J. E. Efome et al., Desalination 373 (2015) 47-57.
1.16. Y. Liao et al., Environ. Sci. Technol. 48 (2014) 6335-6341
1.17. K. Lum et al., J. Phys. Chem. B 103 (1999) 4570-4577.
1.18. S. Meng et al., J. Memb. Sci. 450 (2014) 48-59.
1.19. Y. Liao et al., J. Memb. Sci. 440 (2013) 77-87.
1.20. S. Mandi, et al., Journal of Membrane Science 2017, 537(1), 140-150.
1.21. E. Yüksel et al., Chem. Eng. J. 152 (2009) 347-353.
1.22. J. Lee et al., ACS Appl. Mater. Interfaces 8 (2016) 11154-11161.
1.23. Franken, A. C. M. et al., J. Membr. Sci. 1987, 33, 315-328.
1.24. V. Dutschk et al., J. Colloid Interface Sci. 267 (2003) 456-462.
1.25. A. K. Kota et al., NPG Asia Mater. 6 (2014) e109.
1.26. T. L. Liu et al., Science 346 (2014) 1096-1100.
1.27. J. Lee et al., ACS Appl. Mater. Interfaces 8 (2016) 11154-11161.

### Experimental

### Materials

Poly (vinylidene fluoride-co-hexafluoropropylene) (PVDF-HFP, M_{w}: ˜400000), dimethylacetamide (DMAc), perfluorooctyltriethoxysilane (POTS, 97%), tetraethyl orthosilicate (TEOS), ethyl alcohol (C₂H₅OH), ammonium hydroxide (NH₄OH), and sodium dodecyl sulfate (SDS) were purchased from Sigma-Aldrich (Oakville, ON, Canada) and used without any pre-treatment. All other agents including sodium chloride (NaCl≥99.5%) and acetone (ACS reagent grade) were purchased from Fisher-Scientific (St Laurent, QC, Canada). Single layer reduced graphene oxide (rGO) nanosheets, with a thickness of 0.7-1.2 nm and length of 300-800 nm, were purchased from Cheap Tubes Inc. (Grafton, Vt., USA). Deionized (DI) water was prepared using a Milli-Q purification system (Millipore, Billerica, Mass.).

### Preparation of Superhydrophobic and Amphiphobic Nanofiber Membranes

### PVDF-HFP/rGO Electrospun Mats (PH-rGO)

PVDF-HFP/rGO electrospun mats (PH-rGO) were first prepared. A dope solution was prepared by dissolving PVDF-HFP (3.0 g) in 20 mL of a mixture of DMAc/acetone (8/12, V/V). A mixture of rGO and PVDF-HFP was prepared by suspending 30 mg (0.15 wt %) of rGO in the aforementioned mixture of DMAc/acetone by probe sonication (Branson 3510, Shanghai, China) for 10 min followed by the addition of the same amount of PVDF-HFP. The mixture was stirred overnight on a hot plate at 45° C. 20 mL of each solution was loaded into a Luer-lock syringe (Vitaneedle, Mass.).

Electrospinning of the dope solutions was conducted using a Nanospinner (NE300, Inovenso, Turkey). Polymeric solutions were delivered to the metallic nozzle at a 2.0 mL/h flow rate. A high voltage (25 KV) was applied between the nozzle and the electrically grounded metallic drum. The distance between nozzle tip and collector (12 cm), temperature (24° C.) and relative humidity (25%) were held constant during the process.

### POTS-Grafted Electrospun PVDF-HFP-rGO (PH-rGO-POTS) Nanofiber Membranes

The electrospun mats were modified by POTS as shown in FIG. 4 to achieve superhydrophobicity and amphiphobicity. Electrospun membranes were cut to small pieces and were immersed in a solution of 1 mL POTS in a mixture of 30 mL ethanol and 3 mL DI water for 36 h. Coated membranes then rinsed with DI water three times followed by thermal treatment at 120° C. for 4 h.

### Silica Nanoparticles (SiNPs) Modified Electrospun PVDF-HFP-rGO (PH-rGO-SiNPs) Nanofiber Membranes

The electrospun mats were modified with SiNPs as shown in FIG. 5.

First, a hydrophobic silica nanoparticles (SiNPs) suspension was prepared as described in Reference 1.1. Ammonia (2.4 mL) and ethanol (30 mL) were mixed to form a homogenous solution, and TEOS (2.8 mL) was then added. After 8 h of magnetic stirring, 0.4 mL POTS was added to the reaction solution. The reaction was stirred for another 24 h at room temperature to form a hydrophobic silica particulate sol. Under this synthesis condition, the silica particles were present in the suspension at a concentration of 1.5 wt %.

The PVDF-HFP-rGO mats were immersed in the silica particulate suspension (silica particle concentration, 1.5 wt %) for 36 h to apply silica nanoparticles to the membrane surface. After rinsing with DI water, the treated mat was then dried at 120° C. for 45 min.

### Membrane Characterization

The morphology of the membranes was observed using a FEI Quanta 450 Environmental Scanning Electron Microscope (FE-SEM; FEI company, USA). Samples were coated with a thin 4 nm layer of palladium (Pd) before observation by microscopy. Silicon (Si) mapping was obtained using an EDS apparatus. The fiber diameter distribution and frequency were measured via ImageJ software. The elemental composition of membranes was evaluated by X-ray photoelectron spectroscopy (XPS; SK-Alpha). Surface roughness and topography of membranes were investigated by atomic force microscopy (AFM; NanoINK Inc. Skokie, Ill., USA). Fourier transform infrared spectroscopy (FT-IR) was performed with a Nicolet 6700/Smart iTR (Thermo Scientific, Waltham, Mass., USA) equipped with an attenuated total reflectance (ATR) single logic accessory to observe the functional group changes on PH-rGO mat surface after grafting of POTS and silica nanoparticles.

The surface wetting resistance of the membranes was evaluated by contact angle measurements of DI water (γ=72.1 mN/m), diiodomethane (γ=50.1 mN/m), and glycerol (γ=64 mN/m) using video contact angle system (VCA; AST Products, Inc., Billerica, Mass., USA). The static contact angles were measured by using the system software (VCA optima XE). The water sliding angles were measured by tilting the membrane samples that were fixed on the stage until the water droplet (10 μL) started to move on the surface. At least three desiccator-dried samples were used for contact angle measurements and for each sample, about three points were tested. The data was averaged between the samples.

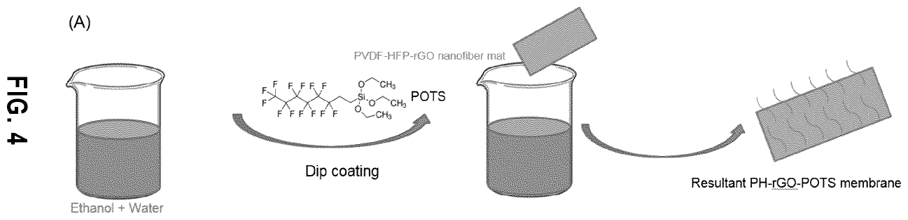

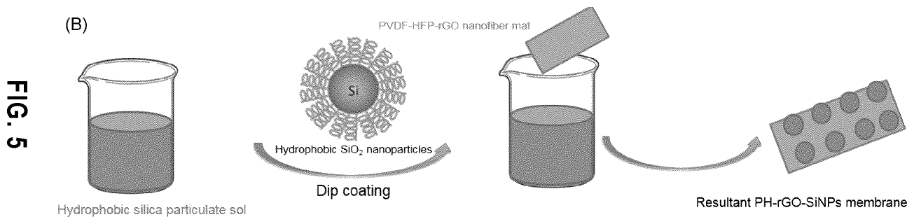

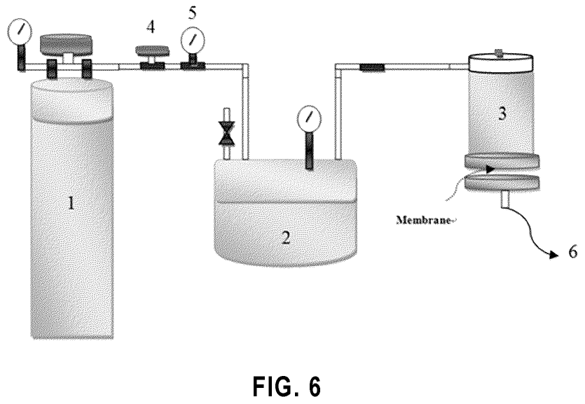

The liquid entry pressure of water (LEPw) was measured by placing the membrane in a dead-end filtration cell. The setup for LEP measurements is shown in FIG. 6, in which (1) is the nitrogen cylinder, (2) is the pressured container, (3) is the membrane cell, (4) is the pressure regulator, (5) is the pressure meter, and (6) is the outlet. Compressed nitrogen was used to apply pressure to the cell. The pressure was recorded when the first drop of water came out from the cell. The experiment was carried out three times using different membranes fabricated under the same conditions. The results were averaged to provide a final LEPw value.

The mean flow pore size (MFP), pore size distribution of the as-prepared membranes were characterized by using a capillary flow porometer (CFP-1500AE, Porous Materials Inc. (PMI), Ithaca, N.Y., USA) based on the wet/dry flow method, where the membranes were firstly wetted with wetting liquid called Galwick (surface tension: 15.9 mN/m) and then placed in a sealed chamber through which gas flows. The membrane porosity was determined by the gravity method reported previously.

### Surface Stability

The thermal, mechanical and chemical stability of surface amphiphobicity were evaluated under challenging conditions including boiling water (DI water, 100° C.) for 4 h, sonication for 60 min, acidic (HCI solution, pH=2) and basic conditions (NaOH solution, pH=12) at room temperature for 110 h. Water and diiodomethane contact angles of the top electrospun membrane surface were then measured at room temperature following the above procedure.

### Membrane Distillation Experiments

The DCMD performance experiment was conducted with the apparatus shown in FIG. 7.

A flat-sheet membrane, with an effective area of 34 cm², was tightly fixed into a PTFE membrane cell (CF042P-FO, Sterlitech Corporation, USA). A hot feed solution was maintained at a constant temperature using a water bath. The feed solution and a cold solution were moved at the same speed across the bottom and upper face of the membrane cell respectively with the help of two gear pumps (GH-75211-10, Cole-parmer, Canada) at around 0.8 psi (GH-68930-12, Cole-Parmer, Canada). The circulation feed rate and permeate rate were detected by two flowmeters (0.1-1 LPM, McMaster-CARR, Canada) and held constant at 0.75 LPM. The operational temperature was monitored at the inlet and outlet of the module using four thermocouples (SCPSS-032u-6, OMEGA, Canada) connected to a thermometer (EW-91427-00, Cole-Parmer, Canada). The inlet temperature of the hot feed varied from 50 to 75° C., while the cold side was kept at a constant 25.0° C. The conductivity of NaCl in the distillate was investigated with an electric conductivity meter (Oakton Instruments, Vernon Hills, Ill., USA).

The experiments were first carried out with DI water to determine the pure water flux of the membranes. Subsequently, 35 g/L of NaCl solution was employed as feed solution to investigate the salt rejection.

The permeate flux, J, of the prepared membrane was calculated using the following equation:

$$J = \frac{Δ M}{A Δ t} \qquad ( 1.1 )$$

where J is the permeate flux (kg/m² h), ΔM is the quantity of distillate (kg), A is the effective membrane area (m²) and Δt is the operation time (h). The salt rejection R was calculated using the following equation:

$$R = \frac{{C}_{f} - {C}_{p}}{{C}_{f}} \times 100 \% \qquad ( 1.2 )$$

where C_{f} and Cₚ are the concentration of the feed and permeate, respectively.

The wetting propensity of the modified nanofibrous membrane was investigated in the presence of SDS surfactant in the feed solution. For the initial 60 min of MD runs, a 3.5 wt % NaCl solution was used as a feed solution, and the mass and conductivity of the cold DI water side were recorded constantly, and thus the real-time flux and salt rejection were calculated and monitored. The SDS was then added to the feed stream solution with a final concentration of 0.3 mM to reduce the surface tension of the solution and thereby to induce pore wetting, if the membranes were wettable. If the membranes were wetted, the feed saline solution would permeate through the wetted portions of the membrane to the distillate side, leading to a significant water flux decline and a salt rejection loss.

The pristine PH-rGO membrane was used as a control sample.

### Results

### Membrane Morphology and Surface Chemistry (SEM, AFM, XPS, FTIR, EDS)

Surface morphology and chemical composition of the membrane surface are first discussed. Electrospinning was applied to fabricate PVDF-HFP-rGO (PH-rGO) nanofibrous membranes. Moreover, electrospun nanofibrouss membranes with multilevel surface roughness provides a re-entrant structure, which improves surface amphiphobicity.

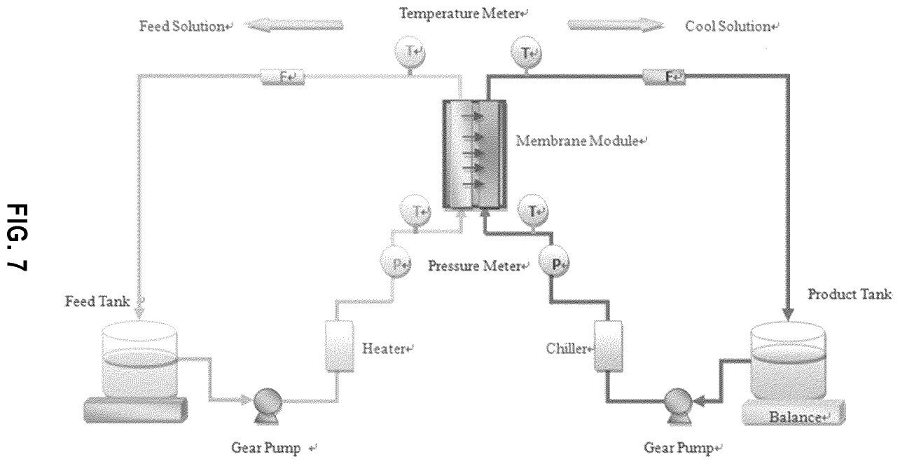

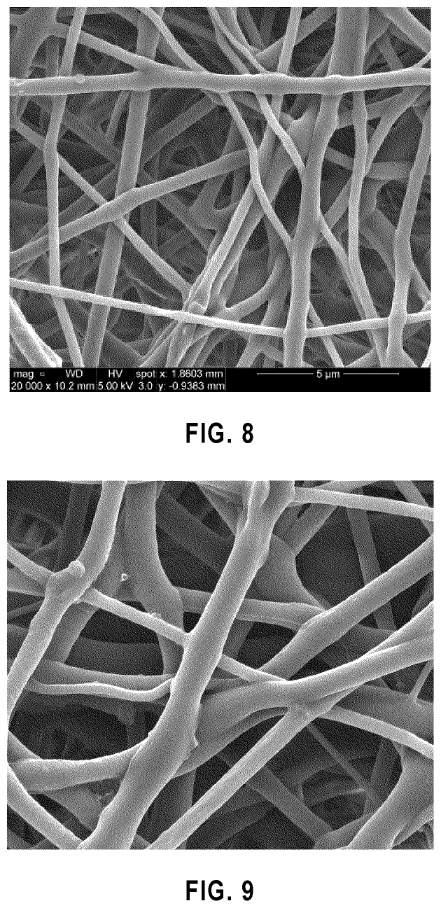

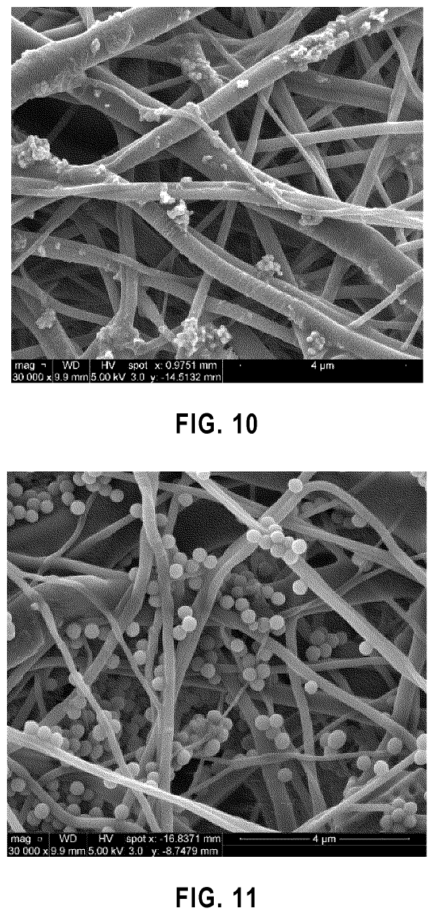

SEM was used to observe the morphology of PVDF-HFP-rGO electrospun membrane before and after surface modification as shown in FIGS. 8 to 11. The electrospun mat is shows at two different magnification in FIGS. 8 and 9 while PH-rGO-POTS and PH-rGO-SiNPs are shows in FIGS. 10 and 11, respectively. All membranes surface presented a “three dimension” nanofibers interconnected open structure. Nanofibers were rougher after surface modification with POTS (PH-rGO-POTS membranes) or hydrophobic SiO₂ nanoparticles (PH-rGO-SiNPs membranes). Aggregated fluoroalkylsilane agent-POTS and hydrophobic SiO₂ nanoparticles were randomly distributed on the fibers—see FIGS. 10 and 11, exhibiting a number of re-entrant geometries. When a liquid droplet was placed on such surface, the Laplace pressure force would be directed upward, which could effectively prevent the liquid from wetting the surface—see Reference 1.2.

The modified membranes had a radically different surface morphology compared to the pristine PVDF-HFP/rGO membrane due to the presence of POTS and the SiNPs. It is evident from the SEM images that POTS molecules and SiNPs cover the surface of the nanofibers and that some form aggregates, which can sustain a metastable Cassie-Baxter thermodynamic state—see Reference 1.3.

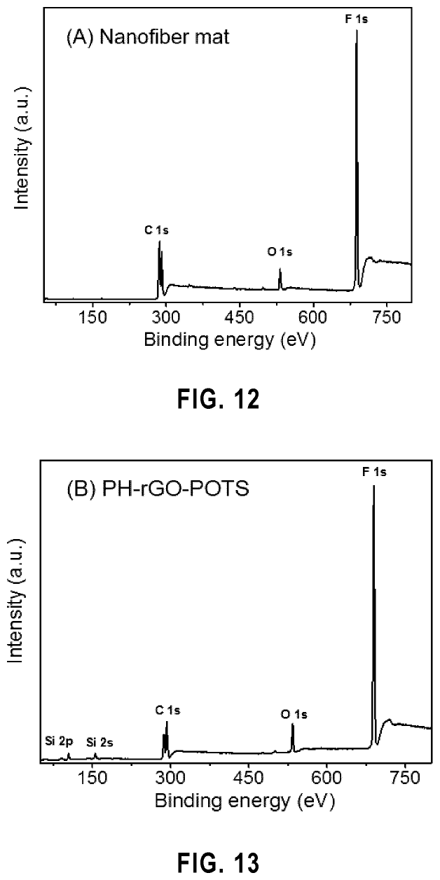

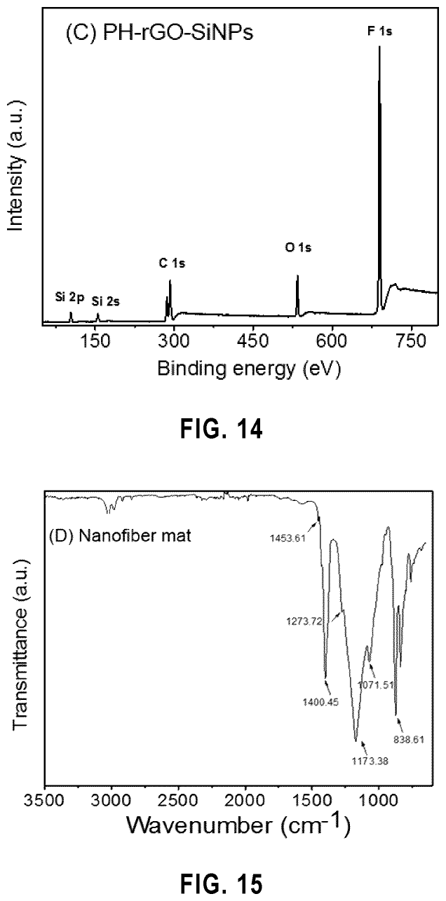

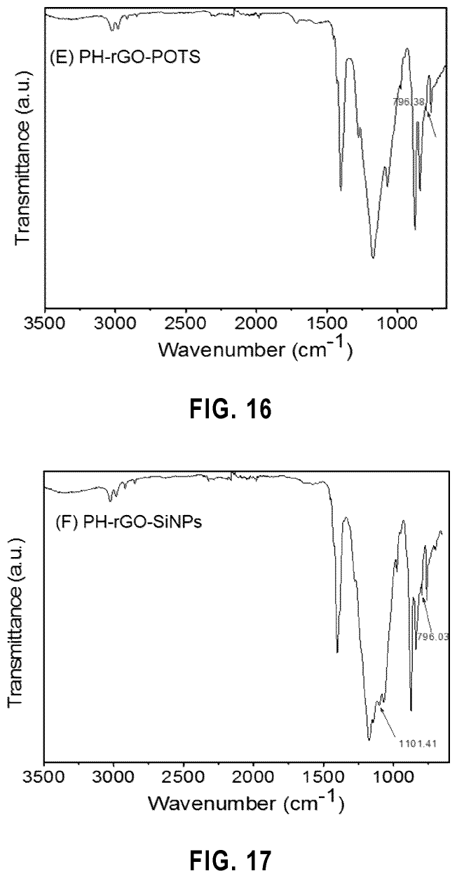

The presence of POTS molecules and SiN Ps were further examined by XPS analysis and FTIR—see FIGS. 12 to 17. Membrane surface elements were analyzed using XPS to find clear Si peaks at the binding energy of 104 eV (for Si 2p) and 155 eV (for Si 2s) upon the successful POTS and SiO₂ nanoparticles grafting on PH-rGO nanofibrous membranes (FIGS. 13 and 14). In contrast, no Si peak was observed in pristine membrane (FIG. 12). These results are also presented in Table 1 The ratio of F/C increased both in P-PHr membrane (˜1.45) and S-PHr membrane (˜1.21), meaning a lower surface energy of the two modified membranes with higher fluorine density from the long fluoroalkyl chain (—CF₂— and —CF₃) of POTS. Additionally, O/C ratio increased from 0.09 to 0.21 in PH-rGO-SiNPs, resulting from the rich oxygen content from silicon dioxide (O—Si—O) of silica nanoparticles.

TABLE 1
Elemental composition of resultant membranes

| | Atom percent (%) | | | | | |
|---|---|---|---|---|---|---|
| | C 1s | O 1s | F 1s | Si 2p | F/C | O/C |
| PH-rGO | 44.54 | 4.16 | 51.3 | 0 | 1.15 | 0.09 |
| PH-rGO-SiNPs | 38.51 | 7.95 | 47.67 | 5.87 | 1.24 | 0.21 |
| PH-rGO-POTS | 36.75 | 6.30 | 53.32 | 3.63 | 1.45 | 0.17 |

The respective FTIR spectra of the pristine and modified PVDF-HFP/rGO membranes are shown in FIGS. 15, 16, and 17. The peak at 796.03 cm⁻¹ wavenumber in PH-rGO-POTS membrane was assigned to the Si—O stretching vibration in POTS—see Reference 1.4. The new peak appeared at 1101.41 cm⁻¹ (Si—O—Si stretching) and 796.03 cm⁻¹ (Si—O stretching) in PH-rGO-SiNPs membrane were the characteristic signals of hydrophobic silica nanoparticles—see References 1.5 and 1.6.

A possible mechanism of the condensation reaction between silane molecules (POTS and SiO₂ nanoparticles) and an oxide surface (PH-rGO) is shown in FIG. 18—see Reference 1.7. The Si—OR bonds in the POTS first hydrolyzed to form silanol Si—OH groups, which can then condensed with each other to form polymeric structures with hydroxyl groups on the PH-rGO material surface. Similarly, the Si—OR bonds and unreacted Si—OH in the fluorinated SiO₂ nanoparticles can form new Si—O bond on the PH-rGO nanofiber surface.

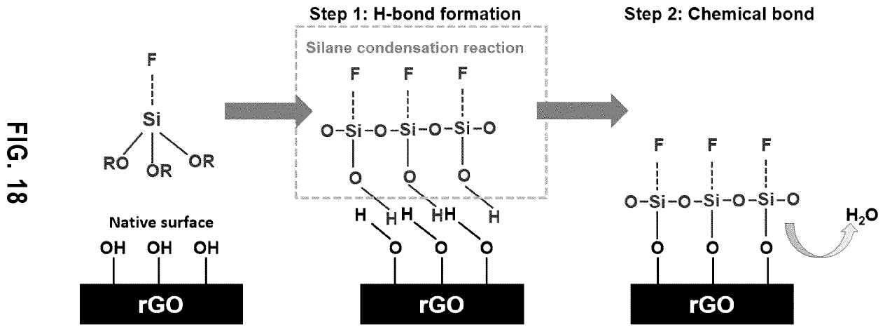

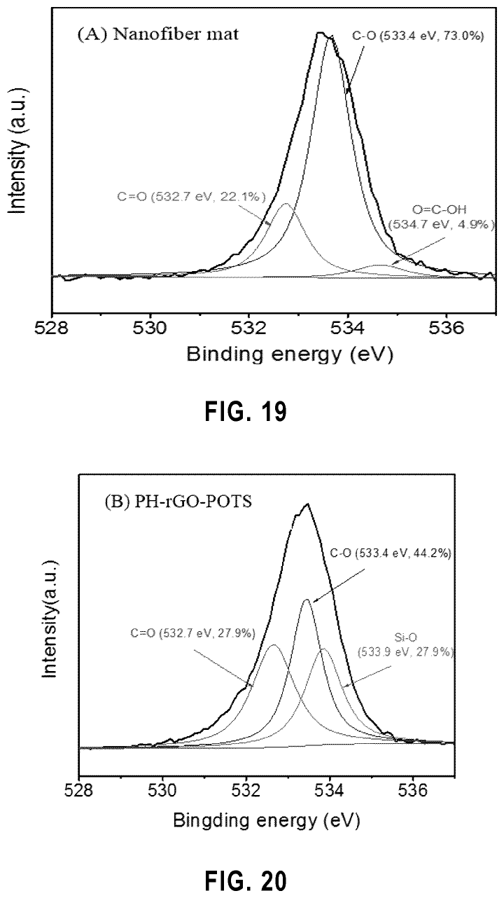

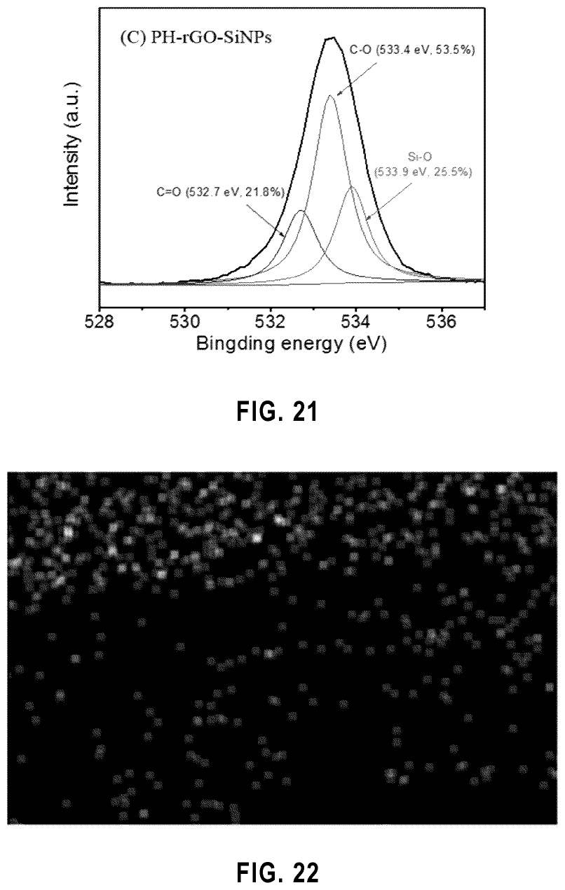

To further analyse the oxygen state on POTS-grafted or hydrophobic SiO₂ nanoparticles grafted membrane, high-resolution XPS spectra were collected at the binding energy from 536 to 528 eV. The Si—O peak at 533.9 eV appeared on the two modified membranes (FIGS. 20 and 21) while the O═C—OH peak at 534.7 almost diminished on the pristine PVDF-HFP-rGO nanofiber membrane surfaces (FIG. 19), indicating newly formed Si—O shown on the substrate membrane surface. Moreover, the hydrophobic-hydrophobic interaction between the fluoride-rich alkane groups from the POTS network and hydrophobic silica nanoparticles with the PH-rGO mat drove the POTS to bind on the nanofibers—see Reference 1.8.

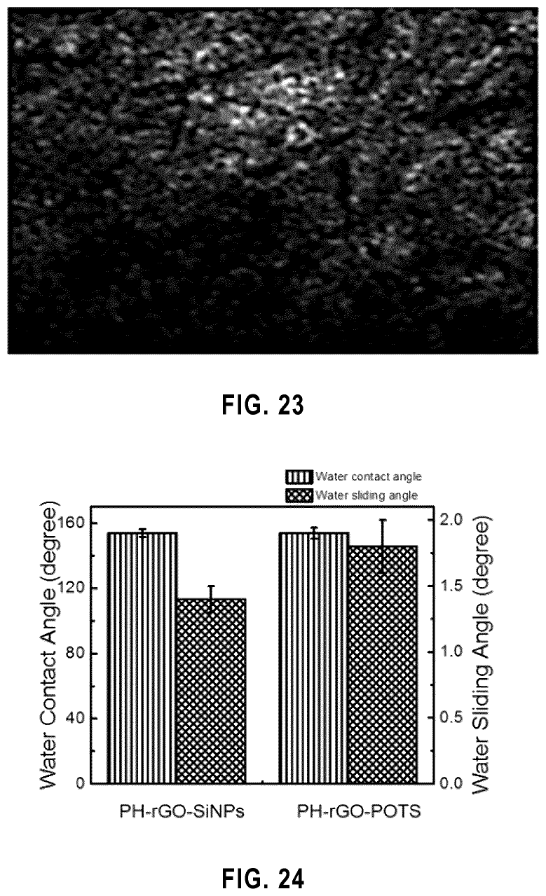

FIGS. 22 and 23 show the EDS mapping images of silicon (Si) on the PH-rGO-POTS and PH-rGO-SiNPs membranes cross-section, respectively. All the samples were analyzed using the same measurement parameters. It can be seen that the Si distributed all across the membrane but its content decreased with the depth for membranes modificated with POTS (PH-rGO-POTS membrane) and hydrophobic SiO₂ nanoparticles (PH-rGO-SiNPs membrane). It is possible that POTS and SiO₂ could penetrate in the membrane pores and bind on the fiber surface during the dip-coating process. Since POTS and SiO₂ enter inside the texture of PH-rGO substrate, it is difficult to peel them off and because of this extra adhesion, the modification robustness was enhanced. In addition, the PH-rGO-SiNPs membrane had a higher content of Si than the pristine PVDF-HFP-rGO nanofiber membrane because of the SiO₂ nanoparticles aggregation.

### Evaluation of Wettability (Contact Angle, Stability)

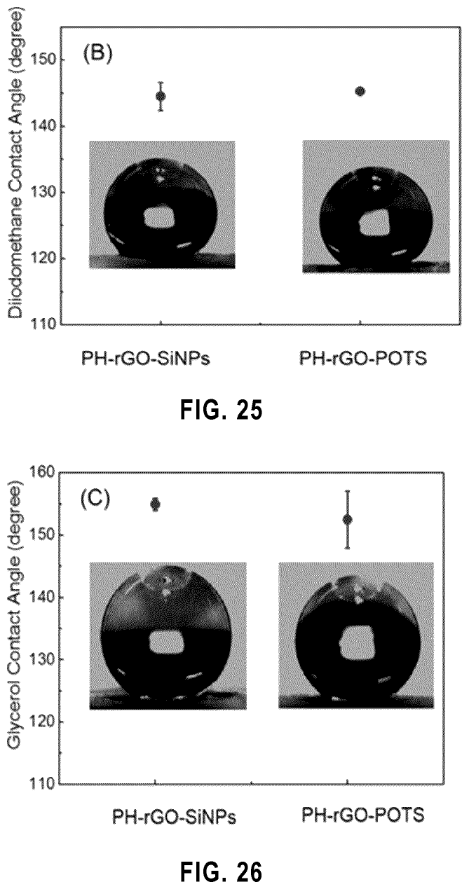

The surface wettability was characterized using the static contact angle using water (FIG. 24), diiodomethane (FIG. 25) and glycerol (FIG. 26) droplets. The reported values were calculated by averaging the three measurements at different locations.

FIG. 24 shows the static and sliding contact angle profiles of water for the two modified membrane samples. The water contact angle for the POTS molecules and SiO₂ nanoparticles grafted membrane was 158° and 157°, respectively. Interestingly, the two as-prepared membranes exhibited a extremely low contact angle hysteresis with sliding angle lower than 2°, therefore these two membranes are both superhydrophobic. The liquid droplet is suspended on the top of the asperities and the air fraction present between the surface and the droplet makes its suspension much easier, which consequently enables the droplet to roll off the membrane surface spontaneously after tilting to a small angle. Nearly sphere-like shapes were formed when water was dropped on the superhydrophobic membrane surface. The sphere-like drops could readily roll off from the surface because of low contact angle hysteresis, indicating their self-cleaning properties—see Reference 1.9.

In addition to superhrdrophobicity, the POTS molecules and SiO₂ nanoparticles modified membranes presented strong oleophobicity with a sharp increase in diiodomethane contact angle from 52.3° for pristine PVDF-HFP/rGO to 145.5° and 146.5°, respectively (FIG. 26). As mentioned above, electrospinning technique can be employed to form highly hydrophobic PVDF-HFP/rGO composite nanofibers with the reentrant structure required for achieving oleophobicity. A further water and diiodomethane contact angle enhance could be attributed to the second level of roughness and lower surface energy created by the aggregated POTS molecules and hydrophobic silica nanoparticles on the individual fibers. Overall, amphiphobicity was achieved on membrane grafted with POTS (PH-rGO-POTS membrane) or with hydrophobic SiO₂ nanoparticles (PH-rGO-SiNPs membrane).

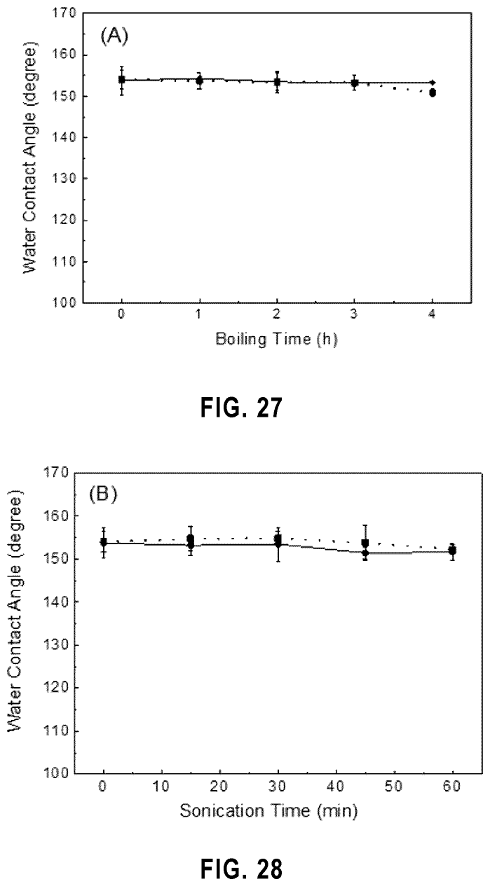

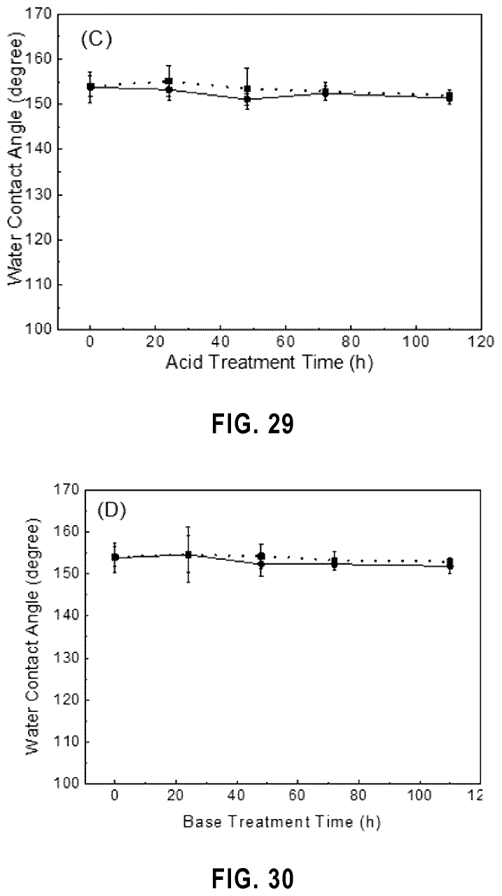

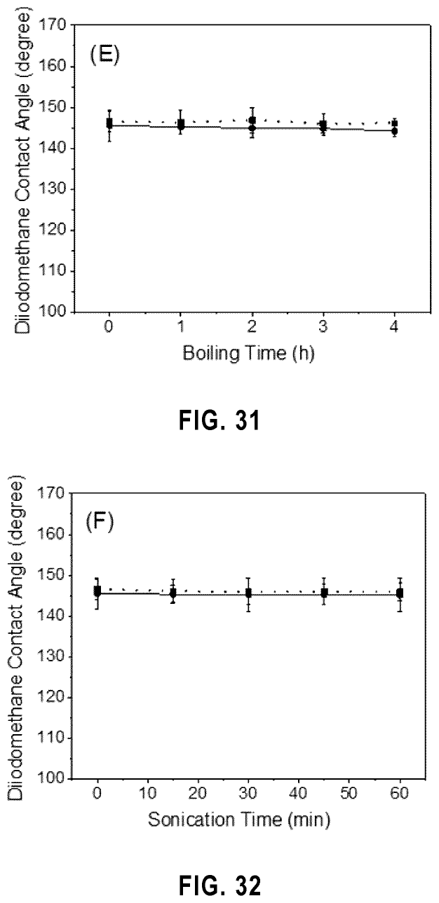

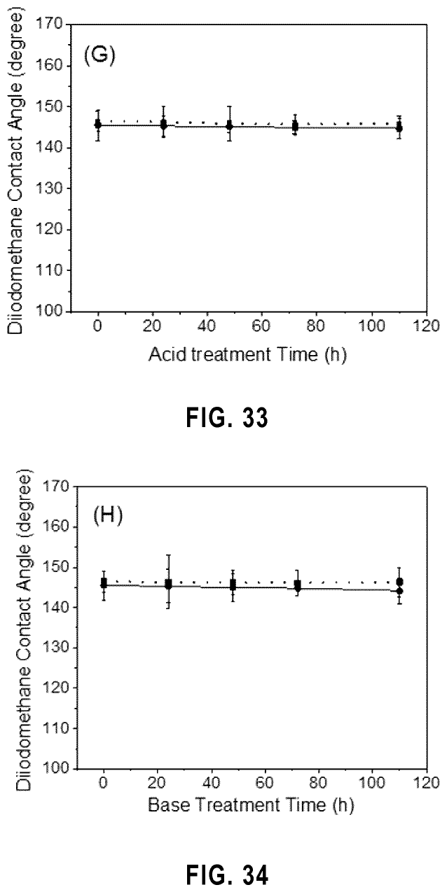

Conventionally the long-term stability of amphiphobic surfaces remains a challenge for their practical applications. Generally, due to the poor adhesion between the coating and the hydrophobic porous PVDF-HFP/rGO support, dip-coating method is perceived as being not effective as it produces coatings that tend to easily peel off from the support—see Reference 1.10. The membrane grafted with POTS and those grafted with hydrophobic SiO₂ nanoparticles unexpectedly possess robust amphiphobicity possibly due to the condensation reaction sites provided by the rGO with POTS molecules and SiO₂ nanoparticles. To further investigate the chemical and mechanical stability of the modified membranes, the membranes were challenged with critical conditions including boiling in water and exposure to strong acid and base solutions, and then their contact angles were determined against water and diiodomethane, respectively. The results reported in FIGS. 27 to 34 show that the water and diiodomethane contact angles of modificated membranes did not change and remain almost constant after the challenging treatments, including 4 h boiling in DI water, 110 h etching in HCI and NaOH solutions, and sonication for 1 h, demonstrating that the grafted POTS and SiO₂ could adhere to PVDF-HFP/rGO nanofibers firmly and withstand various harsh treatments. All these results suggest that two modified membranes are very stable to exhibit excellent amphiphobicity and have great potential for use in difficult conditions.

### Membrane Performance

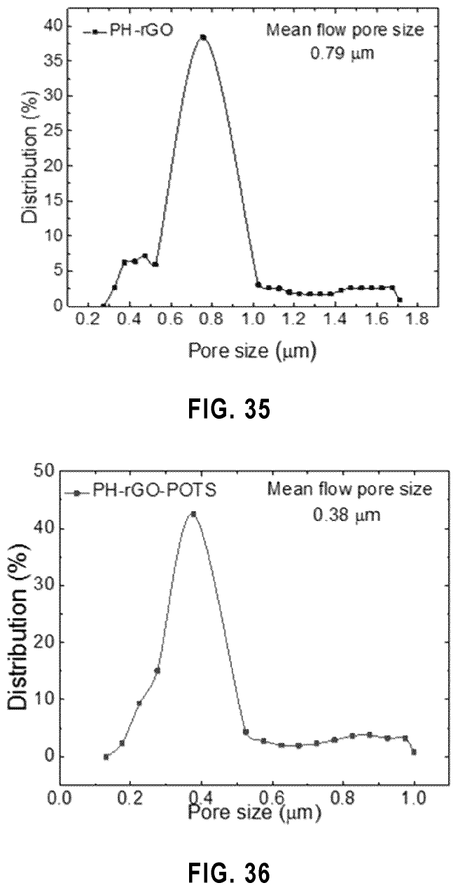

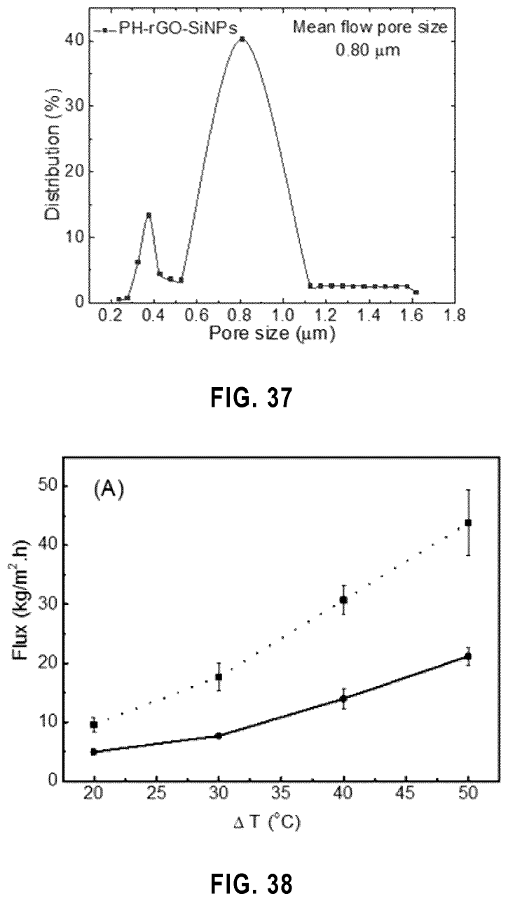

As can be seen from FIGS. 35 to 37, the SiO₂ nanoparticles modified membrane presents a larger mean flow pore size of 0.80 μm, while that of the POTS grafted membrane is 0.38 μm. Possibly the aggregated POTS would partially block the pore size, while the silica nanoparticles almost had no negative effect on the pore size. The correlation between pore size and flux was in accordance with DCMD flux performance—see below. A higher flux is obtained for PH-rGO-SiNPs membrane compared with PH-rGO-POTS membrane.

The DCMD test was first conducted using NaCl solution as the feed to assess the performance characteristics of the two modified membranes. The effect of different parameters such as feed and coolant temperature, the feed salt concentration on product distillate water were analyzed.

In FIG. 38, the effect of temperature difference, AT (feed-coolant temperature difference) on the permeate flux is shown. It can be observed that higher temperature differences increase the permeate flux. Most importantly, membrane grafted with hydrophobic SiO2 nanoparticles exhibited higher flux than that modified by POTS. Its permeate flux varies from 9.8 kg/(m2 h) to 44.2 kg/(m2 h) for an increment in the temperature difference from 20° C. to 50° C. This phenomenon can be explained by the increased vapor pressure and heat transfer at higher temperature differences. It is important to note that the permeate flux is highly sensitive to the temperature difference across the membrane.

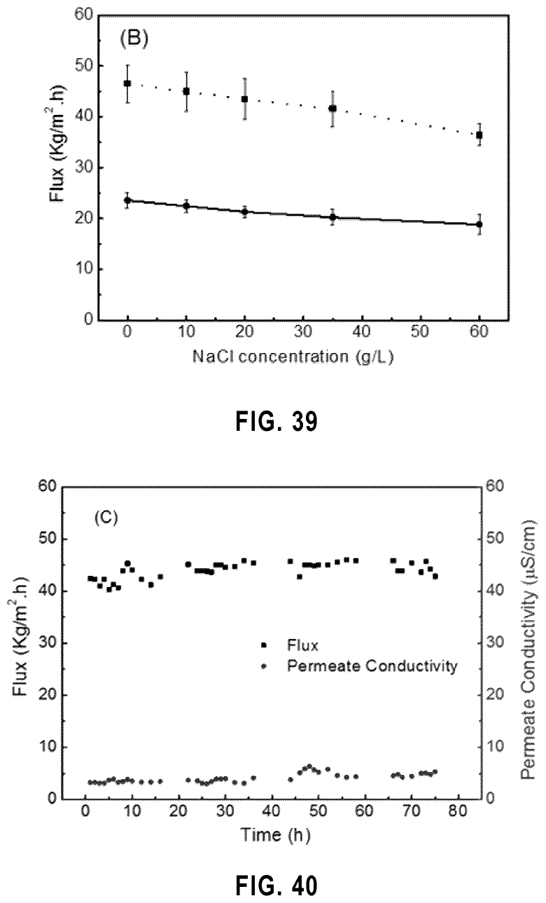

FIG. 39 shows the effect of salt concentration (in grams/Liter) on the product water flux. It can be seen that the increment in the feed concentration leads to a slight reduction (compared with others) in the permeate flux. This reduction is due in part to reduction in vapor pressure as a result of the salt concentration boundary layer at the membrane surface which reduce the mass transfer coefficients—see References 1.11 and 1.12.

It can be seen from FIG. 39 that the permeate flux for PH-rGO-SiNPs membrane and PH-rGO-POTS membrane decreased by about 23.1% and 16.8% respectively when the salt concentration of feed solution increased from 0 to 60 g/L. Here, one interesting phenomenon is that the silica nanoparticles modification seems much more effective than the POTS molecules grafted with a higher water vapor permeability under the same DCMD condition. Usually, greater flux is associated with higher porosity [see Reference 1.13], which was not the case in this study, since the porosity of PH-rGO-SiNPs membrane is only a little higher than that of PH-rGO-POTS membrane (78.8% vs 73.5%). The vapor permeability does not depend solely on the porosity but also on pore sized. It can be deduced that that this prominent flux was ascribed to the largest mean flow pore size of PH-rGO-SiNPs as analyzed previously. Therefore, only the membrane grafted with hydrophobic SiO2 nanoparticles (PH-rGO-SiNPs membrane) was used in the DCMD process to further test the anti-wetting and anti-fouling property.

### Long-Term Stability of PH-rGO-SiNPs Membrane

To investigate the impact of grafted silica nanoparticles on the membrane performances, the water flux and salt rejection of PH-rGO-SiNPs nanofibrous were tested in the DCMD process over a long-term operation using 3.5 wt % NaCl with addition of 0.3 mM SDS solution as a feed solution maintained at 75° C. and DI water was used as a permeate cooling solution maintained at 25° C. FIG. 40 shows that the water flux of the SiO₂—grafted amphiphobic membrane was around 42 kg/(m² h) with satisfactory permeate conductivity lower than 7 μS/cm for a period of 75 h. The stable permeability and high salt rejection of PH-rGO-SiNPs membrane can be attributed to the superhydrophobic membrane surface with a high contact angle of 157° and low sliding angle of 1.4°, which indicates the water repellency and self-cleaning ability of the membrane surface. It is difficult for the feed to directly contact such superhydrophobic membrane surface due to the presence of an ultrathin air gap between them—see Reference 1.17. The self-cleaning property of PH-rGO-SiNPs membrane prevents the membrane from pore wetting, while the strong adhesive property of most commercial membranes and non-modified polymer membranes makes the membrane pores being wetted quickly—see References 1.18 to 1.21.

### Amphiphobicity of the PH-rGO-SiNPs Membrane

Sodium dodecyl sulfate (SDS) is a characteristic popular surfactant in wastewater, often remarkably decreasing the surface tension of wastewater, which normally wets the MD membrane and breaks its performance immediately—see Reference 1.21 and 1.22.

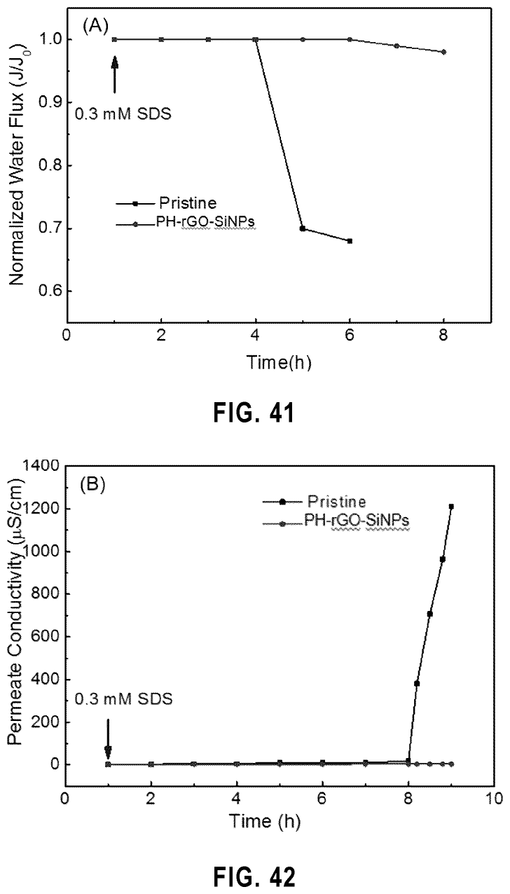

Here, 0.3 mM SDS was introduced into 3.5 wt % NaCl feed solution to challenge the membrane stability during the DCMD process. FIGS. 41 and 42 show the permeate flux and conductivity change of the pristine PVDF-HFP/rGO and SiNPs grafted membranes during DCMD process under the presence of amphiprotic pollutant, SDS. The pristine PVDF-HFP/rGO membrane lost its water flux after 4 h addition of 0.3 mM SDS into feed solution and permeate conductivity starts to increase sharply after 8 h, indicating the pristine membrane was partly wetted first by SDS and then lost its salt rejection performance after full wetting. The partial wetting phenomenon can be explained by the distribution of liquid entry pressures due to heterogeneous pore size distributions—see Reference 1.23. As the surface tension was reduced due to increasing SDS concentration, some larger pores became flooded by the SDS solution because their liquid entry pressures were reduced to levels lower than the hydraulic pressure in the feed channel.

It is interesting that the pristine membrane was not wetted immediately once the SDS was added into the feed, meaning it already had some resistance against low surface tension solutions and could be a good candidate for substrate aiming for amphiphobic membranes. The highly hydrophobic electrospun PVDF-HFP/rGO nanofiber substrate with the reentrant structure exhibited glycerol contact angle around 130°. The capability to prevent surfactant wetting should also be correlated with its surface superhydrophobicity. Similar phenomenon has also been observed on highly hydrophobic polymer surfaces (Teflon AF, Parafilm and PP) with ionic surfactants such as cationic dodecyltrimethylammonium bromide (DTAB) and anionic sodium dodecyl sulfate (SDS)—see Reference 1.24. Therefore, the membrane with highly amphiphobic grafted can also effectively prevent wetting from SDS in the feed.

The SiNPs grafted PVDF-HFP/rGO amphiphobic membrane showed a striking contrast and presented a relatively stable water flux with no obvious decrease and keep constant 100% salt rejection. There was almost no NaCl penetration across the membrane (99.99% of salt rejection) and the modified membrane possessed high wetting resistance against SDS.

The stronger anti-wetting property of PH-rGO-SiNPs nanofibrous membrane as compared to PVDF-HFP/rGO is attributable to the second scale of roughness introduced by the SiN Ps on the fiber surface, which rendered the local wetting of individual fibers more difficult. The importance of multiscale reentrant structure on enhancing the superhydrophobicity or amphiphobicity of membranes is relatively well understood—see References 1.25 and 1.26. In previous studies, the additional local reentrant structure was imparted by coating fluorinated TiO₂ or SiO₂ nanoparticles onto the existing membrane substrates, which has been shown to be very effective in mitigating membrane wetting—see Reference 1.27. Here, we demonstrate an effective anti-wetting MD membrane with hierarchical roughness can be fabricated on the rGO based polymeric substrate without any pretreatment to create a second scale of reentrant structure. In conclusion, the SiNPs grafted improved the dynamic anti-wetting property of PVDF-HFP/rGO nanofibrous membrane against SDS surfactant in the DCMD process.

### EXAMPLE 2

### Membranes for Forward Osmosis—Silica Nanoparticle-Containing Thin-Film Composite Membrane

A high flux and antifouling thin-film composite (TFC) forward osmosis (FO) membrane containing silica (SiO₂) nanoparticles was fabricated using a facile electrospinning technique followed by interfacial polymerization on surface of electrospun nanofiber mat. The successful fabrication of the TFC membrane was confirmed via FE-SEM, TEM, XRD, FTIR, and AFM analyses.

Both the electrospun nylon 6 (N6) substrate and the polyamide (PA) active layer contained superhydrophilic SiO₂ nanoparticles enhancing the hydrophilicity of the fabricated FO membrane. The fabricated electrospun N6/SiO₂-supported TFC FO membrane with a PA/SiO₂ composite active layer was robust (tensile strength of 22.3 MPa) with a water contact angle of 14°.

In the FO process, the fabricated TFC membrane exhibited a high water flux (27.10 LMH) with a low specific reverse salt flux (5.9×10⁻³ mol·L⁻¹). The fabricated membrane also showed high antifouling propensity in FO process for the model foulants of sodium alginate and calcium sulfate. The initial water flux recovery for this membrane was 98% for sodium alginate and 94% for calcium sulfate.

Moreover, a strong interaction between the electrospun substrate and the active layer demonstrated the structural stability of the fabricated TFC membrane. Experimental

### REFERENCES FOR THIS EXAMPLE

The present Example refers to the following documents, all of which are incorporated herein by reference.
2.1. M. S. Islam et al., J. Colloid Sur. A: Physicochem. Eng. Asp. 484 (5) (2015) 9-18.
2.2. M. S. Islam et al., Carbohydrate Polym. 115 (2015) 69-77.
2.3. T. D. Naylor, Polymer Membranes—Materials, Structures and Separation Performance; Dolbey, R. T. L., Ed.; Rapra Technology Limited: Billingham, UK, 1996.
2.4. R. J. Peterson, J. E. Cadotte, Thin Film Composite Reverse Osmosis Membrane. In Handbook of Industrial Membrane Technology, Porter, M.C., Ed.; Noyes Publications: Westwood, N.J., 1990.
2.5. N.-N. Bui et al., Osmosis, Environ. Sci. Technol. 48 (2014) 4129-4136.
2.6. M. S. Islam et al., J. Membr. Sci. 537 (2017) 297-309.
2.7. U. Zulfiqar et al., Colloids Surfaces A: Physicochem. Eng. Aspects 508 (2016) 301-308.
2.8. D. Emadzadeh et al., Chem. Eng. J. 237 (2014) 70-80.
2.9. J.-F. Li et al., Appl. Surf. Sci. 255 (2009) 4725-4732.
2.10. C. Liao et al., Desalination 285 (2012) 117-122.
2.11. H. Li et al., Appl. Surf. Sci. 346 (2015) 134-146.
2.12. J. Yin et al., Desalination 365 (2015) 46-56.
2.13. L. Shen et al., Chem. Eng. Sci. 143 (2016) 194-205.
2.14. G. Han et al., Appl. Energy 132 (2014) 383-393.
2.15. X. Li et al., Appl. Energy 114 (2014) 600-610.
2.16. G. D. Mehta et al., J. Membr. Sci. 4 (1978) 261-265.
2.17. S. Loeb et al., J. Membr. Sci. 129 (1997) 243-249.
2.18. S.-F. Pan et al., J. Membr. Sci. 523 (2017) 205-215.
2.19. H. R. Pant et al., Colloid Surf. A: Physicochem. Eng. Asp. 370 (2010) 87-94.
2.20. Nirmala, K. T. et al., Appl. Surf. Sci. 256 (2010) 6318-6323.
2.21. T. M. Ting et al., Radia. Phy. Chem. 109 (2015) 54-62.
2.22. Q. Shi et al., J. Appl. Polym. Sci. 120 (2011) 425-433.
2.23. S. Liang et al., ACS Appl. Mater. Interf. 5 (2013) 6694-6703.
2.24. J. Ahmad et al., J. Membr. Sci. 427 (2013) 73-84.
2.25. M. Tian et al., Sep. Purif. Technol. 118 (2013)727-736.
2.26. B. Khorshidi et al., J. Membr. Sci. 511 (2016) 29-3.
2.27. C. Boo et al., J. Membr. Sci. 473 (2015) 302-309.
2.28. N. Y. Yip et al., Environ. Sci. Technol. 44 (2010) 3812-3818.
2.29. A. Tiraferri et al., J. Membr. Sci. 367 (2011) 340-352.
2.30. N. Widjojo et al., J. Membr. Sci. 383 (2011) 214-223.
2.31. X. Song et al., Adv. Mater. 23 (2011) 3256-3260.
2.32. K. Y. Wang et al., AIChE J. 58 (2012) 770-781.
2.33. X. Li et al., Ind. Eng. Chem. Res. 51(2012) 10039-10050.
2.34. G. Han et al., J. Membr. Sci. 423-424 (2012) 543-555.
2.35. M. Yasukawa et al., J. Membr. Sci. 487 (2015) 51-59.
2.36. N. Ma et al., J. Membr. Sci. 405-406 (2012) 149-157.
2.37. L. Huang et al., J. Membr. Sci. 499 (2016) 352-360.
2.38. C. S. Ong et al., Desalination 393 (2016) 2-15

### Experimental

### Materials

Nylon 6 (N6), tetraethyl orthosilicate (TEOS), ethyl alcohol (C2H5OH), ammonium hydroxide (NH4OH), m-phenylenediamine (MPD), 1,3,5-benzenetricarbonyl trichloride (TMC), and hexane were obtained from Sigma-Aldrich, USA. Both formic acid and acetic acid were acquired from Fisher Scientific, USA. A commercial flat-sheet TFC forward osmosis membrane was purchased from Hydration Technology Innovations (HTI, Albany, Oreg., USA). De-ionized (DI) water was obtained from a Millipore Integral 10 water system (Millipore, Billerica, Mass.).

### Fabrication of TFC Membrane

### Fabrication of a N6/SiO₂ Composite Nanofiber Substrate by Electrospinning Technique

N6 (21% by weight) was dissolved in a mixture of formic and acetic acids (80% formic acid and 20% acetic acid by volume) using magnetic stirring (rpm 350) for 5 h at room temperature. Separately, a SiO₂ solution was prepared by mixing TEOS, ethanol, and water at a molar ratio of 1:2:2, respectively, in the presence of an NH₄OH catalyst and stirred at 25° C. for 4 h. SiO₂ nanoparticles were then separated from the mixture through centrifugation. Subsequently, SiO₂ nanoparticles were dispersed in a formic acid (80% by volume) and acetic acid (20% by volume) mixture under sonication for 20 min. An appropriate ratio of SiO₂ dispersion was added to the N6 solution and sonicated for 5 min and then stirred for 5 h at ambient conditions to make a N6/SiO₂ solution with 20% SiO₂ content. In the electrospinning process, high-voltage electricity (Nanospinner NE300, Inovenso, Turkey) was applied to the prepared N6/SiO₂solution in a syringe (volume 20 mL, inside diameter 19.05 mm) via an alligator clip attached to the syringe nozzle. The applied voltage was adjusted to 30 kV. The solution was delivered to the nozzle tip via a syringe pump to control the solution flow rate (0.18 mL/h). Fiber mats were collected on an electrically grounded metallic drum placed 8.8 cm above the nozzle tip—see References 2.1 and 2.2. Temperature (25° C.) and relative humidity (40%) were controlled by the electrospinning machine itself and a dehumidifier (RECUSORB DR-010B), respectively, throughout the fabrication process.

A N6 solution without SiO₂ nanoparticles was also electrospun to fabricate a pristine N6 nanofiber mat as a substrate of the TFC membrane.

### Formation of PA/SiO₂ Composite Active Layer on the Substrate

An active layer of PA/SiO₂ nanoparticle composite was formed on the electrospun N6/SiO₂ substrate by an interfacial polymerization reaction. First, the electrospun substrate was put on a glass plate and then each side of the substrate was tapped with the glass plate very well. The electrospun substrate with the glass plate was immersed in an aqueous MPD/SiO₂ solution (1% MPD and 1, 2, 4 and 6% SiO₂ with respect to MPD) for 2 min. Excess MPD solution was removed from the substrate surface using an air knife. The MPD/SiO₂ substrate was then dipped into a solution of 0.15 wt % TMC in hexane for 1 min (to form an ultrathin PA/SiO₂ composite as active layer by an interfacial polymerization reaction between MPD and TMC) followed by removal of the excess TMC solution from the top surface of the substrate using an air knife. The electrospun substrate with the PA/SiO₂composite active layer was then heated at ˜75° C. in an oven for 10 min to complete internal cross-linking of the remaining un-reacted precursors of interfacial polymerization reaction—see References 2.3 to 2.5.

A schematic representation of the interfacial polymerization between MPD and TMC is presented below:

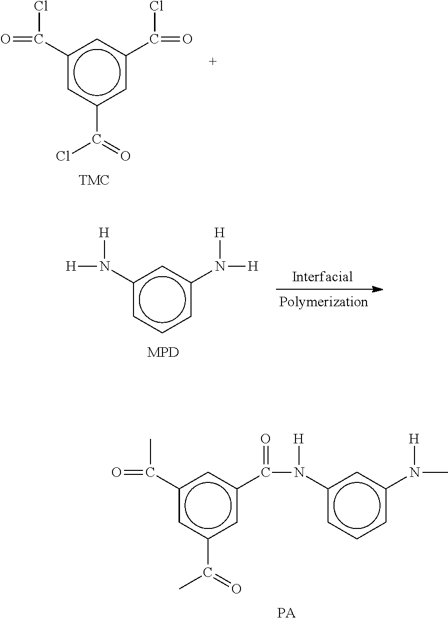

A polyamide active layer was also fabricated on the electrospun N6/SiO₂ substrate without adding SiO₂ nanoparticles into MPD solution during the interfacial polymerization between MPD and TMC as the same protocol mentioned above. Moreover, both polyamide and polyamide/SiO₂ composite (4% SiO₂ content as regards MPD) active layers were fabricated on the electrospun N6 substrate.

All the fabricated TFC membranes were stored in DI water until they were tested. These TFC membranes are summarized in Table 2.

TABLE 2
A list of the fabricated TFC membranes.

| | Representative |
|---|---|
| Membrane description | symbol |
| Electrospun N6 supported membrane with PA | E. Spun N6-PA |
| active layer | |
| Electrospun N6 supported membrane with PA/ | E. Spun N6-PA/SiO₂ |
| SiO₂ active layer | |
| Electrospun N6/SiO₂ supported membrane with | E. Spun N6/SiO₂-PA |
| PA active layer | |
| Electrospun N6/SiO₂ supported membrane with | E. Spun N6/SiO₂-PA/ |
| PA/SiO₂ active layer | SiO₂ |

### Fabrication of N6 Substrate by Casting and Phase Inversion Method

A N6 substrate was also prepared by casting and phase inversion method. A 21% N6 solution (by weight) in 80% formic acid and 20% acetic acid mixture (by volume) was manually cast on a clean glass plate using a casting knife with the thickness of 85 μm at ambient condition. After casting, the film was dried for 24 h at ambient condition and then it was peeled from the glass plate. Finally, the film was immersed into DI water for another 24 h in order to remove the remaining solvent.

### Physicochemical Characterization

Field emission-scanning electron microscopy (FE-SEM) (QUANTA FEG 450) with a platinum coating on the sample surface was performed to observe the morphology of the substrates and TFC membranes. Cross-sectional morphology and thickness of the TFC membrane were measured using FE-SEM and a TMI instrument (Testing Machines, Inc.), respectively—see Reference 2.6.

Transmission electron microscopy (TEM) (TF20) was conducted to examine the morphology of the electrospun substrates. A structural study of the electrospun substrates was conducted via the use of X-ray diffraction (XRD) (Bruker D8 Discover with a copper X-ray source and equipped with a Vantec area detector), and Fourier transform infra-red (FTIR) (NICOLET 6700 FT-IR) spectrometry. The wettability and surface roughness of both the substrates and TFC membrane were investigated using a VCA optima instrument (AST Products, Inc.), and an atomic force microscope (AFM) (BRUKER, NanoScopeRV), respectively. The wettability of SiO₂ nanoparticles was also investigated using the VCA optima instrument (AST Products, Inc.).

The analysis was performed using the same protocol for SiO₂ nanoparticles described elsewhere—see References 2.6 and 2.7. Briefly, a few drops of SiO₂ nanoparticle suspension, in ethanol, were placed on a glass slide and then dried in an oven at 80° C. for 30 min followed by cooling the SiO₂ nanoparticles on the glass slide at room temperature. Then, the VCA optima instrument was used to determine the water contact angle of the SiO₂ nanoparticles placed on the glass slide. The tensile strength of the substrates and TFC membrane were investigated using an Instron instrument (Mini 44), USA.

### Porosity and Pore Size of the Electrospun Substrate

The gravimetric method was used to investigate the porosity of the electrospun substrate, using the following equation:

$$ɛ ( \% ) = \frac{{W}_{w} - {W}_{d}}{{ρ}_{w} AL} \times 100 \qquad ( 2.1 )$$

where W_{w} and W_{d} are the weight of the wet and dry substrates, respectively; ρ_{w} is the water density (0.998 g cm⁻³); A is the effective area of the substrate; and L is the substrate thickness—see Reference 2.8 to 2.12.

The mean pore size of the substrate was determined via the filtration velocity method. The volume of permeate water was obtained using a dead-end stirred cell filtration device (Millipore stirred ultra-filtration cells, 8010, USA, effective area of 0.0003 m²) connected to a nitrogen gas cylinder. The mean pore size (rₘ) was calculated using the Guerout-Elford-Ferry equation:

$${r}_{m} = √ [ \frac{( 2.9 - 1.75 ɛ ) \times 8 η {lQ}_{T}}{ɛ A Δ P} ] \qquad ( 2.2 )$$

where ε is the substrate porosity; η is the water viscosity (8.9×10⁻⁴ Pa s); I is the substrate thickness; Q_{T} is the permeate volume per unit time; ΔP is the applied pressure (1 bar); and A is the effective area of the substrate—see References 2.9 to 2.12.

The maximum pore size (Rₘₐₓ) was determined via the bubble point method. The bubble point pressure was determined using the aforementioned dead-end stirred cell filtration system—see Reference 2.6. The substrate was immersed in DI water for 4 h and then fitted on the dead-end cell. The output tube of the dead-end cell was immersed in DI water so that the bubble point pressure could be read. The maximum pore size was calculated according to Laplace's equation:

$${R}_{max} = \frac{2 σ cos θ}{P} \qquad ( 2.3 )$$

where σ is the surface tension of water (72.80×10⁻³ Nm⁻¹); θ is the contact angle of water on the substrate; and P is the minimum bubble point pressure—see References 2.6 and 2.9.

### Performance Evaluation of the TFC Membrane

### Water Permeability, Salt Rejection, Salt Permeability and Structural Parameters

A flat-sheet TFC membrane was used to conduct all the forward osmosis experiments. The water permeability coefficient (A) and salt permeability coefficient (B) for the TFC membrane were investigated using a bench-scale cross-flow RO test system. A piece of the membrane with an effective surface area of 19.94 cm² was placed in a stainless-steel test cell with the active surface of the membrane facing the feed stream. Using a high-pressure positive displacement pump (Hydra-cell pump), the feed solution was re-circulated at the velocity of 52.6 cm/s. DI water was used as the feed stream to investigate A, and a 20 mM solution of NaCl was used as the feed stream to investigate R (rejection) and B for the TFC membrane.

A, R and B for the membrane were determined using the following equations:

$$\begin{matrix}J = \frac{Δ V}{{A}_{m} Δ t} & ( 2.4 ) \\ A = \frac{J}{Δ P} & ( 2.5 ) \\ R ( \% ) = \frac{{C}_{f} - {C}_{p}}{{C}_{f}} \times 100 & ( 2.6 ) \\ B = \frac{A ( 1 - R ) ( Δ P - Δπ )}{R} & ( 2.7 )\end{matrix}$$

where J is the pure water flux; Aₘ is the effective membrane area; ΔV is the permeate volume; Δt is time; ΔP is the hydraulic pressure difference across the membrane; C_{f} is the salt concentration of the feed solution; Cₚ is the salt concentration of the permeate solution; and Δπ is the osmotic pressure of the feed solution—see References 2.8 and 2.13 to 2.15.

The pressure was increased in 0.345 MPa increments from 0.345 to 1.034 MPa in order to investigate A of the TFC membrane. Constant pressure was applied at each increment for 8 h. The water flux through the membrane was obtained from a liquid flow sensor (Sensirion, The Sensor Company) directly connected to a computer. To investigate R and B, 1.896 MPa pressure was applied to the RO cell. Conductivity of the feed and permeate solutions was investigated using a calibrated conductivity meter (Oakton, Eutech Instruments) to calculate solute rejection. This experiment was conducted at a constant temperature of 24° C. using a chiller (Polystat, Cole-Parmer).

A bench-scale FO test system was used to determine the structural parameter (S) of the TFC membrane by applying the following equation:

$$S = ( \frac{D}{{J}_{w}} ) ln [ \frac{A {π}_{draw} + B}{A {π}_{feed} + {J}_{w} + B} ] \qquad ( 2.8 )$$

where J_{w} is the FO water flux for the draw solutions. In this approach, de-ionized water was used as the feed solution, while 1 M NaCl was used as the draw solution—see References 2.8, 2.13, 2.16 and 2.17.

### Water Flux and Reverse Salt Flux in FO Experiment

A bench-scale experimental setup (shown in FIG. 43) was used to evaluate the FO performance of the TFC membranes. DI water and 1M NaCl solution were used as the feed and draw solutions, respectively, in the FO experiment. A piece of the membrane with an effective surface area of 19.94 cm² was placed in an acrylic cross-flow cell with the active layer of the membrane facing the feed stream. On both sides of the membrane, the cross-flow cell had symmetric channels, which allowed for both the feed and the draw solutions to flow tangential to the membrane. Re-circulation of the feed solution and the draw solution on the opposite sides of the membrane was executed using two variable-speed gear pumps (Gear Pump Drive, Cole-Parmer Instrument Company). The flow rate of each solution was maintained at 26.3 cm/s. The feed solution temperature and the draw solution temperature were held at a constant temperature of 24° C. and monitored with a thermometer. The feed solution and the draw solution were placed in two separate 4.0 L reservoirs to conduct the experiment. The feed solution container was placed on a digital analytical balance. The water flux and the reverse salt flux were determined to evaluate the FO performance of the TFC membranes. Each experiment was conducted for one hour and the concentration of the draw solution was adjusted by adding concentrated draw solution in every 15 min. The water flux through the membrane was obtained from the digital analytical balance by using equation (2.4) above. To investigate the reverse salt flux, a sample of the feed solution was collected before and after the experiment to determine the salt concentration using a calibrated conductivity meter (Oakton, Eutech Instruments). Reverse salt flux was calculated using the following equation:

$${J}_{s} = \frac{{C}_{f} {V}_{f} - {C}_{f \cdot i} {V}_{f \cdot i}}{{A}_{m} Δ t} \qquad ( 2.9 )$$

where C_{f} and V_{f} are the salt concentration and total volume of the feed, respectively, at the end of the tests; and C_{f,i} and V_{f,i} are the initial salt concentration and total volume of the feed, respectively—see Reference 2.18.

### Membrane Antifouling Test

Sodium alginate (SA) and calcium sulfate (CaSO₄) were used as model organic and inorganic foulants, respectively, to investigate the antifouling properties of the FO membranes. The membrane coupon was placed into the FO cell with the active layer facing the feed side. The membrane coupon was immersed in DI water for 24 h before conducting the antifouling test. First, the FO experiment was conducted for 6 h at a flow rate of 26.3 cm/s using 1 M NaCl as draw solution and DI water as feed. Then, 1 M NaCl, as draw solution, and DI water with SA (200 mg/L) and CaCl₂ (1 mM), as feed solution, were used to conduct the antifouling test for 6 h at the same flow rate (26.3 cm/s) using a new membrane coupon. To investigate antifouling propensity in relation to CaSO₄, 1 M NaCl as draw solution and DI water with CaSO₄ (2000 mg/L) as feed solution, were used to conduct the antifouling test. This experiment was also conducted for 6 h at a flow rate of 26.3 cm/s using a new membrane coupon. Weight changes of the feed solution throughout the FO experiments were monitored precisely using a digital weight balance at fifteen-minute intervals. Then, for 2 h, DI water with a flow rate of 52.6 cm/s was applied to physically clean the membrane active surface of the both fouled membranes (fouled by SA and CaSO₄). In the FO experiment, the water flux through the cleaned membranes was measured using 1 M NaCl and DI water as draw and feed, respectively, in order to investigate flux recovery for these membranes. These experiments were also conducted for 6 h at a flow rate of 26.3 cm/s in which the weight changes of the feed solution were monitored using a digital weight balance at fifteen-minute intervals.

### Results

### Morphology of the Electrospun Substrates

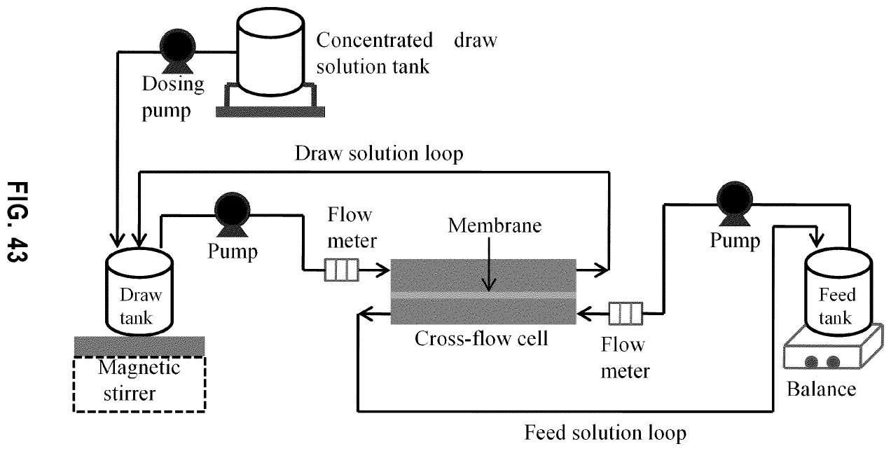

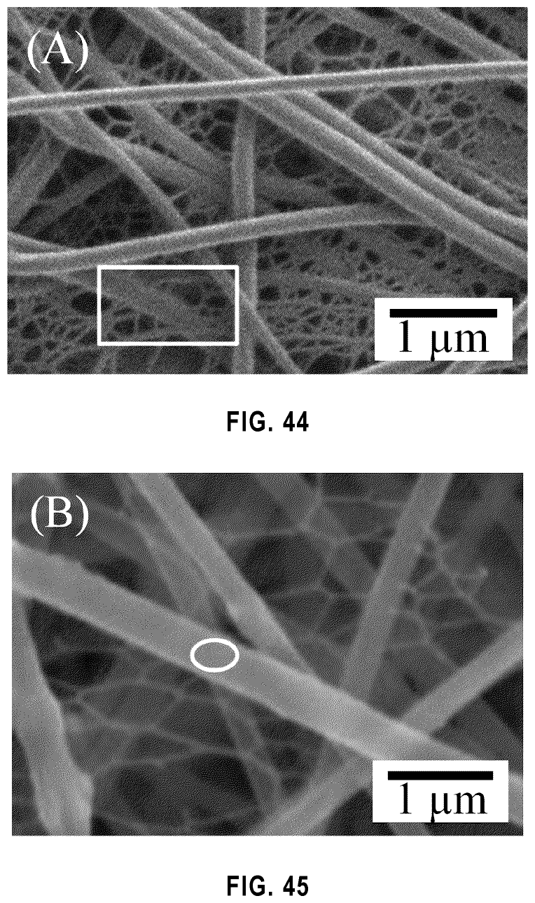

The FE-SEM images of N6 and N6/SiO₂ composite electrospun substrates with 20 wt. % SiO₂ content are shown in FIGS. 44 and 45. A mixture of 80% formic acid and 20% acetic acid by volume was used as solvent to prepare pristine N6 (FIG. 44) and N6/SiO₂ (FIG. 45) blended solutions for electrospinning. The surface of the electrospun substrates was coated with Pt to capture these FE-SEM images. The electrospun N6/SiO₂ composite with 20 wt. % SiO₂ content was the best composite studied in our previous report—see Reference 2.6.

The electrospun N6 substrate showed a fibrous morphology in which the diameter of the fibers ranged between 80 to 160 nm (FIG. 44). The spider-web like structure was obtained in the mat substrate due to higher applied voltage (30 kV) that lead to ionization of N6 in the acid solvent during electrospinning of the N6 solution—see References 2.6, 2.19 and 2.20. As seen in FIG. 45, the diameters of the fibers of the electrospun N6 substrate increased with the addition of SiO₂ nanoparticles. The addition of highly surface-active SiO₂ nanoparticles increase both the viscosity and surface tension of the electrospinning solution, which contribute to increase the diameter of nanofibers of the electrospun N6/SiO₂ composite substrate. Furthermore, the density of the spider-web like structure of electrospun substrates was decreased with the incorporation of SiO₂ nanoparticles (FIG. 45). The addition of SiO₂ nanoparticles may have decreased the conductivity of the ionic N6 solution, which in turn decreased the ionization of the N6 during the electrospinning process. Hence, the density of the spider-web like structure of electrospun N6/SiO₂ composite substrate was decreased due to a decrease in the conductivity of the ionic N6.

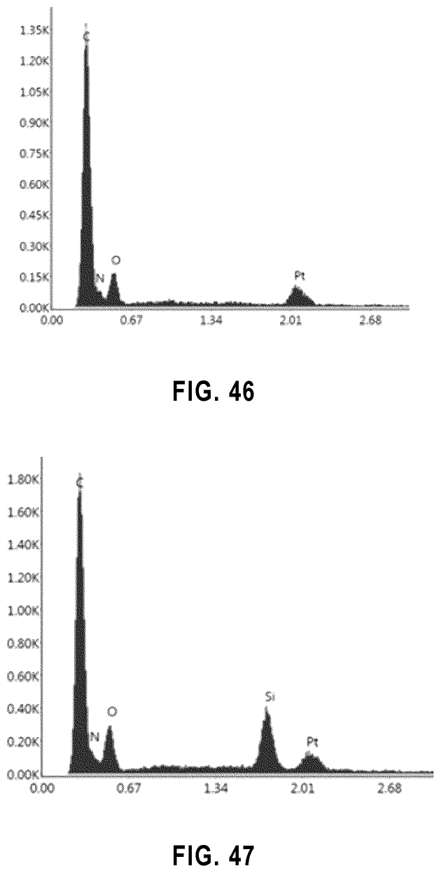

The SEM-EDX spectra of the electrospun substrates for the pristine N6 and N6/SiO₂ composite are shown in FIGS. 46 and 47. The SEM-EDX spectrum shown in FIG. 46 was taken from the region in a rectangle in FIG. 44, while that shown in FIG. 47 was taken from the region in an oval in FIG. 45.

The EDX analysis suggests the presence of C, N and O atoms of N6 (FIG. 46). Pt was also obtained in the EDX spectrum due to the Pt coating applied to conduct the SEM analysis for the electrospun N6 substrate. The N6/SiO₂ composite substrate showed an additional peak for Si and an O peak with a higher intensity (FIG. 47) than previously observed for N6 alone (FIG. 46). This result confirmed the successful incorporation of SiO₂ nanoparticles into the electrospun N6 substrate.

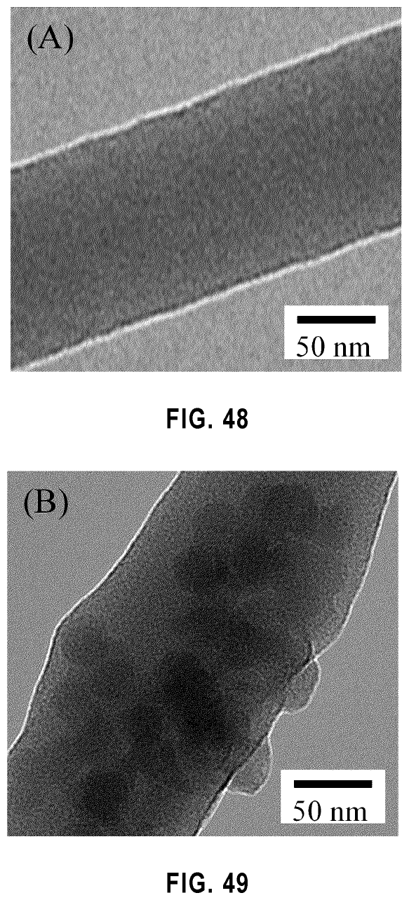

TEM images of the electrospun substrates of pristine N6 and N6/SiO₂ composites are shown in FIGS. 48 and 49, respectively. The SiO₂ nanoparticles were incorporated and well distributed in the N6 nanofibers of the electrospun substrates (FIG. 49). The TEM images also show the size of the SiO₂ nanoparticles, which is about 30 nm, in the nanofibers of the electrospun substrates.

### Structural Study of the Electrospun N6/SiO₂ Composite by XRD and FTIR Analysis

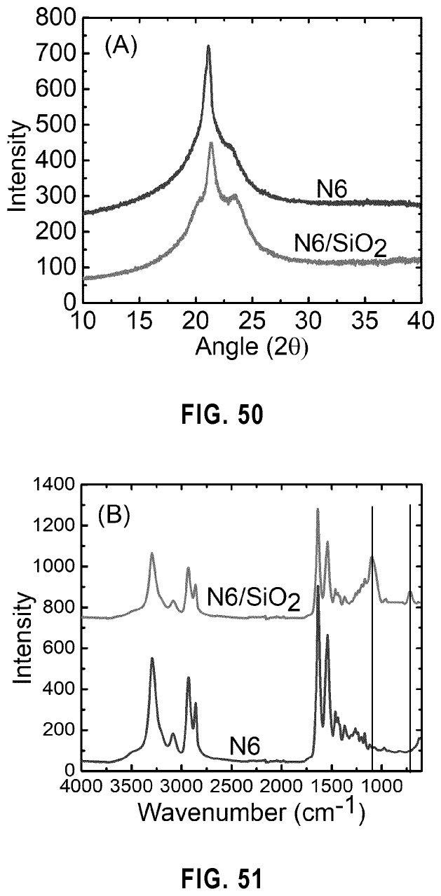

FIG. 50 shows the XRD data for the electrospun substrates of pristine N6 and the N6/SiO₂ composite with 20 wt. % SiO₂ content. The XRD data of the pristine N6 shows a peak at 2θ=21.2° indicating the morphology of a semi-crystalline polymer containing crystals of γ-form, which is consistent with the literature—see Reference 2.21.

The incorporation of SiO₂ into N6 caused a reduction in the peak intensity and a smaller peak appeared as a result of the crystal structure splitting from γ (2θ=21.2°) into the α-form at 2θ=23.5°—see Reference 2.21.

The FTIR spectra are shown in FIG. 51. The FTIR spectrum of electrospun N6 substrate shows typical peaks at 1545 cm⁻¹ (N—H deformation), 1637 cm⁻¹ (C═O stretching), and 3294 cm⁻¹ (N—H stretching)—see Reference 2.22. These peaks can also be seen in the spectrum for 20 wt. % SiO₂ content for the electrospun N6/SiO₂ composite substrate. Two additional peaks at 1100 cm⁻¹ and 800-700 cm⁻¹ were observed due to incorporation of SiO₂ nanoparticles into the N6 substrate. The peak at 1100 cm⁻¹ is characteristic of a Si—O—Si bond in the N6/SiO₂ composite—see Reference 2.22. The peak at 800-700 cm⁻¹ is due to v(Si—OH) in the N6/SiO₂ composite—see Reference 2.1. In fact, hydrogen bonds were formed between the O atom of the hydroxyl group of the SiO₂ nanoparticles and the H atom of the amide group of N6 as shown in the following schematic representation of the electrospun N6/SiO₂ composite.

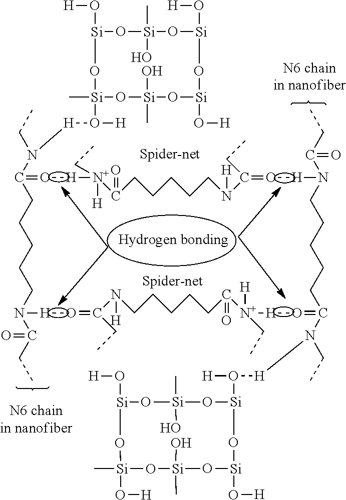

### Wettability of the Electrospun Substrates

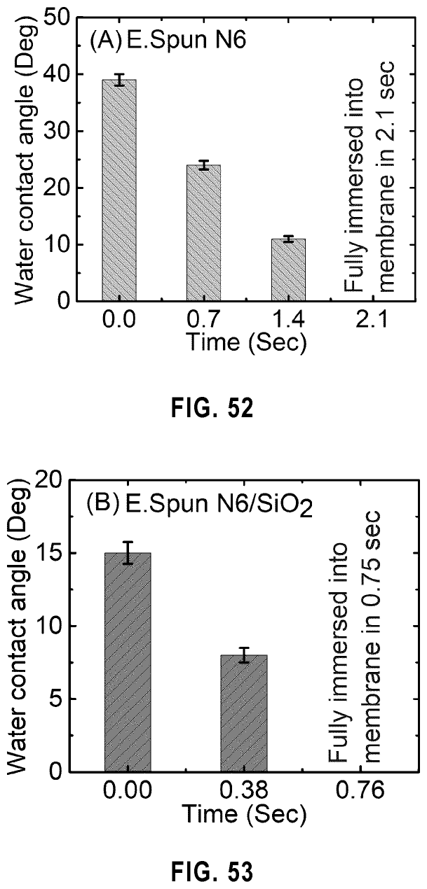

The wettability of the electrospun substrates of pristine N6 and N6 with 20 wt. % SiO₂content is shown in FIGS. 52 and 53. The water contact angles of the electrospun substrates of N6 and N6/SiO₂ composite were 39° and 15°, respectively, at the point where the substrate surface was touched by the water droplet (FIGS. 52 and 53). The water droplet was quickly absorbed through the electrospun substrates after touching its surface during the contact angle measurement, indicating highly hydrophilic properties of the substrates—see reference 2.23. The durations of 2.1 sec and 0.75 sec were required by the electrospun N6 and N6/SiO₂ composite substrates, respectively, to completely absorb the water droplet. Due to incorporation of superhydrophilic SiO₂ nanoparticles, the electrospun N6/SiO₂ composite showed greater hydrophilic properties as compared to those of the electrospun N6.

### Porosity, Pore Size and Tensile Strength of the Electrospun Substrates

The porosities of the electrospun substrates of pristine N6 and N6/SiO₂ (20 wt. %) composite are shown in Table 3. The electrospun N6 substrate with 21 wt % of N6 solution exhibited high porosity (86%) due to the high surface area to volume ratio of the nanofibers of the substrate. However, the incorporation of SiO₂ nanoparticles (20 wt %) increased the porosity of the electrospun N6 substrate by ˜10%. The average and maximum pore sizes of the electrospun N6 substrate were 406 and 575 nm, respectively, while those values were 478 nm (average) and 661 nm (maximum) for the electrospun N6/SiO₂ composite substrate (Table 3). It is assumed that the higher pore sizes are due to higher fiber diameters of the electrospun N6/SiO₂ composite substrate as compared to the electrospun N6 substrate.

TABLE 3
Porosity, pore size, and tensile strength
of the electrospun substrates.

| | Porosity | Pore size (nm) | | Tensile strength |
|---|---|---|---|---|
| Substrate | (%) | Average | Maximum | (MPa) |
| E. Spun N6 | 86 ± 1 | 406 ± 11 | 575 ± 14 | 19.0 ± 1 |
| E. Spun N6/SiO₂ | 95 ± 0.5 | 478 ± 13 | 661 ± 15 | 21.40 ± 0.85 |

The tensile strength of the fabricated electrospun substrates is also shown in Table 3. The electrospun N6 substrate showed a tensile strength of 19.0 MPa. The high tensile strength of the electrospun N6 substrate was due to the highly interconnected spider-web like structure in the substrate. The ionic species of the N6 solution form stronger hydrogen bonds because of the extra available charge on them in the presence of high applied voltage during the electrospinning process. The protonated amide group of ionic N6 can effectively form hydrogen bonds with oxygen atoms of a N6 molecule in the main fiber and form another hydrogen bond between an oxygen atom between the ionic molecule and a hydrogen atom from the amide group of another main fiber to form the interconnected spider-web like substrate. The incorporation of SiO₂ nanoparticles enhanced the tensile strength of the electrospun N6 substrate (21.40 MPa), likely due to the integrated network structure of SiO₂ (see the schematic representation of the electrospun N6/SiO₂ composite provided above).

### Characteristics of Casted N6 Substrate

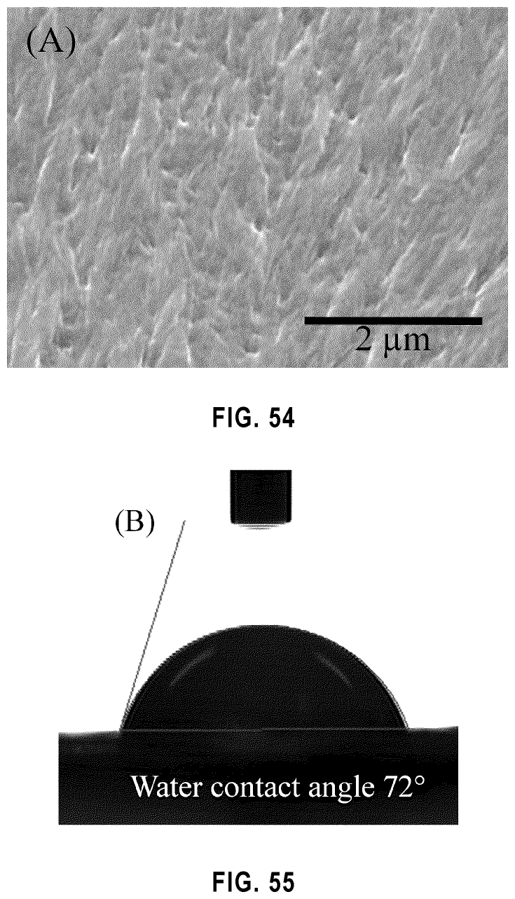

A N6 substrate was prepared by the phase inversion method. The casted N6 substrate was almost nonporous (see FIG. 54) with low wettability (water contact angle)72° as shown in FIG. 55. Therefore, the casted N6 cannot be used as an effective substrate for TFC membrane.

### Morphology of the TFC Membrane

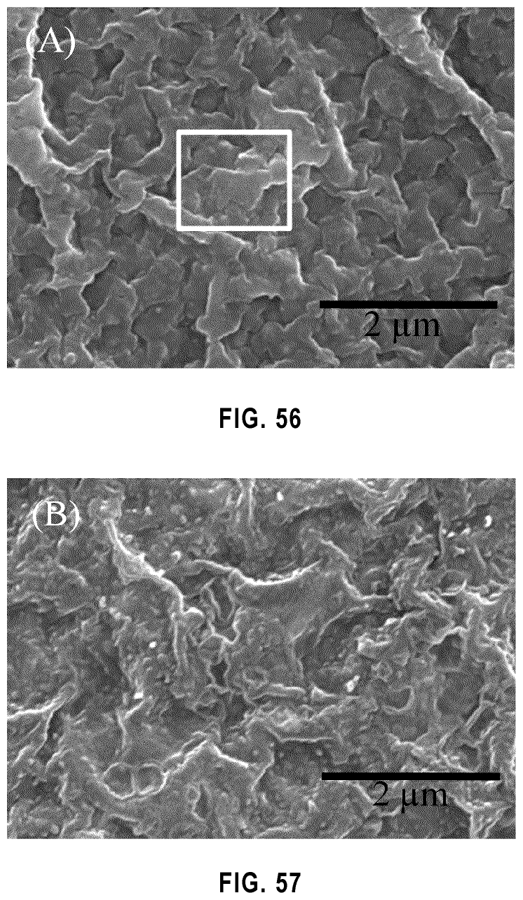

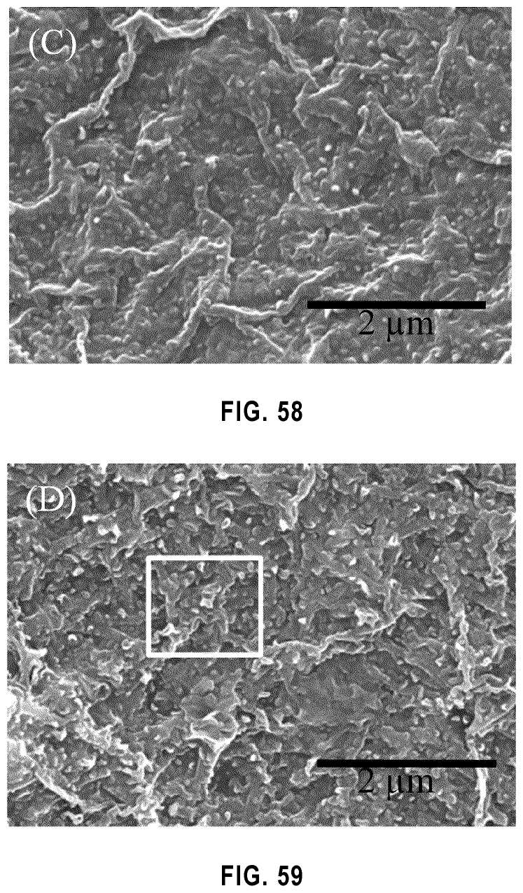

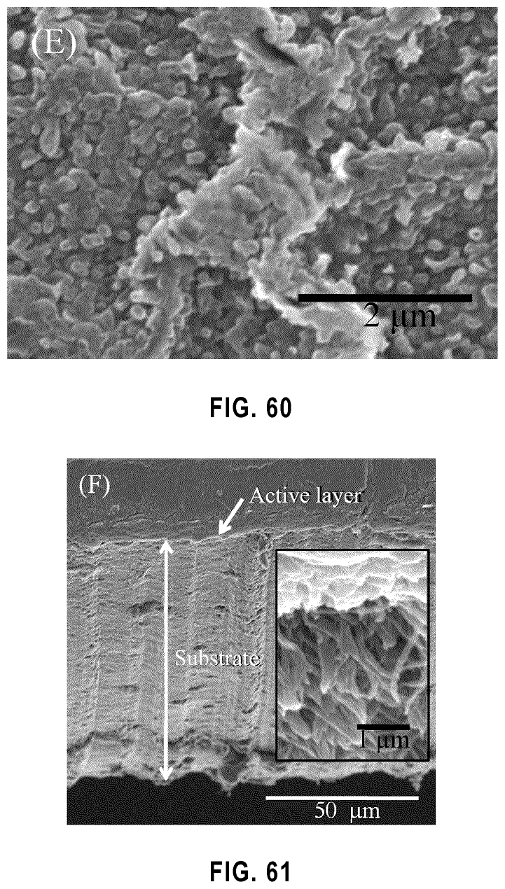

The top surface FE-SEM images of the electrospun N6/SiO₂ composite supported TFC membranes with pristine PA and PA/SiO₂ composite active layers are exhibited in FIGS. 56 to 60, in which the percentages of SiO₂ nanoparticles in the active layer were taken with respect to MPD during interfacial polymerization. The obtained “ridge and valley” structure indicated the successful formation of active layers of pristine PA (FIG. 56) and PA/SiO₂ composite (FIGS. 57 to 60) on the electrospun N6/SiO₂ composite substrate. Incorporated SiO₂ nanoparticles were clearly observed for the PA/SiO₂ composite active layers (FIGS. 57 to 60). Some nanoparticles were observed on the surface and some nanoparticles were embedded into the PA active layers. The concentration of the SiO₂ nanoparticles increased as a function of increased incorporated SiO₂ nanoparticles during interfacial polymerization. The sizes of the incorporated SiO2 nanoparticles were much higher for 6% SiO₂ content (FIG. 60) as compared to the other percentages of SiO₂ content (1, 2 and 4%) (FIGS. 57 to 59). The larger size of particles for 6% SiO₂ content indicated the aggregation of nanoparticles. The highest concentration, with still well dispersed SiO₂ nanoparticles, was observed with a 4% SiO₂ content (FIG. 59) in the active layer. The interaction between PA and SiO₂ nanoparticles in the active layer was obtained due to hydrogen bond formation between the O atom in the hydroxyl group of the SiO₂ nanoparticles and the H atom of the amide group of PA as shown in the following schematic representation of the interaction between PA and SiO₂ nanoparticles.

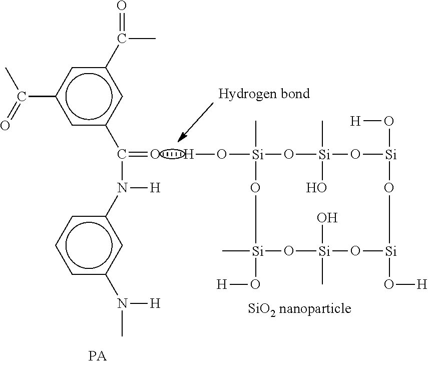

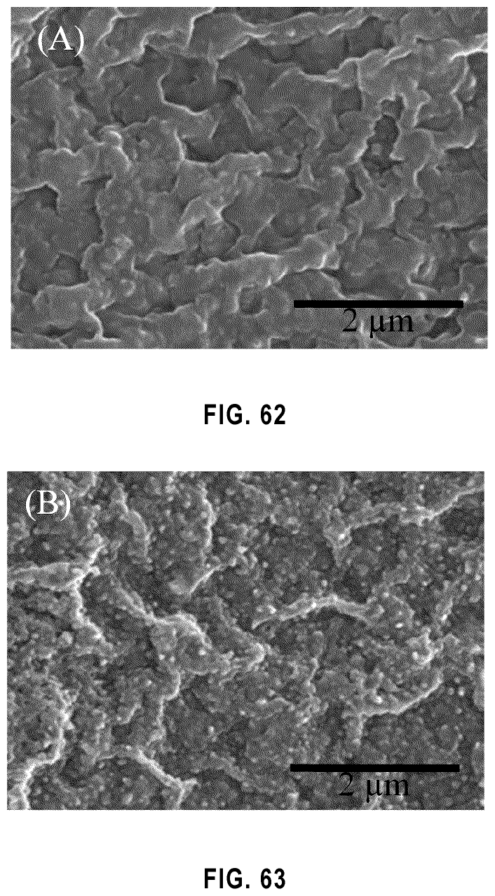

The cross-section of the fabricated electrospun N6/SiO₂ supported TFC membrane with 4% SiO₂ content in the PA active layer is shown in FIG. 61, in which the percentages of SiO₂ nanoparticles in the active layer were taken with respect to MPD during interfacial polymerization. The thickness of the electrospun substrate was ˜85 μm and a very thin PA active layer existed on the surface of the substrate (FIG. 61). The PA active layer was strongly attached to the surface of electrospun substrate due to the interaction between the polar amide groups of N6 and the polar amide groups of PA—see Reference 2.24. The top surface FE-SEM images of the electrospun N6 supported TFC membranes with pristine PA and PA/SiO₂ composite (4% SiO₂ content as regards MPD) active layers are shown in FIGS. 62 and 63, respectively.

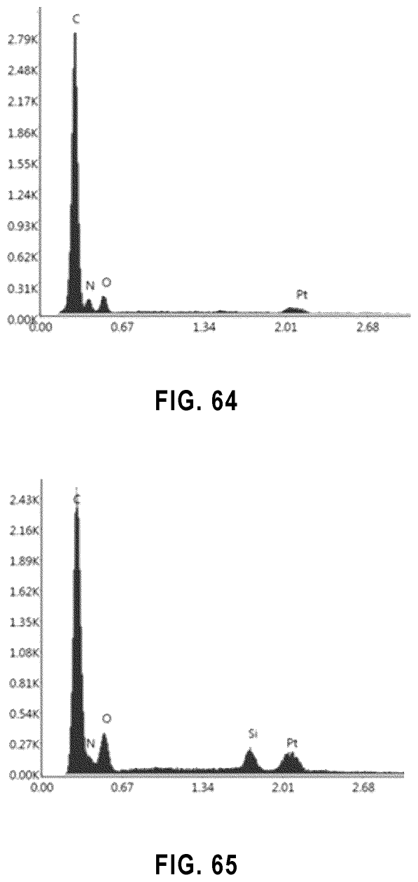

The SEM-EDX spectra of the surfaces of the electrospun N6/SiO₂ supported TFC membranes with the pristine PA and the PA/SiO₂ composite active layers are shown in FIGS. 64 and 65. The EDX analysis suggests the presence of C, N, and O atoms of PA (FIG. 64). Pt was also obtained in the EDX spectrum due to the Pt coating applied to conduct the SEM analysis for the TFC membranes. The PA/SiO₂ composite active layer showed a new peak for Si and an O peak with a higher intensity (FIG. 65) than previously observed for PA alone (FIG. 64). This result confirmed the successful incorporation of SiO₂ nanoparticles into the PA active layer during interfacial polymerization.

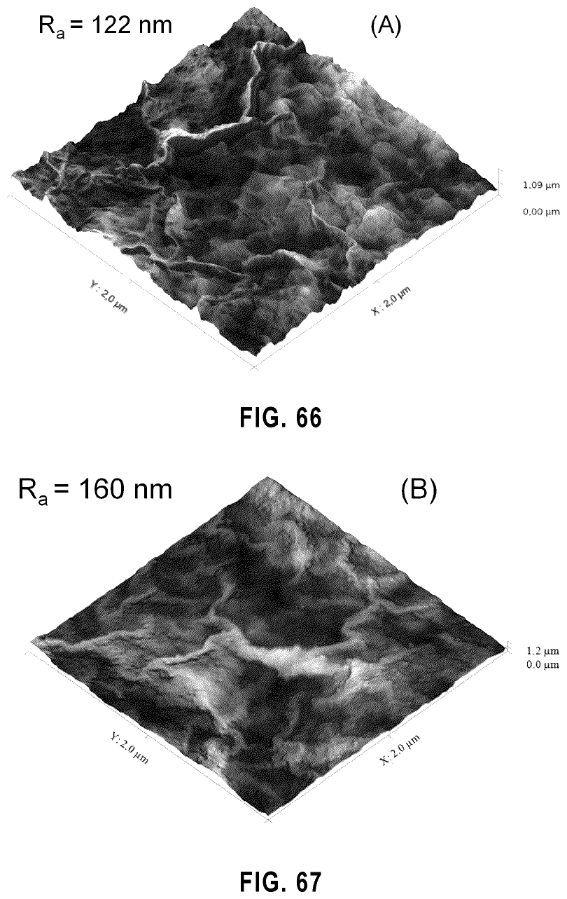

The surface roughness of the electrospun N6/SiO₂ supported TFC membranes with the pristine PA and the PA/SiO₂ composite active layers was also investigated through AFM and the result of this investigation is shown in FIGS. 66 and 67, in which the percentages of SiO₂ nanoparticles in the active layer were taken into account in regard to MPD during interfacial polymerization. The average surface roughness (Rₐ) of the electrospun N6/SiO₂ supported TFC membrane with the pristine PA was 122 nm (FIG. 66). However, the Rₐ of the TFC membrane with the active layer of PA/SiO₂ composite increased to 160 nm due to the addition of surface-active SiO₂ nanoparticles (FIG. 67).

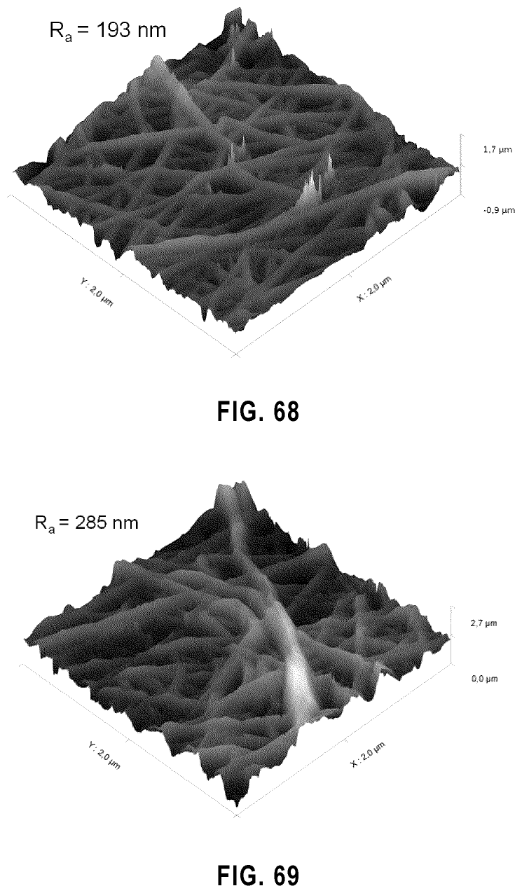

The surface roughness of the electrospun substrates was investigated through AFM and the result of this investigation is shown in FIGS. 68 and 69. The average surface roughness (Rₐ) of the electrospun N6 substrate was 193 nm (FIG. 68). However, the average surface roughness of the electrospun N6 substrate increased to 285 nm due to the addition of surface-active SiO₂ nanoparticles (FIG. 69). The top surface of the fabricated membrane became rough due to roughness of the electrospun N6 and N6/SiO₂ composite substrates, which is consistent with literature—see References 2.6 and 2.25.

### Wettability and Tensile Strength of the Membranes

The wettability of the fabricated and the commercial TFC membranes is reported in Table 4. The water contact angles of the fabricated E.Spun N6-PA and E.Spun N6-PA/SiO₂ TFC membranes were 63° and 47°, respectively. A lower water contact angle was obtained for the TFC membrane with PA/SiO₂ composite active layer. The water contact angle of the fabricated E.Spun N6/SiO₂-PA TFC membrane was 32°, however, the water contact angle was only 14° when incorporating 4% SiO₂ nanoparticles (as regards MPD during interfacial polymerization) into the PA active layer. The water contact angle decreased due to superhydrophilic properties of the incorporated SiO₂ nanoparticles into the PA active layer. In Table 4, it is also observed that the wettability of the fabricated TFC membranes increased with increasing wettability of the substrates, while the active layers remained the same. In fact, the highly wettable substrate induced the very thin active layer to be more wettable. The water contact angle of the fabricated E.Spun N6/SiO₂-PA/SiO₂ TFC membrane was 0.56 times lower as compared to that of the commercial TFC membrane (water contact angle 25°). The obtained water contact angle of the commercial TFC membrane was comparable to the literature value (water contact angle)24° for the same type of membrane—see Reference 2.26.

TABLE 4
Water contact angle and tensile strength of the TFC membranes.

| | Water contact angle | Tensile strength |
|---|---|---|
| Membrane | (°) | (MPa) |
| E. Spun N6-PA | 63 ± 0.9 | 19.4 ± 0.8 |
| E. Spun N6-PA/SiO₂ | 47 ± 1.0 | 19.5 ± 0.7 |
| E. Spun N6/SiO₂-PA | 32 ± 0.8 | 22 ± 0.4 |
| E. Spun N6/SiO₂-PA/SiO₂ | 14 ± 0.5 | 22.3 ± 0.2 |
| Commercial TFC | 25 ± 0.7 | 8.2 ± 0.3 |

The tensile strength of the fabricated membranes—as well as commercial TFC membranes—is also reported in Table 4. The tensile strength of E.Spun N6-PA and E.Spun N6-PA/SiO₂ TFC membranes were 19.4 and 19.5 MPa, respectively. The fabricated E.Spun N6/SiO₂-PA TFC membrane showed a tensile strength of 22 MPa. The tensile strength of the E.Spun N6/SiO₂-PA/SiO₂ TFC membrane was almost same as the fabricated E.Spun N6/SiO₂-PA TFC membrane. The very small quantity of incorporated SiO₂ nanoparticles into the PA active layer could not provide any contribution to enhance mechanical strength of the E.Spun N6/SiO₂-PA/SiO₂ TFC membrane. However, the tensile strength of the electrospun substrates slightly increased after fabricating active layers on it due to fiber binding effect of the active layer (Table 3 and Table 4). The obtained tensile strength of the commercial TFC membrane was much lower (8.2 MPa) as compared to the fabricated TFC membranes (Table 4).

### Performance of the Membranes

### FO Water Flux and Structural Parameter of the Membranes

A cross-flow RO cell was used to investigate pure water permeability of the fabricated as well as a commercial TFC membranes, and the obtained water permeability values were 20.1, 23.3, 28.2, 45, and 32.5 LMH/MPa for E.Spun N6-PA, E.Spun N6-PA/SiO₂, E.Spun N6/SiO₂-PA, E.Spun N6/SiO₂-PA/SiO₂, and commercial TFC membranes, respectively. The obtained water permeability value for the commercial TFC membrane is very near to the literature value (31.6 LMH/MPa) for the same type of membrane—see Reference 2.27. The fabricated E.Spun N6-PA and E.Spun N6-PA/SiO₂ TFC membranes were not considered for further FO performance investigations due to their lower water permeability compared to those of the other two fabricated membranes. The structural parameters of the fabricated and the commercial TFC membranes were determined through the investigation of salt rejection and salt permeability coefficient in a cross-flow RO cell (Table 5).

TABLE 5
FO water flux (at 1M NaCl draw solution against DI water
as feed) and structural parameters of the membranes.

| | NaCl solution | Osmotic pressure | | | FO | |
|---|---|---|---|---|---|---|
| | conc. (mM) | (MPa) of 20 mM | R | B | water flux | S |
| Membranes | in RO test | NaCl solution | (%) | (LMH) | (LMH) | (μm) |
| E. Spun N6/SiO₂-PA | | | 98.00 | 1.04 | 17.50 | 554 |
| E. Spun N6/SiO₂-PA/SiO₂ | 20 | 0.09 | 98.50 | 1.24 | 27.10 | 365 |
| Comm. TFC | | | 97.27 | 1.65 | 20.82 | 456 |

* Applied pressure for rejection test in RO experiment was 1.896 MPa. The pure water permeability of the fabricated E. Spun N6/SiO₂-PA and E. Spun N6/SiO₂-PA/SiO₂ membranes, and the commercial TFC membrane in RO experiments were 28.2, 45, and 32.5 LMH/MPa, respectively. Mutual diffusivity of the NaCl solution was 1.38 × 10⁻⁹ m²/s. Osmotic pressure of 1M NaCl solution was 4.6 MPa. Each set of FO experiment was conducted thrice and then the average values of obtained water flux from these three sets of experiments are presented in Table 5.

The salt rejections of the fabricated membranes were 98% for E.Spun N6/SiO₂-PA and 98.5% for E.Spun N6/SiO₂-PA/SiO₂, whereas it was 97.27% for the commercial TFC membrane. The salt permeability coefficient of the fabricated membranes were 1.04 LMH for E.Spun N6/SiO₂-PA, 1.24 LMH for E.Spun N6/SiO₂-PA/SiO₂, which were lower than that of the commercial membrane (1.65 LMH). FO water fluxes for the fabricated and the commercial TFC membranes are presented in Table 5. In order to obtain water flux, 1 M NaCl and DI water were used as draw solution and feed, respectively, in the FO process. The use of 1 M NaCl as draw solution and DI water as feed is a common practice in FO process. The obtained FO water fluxes for the fabricated E.Spun N6/SiO₂-PA/SiO₂TFC membrane was higher (27.10 LMH) than those of the other fabricated E.Spun N6/SiO₂-PA (17.50 LMH) and the commercial (20.82 LMH) TFC membranes at the same experimental conditions. Compared to the fabricated E.Spun N6/SiO₂-PA and the commercial TFC membranes, the higher FO water flux was obtained for the fabricated E.Spun N6/SiO₂-PA/SiO₂ TFC membrane due to its higher hydrophilicity with lower structural parameters as presented in Table 6 and Table 5.

Table 6 presents a comparison between the intrinsic permeation properties of lab-made TFC membranes and the literature TFC flat sheet membranes under both FO and RO conditions.

TABLE 2.6
Performance comparison of various FO TFC flat-sheet membranes in FO mode.

| | FO | | | | | |
|---|---|---|---|---|---|---|
| | performance* | | | | | |
| | Water | RO performance | | | | |
| | Flux | A | B | R | S | |
| Membrane | (LMH) | (LMH/MPa) | (LMH) | (%) | (μm) | Reference |
| E. Spun N6/SiO₂-PA | 17.50 | 28.2 | 1.04 | 98 | 554 | This work |
| E. Spun N6/SiO₂-PA/SiO₂ | 27.10 | 45 | 1.24 | 98.5 | 365 | |
| Commercial TFC | 20.82 | 32.5 | 1.65 | 97.27 | 456 | |
| TFC1, PA/PES | 11.0 | 6.6 | 0.35 | 97.8 | 460 | Reference 2.26 |
| TFC2, PA/PES | 17.0 | 18 | 1.00 | 97.5 | 458 | |
| TFC3, PA/PES | 26.5 | 57.8 | 4.96 | 93.4 | 436 | |
| PA/PSf | 15.8 | 11.6 | 0.47 | 97.4 | 492 | Reference 2.28 |
| PA/PSf | 25.0 | 19.0 | 0.33 | 98.6 | 312 | Reference 2.29 |
| PA/PES-co-sPPSU | 20.0 | 7.3 | 0.25 | 91.0 | 324 | Reference 2.30 |
| PA/PES | 47.0 | 17.0 | — | 97.0 | 80 | Reference 2.31 |
| PA/PES-SPSF | 32.0 | 7.7 | 0.11 | 93.5 | 238 | Reference 2.32 |
| PA/CAP | 10.0 | 18.2 | 0.19 | 89.2 | 789 | Reference 2.33 |
| PA/PSf-SPEK | 23.0 | 7.5 | 0.07 | 89.5 | 107 | Reference 2.34 |
| PA/PVDF | 28.0 | 31.5 | 2.33 | 84.4 | 325 | Reference 2.25 |
| PA/PK | 27.0 | 25.0 | 0.18 | — | 280 | Reference 2.35 |
| Zeolite NaY-PA/PSf | 11.0 | 25.7 | 1.57 | 77.6 | 782 | Reference 2.36 |
| PA/PVDF | 22.0 | 12.8 | 0.28 | — | 193 | Reference 2.37 |
| PA/PSf-LDHs | 18.1 | 6.1 | 0.27 | — | 148 | Reference 2.38 |

*Feed solution: DI water, Draw solution: 1M NaCl

### Reverse Salt Flux and Specific Reverse Salt Flux of the Membranes in FO Process

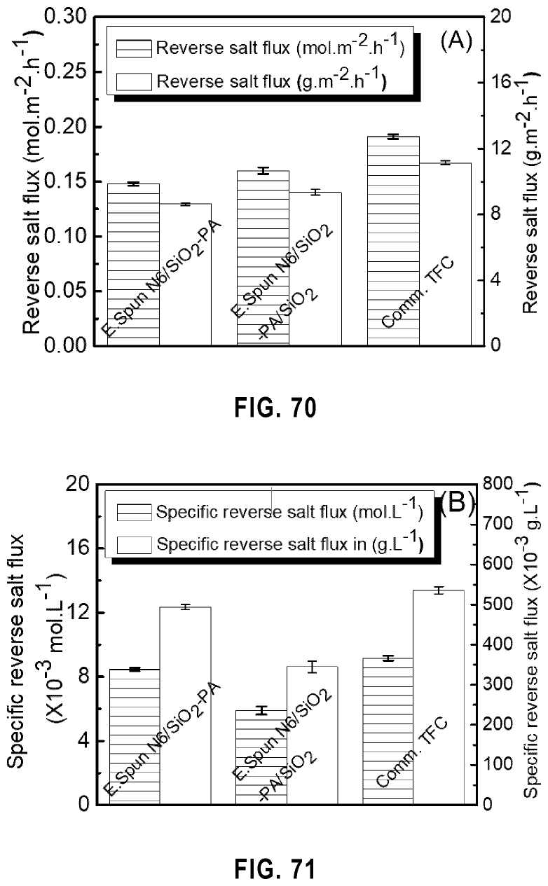

The reverse salt flux and specific reverse salt flux of the TFC membranes used in FO processes are shown in FIGS. 70 and 71. The reverse salt fluxes of the fabricated TFC membranes (0.148 mol·m⁻²·h⁻¹ or 8.64 g·m⁻²·h⁻¹ for E.Spun N6/SiO₂-PA and 0.16 mol·m⁻²·h⁻¹ or 9.34 g·m⁻²·h⁻¹ for E.Spun N6/SiO₂-PA/SiO₂) were lower than that of the commercial TFC membrane (0.191 mol·m⁻²·h⁻¹ or 11.15 g·m⁻²·h⁻¹) (FIG. 70). Due to incorporation of SiO₂ nanoparticles into the active layer, a little higher reverse salt flux was obtained for the fabricated E.Spun N6/SiO₂-PA/SiO2TFC membrane as compared to the other fabricated membrane (E.Spun N6/SiO₂-PA). Higher salt permeability in RO test (Table 6) also supports the higher reverse salt flux for the fabricated E.Spun N6/SiO₂-PA/SiO₂TFC membrane as compared to that of the fabricated E.Spun N6/SiO₂-PA TFC membrane. However, the specific reverse salt flux of the fabricated E.Spun N6/SiO₂-PA/SiO₂TFC membrane (specific reverse salt flux 5.9×10⁻³ mol·L⁻¹ or 344.6×10⁻³ g·L⁻¹) was much lower, as compared to those of the fabricated E.Spun N6/SiO₂-PA (specific reverse salt flux 8.46×10⁻³ mol·L⁻¹ or 494×10⁻³ g·L⁻¹) and the commercial (specific reverse salt flux 9.17×10⁻³ mol·L⁻¹ or 535.5×10⁻³ g·L⁻¹) TFC membranes (FIG. 71). Higher water flux was responsible for obtaining lower specific reverse salt flux for the fabricated E.Spun N6/SiO₂-PA/SiO₂membrane as compared to the other two membranes.

### Antifouling Propensity of Membrane in the FO Process

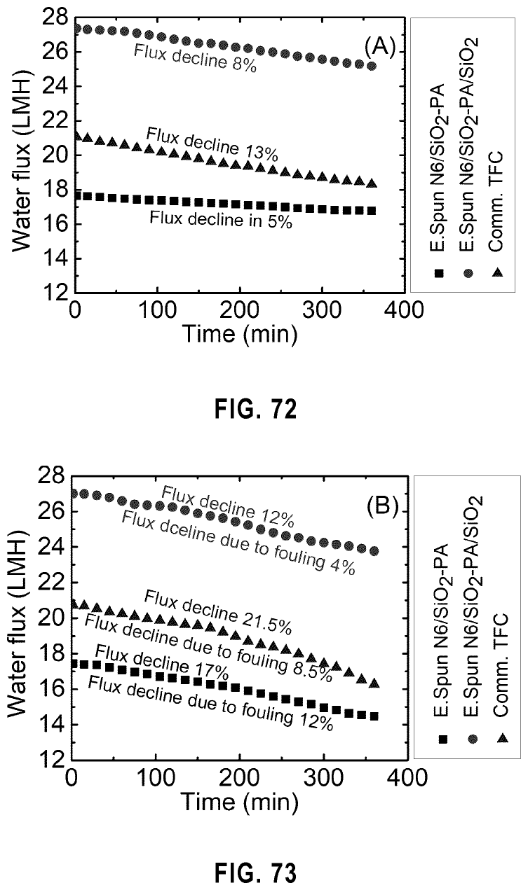

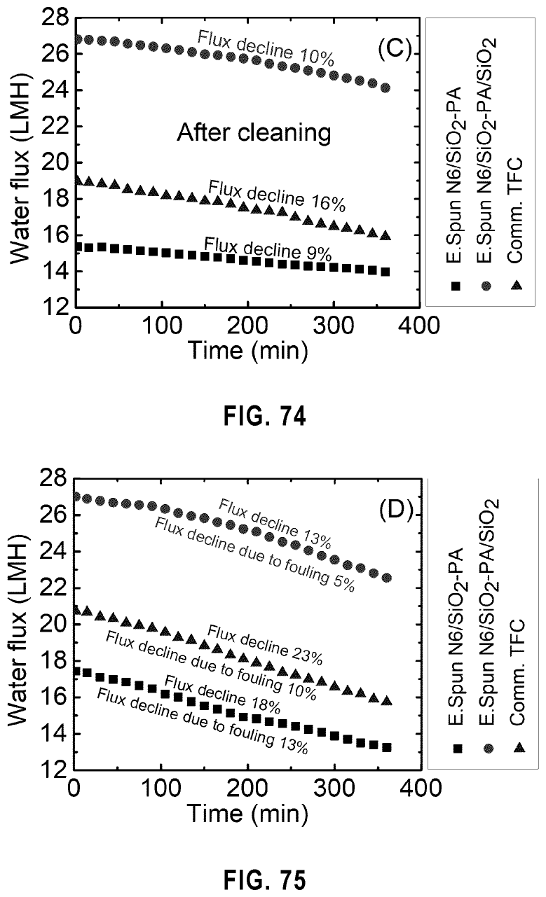

The antifouling propensity of the fabricated membrane, as well as commercial TFC membrane, was studied in the presence of two separate foulants, namely SA (model organic foulant) with calcium ions (as bridging agent) and CaSO₄ (model inorganic foulant). The fouling behavior of the TFC membranes with these two foulants is illustrated in FIGS. 72 to 77. The decline in water flux due to reverse salt flux in 6 h were 5, 8, and 13% for the fabricated E.Spun N6/SiO₂-PA, E.Spun N6/SiO₂-PA/SiO₂, and the commercial TFC membranes, respectively, when using 1 M NaCl as draw solution and DI water as feed solution (FIG. 72). However, 17, 12, and 21.5% declines of water flux were obtained for the fabricated E.Spun N6/SiO₂-PA, E.Spun N6/SiO₂-PA/SiO₂, and the commercial TFC membranes, respectively, when SA with calcium ions was used as the foulant (FIG. 73). In FIG. 73, 12, 4 and 8.5% declines of water flux were observed for the fabricated E.Spun N6/SiO₂-PA, E.Spun N6/SiO₂-PA/SiO₂, and the commercial TFC membranes, respectively, due to fouling caused by SA. A higher antifouling propensity was obtained due to higher hydrophilicity of the fabricated E.Spun N6/SiO₂-PA/SiO₂ membrane as compared to the two other types of membranes. The membranes were physically cleaned after conducting the fouling experiments with SA. The water flux of the cleaned membranes was determined in the use of 1 M NaCl as a draw solution and DI water as feed in order to investigate water flux recovery of the membranes. The initial water flux recovery of 87, 98, and 90% (FIG. 77) with water flux decline of 9, 10, and 16% (FIG. 74) after 6 h was obtained for the fabricated E.Spun N6/SiO₂-PA, E.Spun N6/SiO₂-PA/SiO₂, and the commercial TFC membranes, respectively.

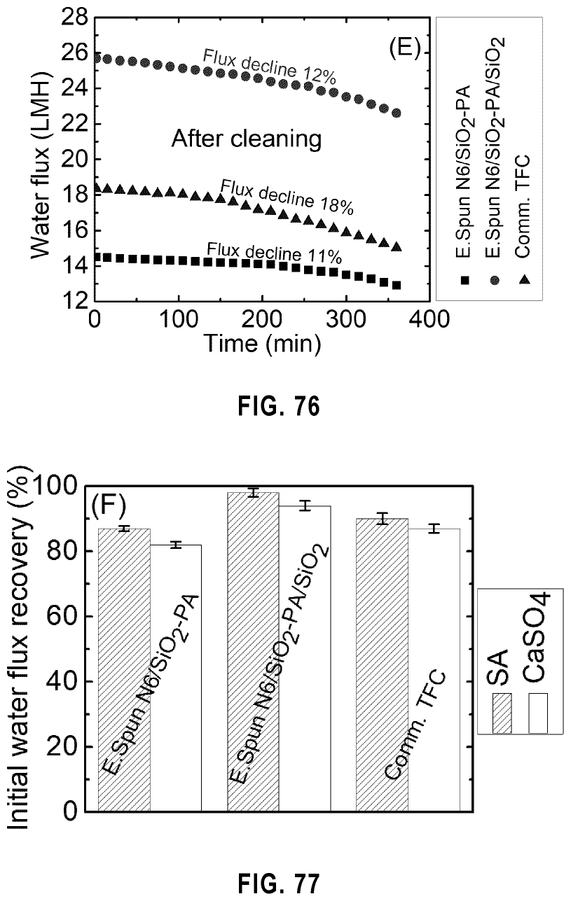

The decline in water flux for the E.Spun N6/SiO₂-PA, E.Spun N6/SiO₂-PA/SiO₂, and the commercial TFC membranes were 18%, 13%, and 23%, respectively, when CaSO₄ was used as the foulant (FIG. 75). Water flux declines of 13, 5 and 10% were observed for the fabricated E.Spun N6/SiO₂-PA, E.Spun N6/SiO₂-PA/SiO₂, and the commercial TFC membranes, respectively, due to fouling caused by CaSO₄ (FIG. 75). The membranes were also cleaned physically after conducting the fouling experiments with CaSO₄ and the water flux of the cleaned membranes was determined in order to investigate water flux recovery of the membranes. An initial water flux recovery of 82, 94, and 87% (FIG. 77) with water flux decline of 11, 12, and 18% (FIG. 76) after 6 h was obtained for E.Spun N6/SiO₂-PA, E.Spun 6/SiO₂-PA/SiO₂, and the commercial TFC membranes, respectively. The fabricated E.Spun N6/SiO₂-PA/SiO₂ TFC membrane exhibited the best antifouling performance for both foulants (SA and CaSO₄) due to incorporation of superhydrophilic SiO₂ nanoparticles into the PA active layer.

### EXAMPLE 3

### Combined MF-FO-MD Processes for Fracking Wastewater Treatment

A combined process, comprised of microfiltration, forward osmosis and membrane distillation was successfully applied to the treatment of fracking wastewater. In fact, both insoluble and soluble contaminants were removed by microfiltration and forward osmosis, respectively. After applying this combined process, fresh water was obtained from the fracking wastewater.

Microfiltration as a pre-treatment process followed the emerging forward osmosis coupled with membrane distillation—used as a downstream separator to recycle FO draw solutions as well as to produce pure water—as post-treatment processes were successfully applied for the first time to the treatment of fracking wastewater. Microfiltration as a pre-treatment removed ˜52% of TOC and ˜98.5% of turbidity. High average water fluxes (19.98 LMH for NaCl and 30.97 LMH for NaP draw solutions) with high solute rejection were obtained via the FO process using a nanocomposite membrane, while these water fluxes were 14.39 LMH for NaCl and 23.79 LMH for NaP draw solutions when using a PA membrane. High solute rejection was obtained by both membranes (nanocomposite and PA) in the FO treatment of pre-treated fracking wastewater. This research also demonstrated that 98.5% and 97% of initial water flux can be recovered by the nanocomposite and PA membranes, respectively, after desalination of fracking wastewater. In membrane distillation, permeate fluxes were about 10.40 LMH for NaCl and about 13.82 LMH for NaP with approximately 99.99% solute rejection, producing “pure” water. This result indicates a successful implementation of membrane distillation as a downstream separator in the FO process.

### REFERENCES FOR THIS EXAMPLE

The present Example refers to the following documents, all of which are incorporated herein by reference.
3.1. M. S. Islam et al., J. Membr. Sci. 537 (2017) 297-309.
3.2. D. Emadzadeh et al., Chem. Eng. J. 237 (2014) 70-80.
3.3. J.-F. Li et al., Appl. Surf. Sci. 255 (2009) 4725-4732.
3.4. C. Liao et al., Desalination 285 (2012) 117-122.
3.5. H. Li et al., Appl. Surf. Sci. 346 (2015) 134-146.
3.6. J. Yin et al., Desalination 365 (2015) 46-56.
3.7. J. Ju et al., J. Colloid lnterf. Sci. 434 (2014) 175-180.
3.8. G. Han et al., Appl. Energy 132 (2014) 383-393.
3.9. L. Shen et al., Chem. Eng. Sci. 143 (2016) 194-205.
3.10. X. Li et al., Appl. Energy 114 (2014) 600-610.
3.11. M. Hamdan et al., J. Food Eng. 155 (2015) 10-15.
3.12. V. T. Granik et al., Biomed. Microdevices 4 (2002) 309-321.
3.13. K. S. Pitzer et al., Chem. Soc. Rev. 34 (2005) 440-458.
3.14. S. Kumar et al., Process Safety Environ. Protection 102 (2016) 214-228.
3.15. T. Rajasekhar et al., J. Membr. Sci. 481 (2015) 82-93.
3.16. B. Deng et al., J. Membr. Sci. 350 (2010) 252-258.
3.17. M. Qasim et al., Desalination 423 (2017) 12-20.
3.18. Y. Yang et al., Chinese J. Chem. Eng. 25 (2017) 1395-1401.
3.19. W. Cao et al., Ind. Eng. Chem. Res. 54 (2) (2015) 672-680.
3.20. Le Han et al., J. Membr. Sci. 541 (2017) 291-299.
3.21. C. Zhao et al., Desalination 334 (2014) 17-22.
3.22. W. Guo et al., Bioresour. Technol. 122 (2012) 27-34.

### Experimental

### Materials

Sodium chloride (NaCl) and sodium propionate (NaP) were purchased from Sigma-Aldrich, USA.

Nanocomposite microfiltration membranes were produced by our laboratory (see details below) and polysulfone (PSf) microfiltration membranes were purchased from Pall Corporation, USA (Part number: S80065, Description: HT 200 membrane, 8 inch-10 inch sheet; Base material: Unsupported polysulfone (HT), pore size: 0.2 micrometer, thickness: 114.3-190.5 micrometer).

The flat-sheet thin-film composite (TFC) FO membranes were as described in Example 2 above [nanocomposite membrane] and #40161507 Filter membranes, Basic TFC Forward Osmosis Membranes by Hydration Technology Innovations (HTI, Albany, Oreg., USA) [polyamide (PA) membrane].

Millipore, USA, provided poly(vinylidene fluoride) (PVDF) membrane (Durapore®) (mean pore size 0.22 μm, porosity 75%) for membrane distillation.

Sample fracking wastewater was obtained from Canbriam Energy Inc., Calgary, Alberta, Canada. The composition of dissolved inorganic solids in this wastewater is provided in the Table 7. De-ionized (DI) water was supplied from a Millipore Integral 10 water system (Millipore, Billerica, Mass.).

### Production of the Nanocomposite Microfiltration Membranes

Nylon 6 (N6), tetraethyl orthosilicate (TEOS), ethyl alcohol (C₂H₅OH), polyvinyl acetate (M_{w} 140,000), ammonium hydroxide (NH₄OH), acetone and sodium dodecyl sulfate (SDS) were obtained from Sigma-Aldrich, USA. Both formic acid and acetic acid were received from Fisher Scientific, USA. Machine oil (90% base oil with 10% additives, density of 881.4 kg/m³ at 20° C., kinematic viscosity of 271.62 mm²/s at 20° C., and surface tension of 29.8 mN/m at 20° C.) was received from Canadian Tire (Canada). De-ionized (DI) water was obtained from a Millipore Integral 10 water system (Millipore, Billerica, Mass.).

### Preparation of Solutions for Electrospinning

N6 (21% by weight) was dissolved in a mixture of formic and acetic acids (80% formic acid and 20% acetic acid by volume) using magnetic stirring (rpm 350) for 5 h at room temperature. Separately, a SiO₂ solution was prepared by mixing TEOS, ethanol and water at a molar ratio of 1:2:2, respectively, in the presence of an NH₄OH catalyst and stirred at 25° C. for 4 h. The SiO₂ nanoparticles were then separated from the mixture through centrifugation. Subsequently, the SiO₂ nanoparticles were dispersed in a formic acid (80% by volume) and acetic acid (20% by volume) mixture under sonication for 20 min. An appropriate ratio of SiO₂ dispersion was then added into the N6 solution and sonicated for 5 min and then stirred for 5 h at ambient condition.

### Fabrication of MF Membrane

Electrospinning. High-voltage electricity (Nanospinner NE300, Inovenso, Turkey) was applied to the prepared solutions in a syringe (volume 20 mL, inside diameter 19.05 mm) via an alligator clip attached to the syringe nozzle. The applied voltage was adjusted to 30 kV. The solution was delivered to the nozzle tip via a syringe pump to control the solution flow rate (0.18 mL/h). Fiber mats were collected on an electrically grounded metallic drum placed 8.8 cm above the nozzle tip [12, 30]. Temperature (25° C.) and relative humidity (40%) were controlled throughout the fabrication process.

Coating, drying and washing. A PVAc coating layer was applied onto the electrospun nanofiber mat through casting and then phase inversion techniques. PVAc was dissolved in acetone under magnetic stirring for 3 h to make a 10% casting solution. The N6 nanofiber mat was first soaked in DI water before coating in order to minimize the penetration of the PVAc solution into the nanofiber mat. After making the coating, the resulting two-tier composite membrane was dried for 4 h at ambient conditions and then immersed in de-ionized water for 24 h in order to remove the excess solvent from the membrane.

### Fabrication of N6 and PVAc Films

Films of pristine N6 and PVAc were also prepared to investigate water contact angles. A 21% nylon 6 solution (by weight) in 80% formic acid and 20% acetic acid mixture (by volume) was used to fabricate nylon 6 film. The nylon 6 solution was casted manually on a clean glass plate using a casting knife with the thickness of 60 μm at ambient condition. After casting, the film was dried for 24 h at ambient condition and then it was removed from the glass plate. A 10% PVAc solution (by weight) in acetone was used to make PVAc film. The PVAc solution was casted manually on an aluminium foil putting on glass plate using a casting knife with the thickness of 60 μm at ambient condition. The PVAc film was dried for 24 h at ambient condition after casting and then it was removed from the aluminium foil.

TABLE 7
Composition of inorganic dissolved solids
found in the real fracking wastewater.

| Component | Conc. (mg/L) |
|---|---|
| Sodium (Na⁺) | 54400 |
| Potassium (K⁺) | 1950 |
| Calcium (Ca²⁺) | 8010 |
| Magnesium (Mg²⁺) | 909 |
| Barium (Ba²⁺) | 501 |
| Strontium (Sr²⁺) | 1490 |
| Iron (Fe²⁺) | 29.5 |
| Chloride (Cl⁻) | 109186 |
| Bromide (Br⁻) | 1850 |
| Iodide (I⁻) | 29.6 |
| Bicarbonate (HCO₃⁻) | 174.5 |
| Sulfate (SO₄²⁻) | 50.3 |

*Data obtained from Canbriam Energy Inc., Calgary, Alberta, Canada.

### Methods

### Physicochemical Characterization of Membranes

The thicknesses of all membranes were measured using a TMI instrument (Testing Machines, Inc.)—see Reference 3.1. The wettability and tensile strength of the membranes were investigated using a VCA optima instrument (AST Products, Inc.) and Instron (Mini 44), USA, respectively. Field emission-scanning electron microscopy (FE-SEM) (QUANTA FEG 450) with a platinum coating on the sample surface was performed to examine the morphology of the FO membranes.

### Porosity and Pore Sizes of MF Membranes

The gravimetric method was used to investigate porosity (ε) of the MF membranes using the following equation:

$$ɛ ( \% ) = \frac{{W}_{w} - {W}_{d}}{{ρ}_{w} {A}_{m 1} {L}_{1}} \times 100 \qquad ( 3.1 )$$

where W_{w} and W_{d} are the weight of the wet and dry membranes, respectively; ρ_{w} is the water density (0.998 g cm⁻³); Aₘ₁ is the effective area of the membrane and L₁ is the membrane thickness—see References 3.2 to 3.6.

The mean pore size of the MF membranes was determined via the filtration velocity method. The volume of permeate water was obtained using a dead-end stirred cell filtration device (Millipore stirred ultra-filtration cells, 8010, USA, effective area of 0.0003 m²) connected to a nitrogen gas cylinder. The mean pore size (rₘ) was calculated using the Guerout-Elford-Ferry equation:

$${r}_{m} = √ [ \frac{( 2.9 - 1.75 ɛ ) \times 8 η {L}_{1} {Q}_{T}}{ɛ {A}_{m 1} Δ P} ] \qquad ( 3.2 )$$

where [symbol] is the water viscosity (8.9×10⁻⁴Pa s); L₁ is the membrane thickness; Q_{T} is the permeate volume per unit time; ΔP is the applied pressure (1 bar) and A is the effective area of the membrane—see References 3.3 to 3.6.

### Pure Water Permeability of the Membranes

Pure water flux for the MF membranes was measured using a dead-end stirred cell filtration device (Millipore stirred ultra-filtration cells, 8010, USA, effective area of 0.0003 m²) connected to a nitrogen gas cylinder. The membrane was pre-compacted at an applied pressure of 0.28 bar until a constant water flux was achieved. Pure water flux at a temperature of 25° C. was measured at applied pressures of 0.28, 0.55, 0.83, 1.1 and 1.38 bar. The equations below were used to calculate pure water permeability for the MF membranes:

$$\begin{matrix}{J}_{0} = \frac{V}{{A}_{m 1} Δ {t}_{1}} & ( 3.3 ) \\ {A}_{1} = \frac{{J}_{0}}{Δ {P}_{1}} & ( 3.4 )\end{matrix}$$

where J₀, V, Aₘ₁, A₁, Δt₁ and ΔP₁ are the pure water flux/permeate flux, permeated water volume, membrane effective area, water permeability, measurement time, and applied pressure across the membrane, respectively—see References 3.2 and 3.7.

The water permeability (A) for the FO membranes was investigated using a flat-sheet bench-scale cross-flow RO test system. A piece of the membrane with an effective surface area of 19.94 cm² was placed in a stainless-steel test cell with the active surface of the membrane facing the feed stream. Using a high-pressure positive displacement pump (Hydra-cell pump), the feed solution was re-circulated at 1.0 L/min. DI water was used as the feed stream to investigate water permeability for the FO membranes. Water permeability values for the membrane were calculated using the following equations:

$$\begin{matrix}J = \frac{Δ V}{{A}_{m} Δ t} & ( 3.5 ) \\ A = \frac{J}{Δ P} & ( 3.6 )\end{matrix}$$

where J is the pure water flux, Aₘ is the effective membrane area, ΔV is the permeate volume, Δt is time, and ΔP is the hydraulic pressure difference across the membrane—References 3.2 and 3.8 to 3.10. The pressure was increased in 3.45 bar increments from 3.45 to 10.34 bar in order to investigate A of the FO membranes. Constant pressure was applied at each increment for 8 h. The water flux through the membrane was obtained from a liquid flow sensor (Sensirion, The Sensor Company) that was directly connected to a computer.

### Treatment of Fracking Wastewater

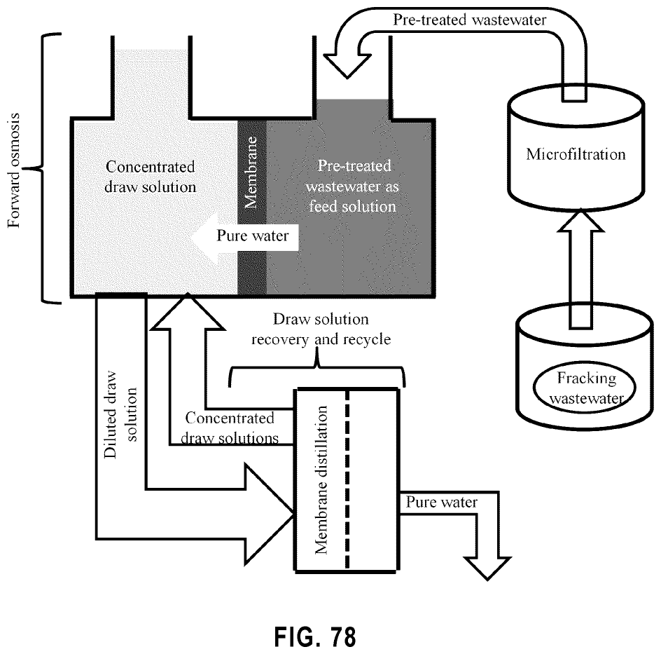

The treatment of fracking wastewater involved three steps: microfiltration, then forward osmosis and finally recovery of draw solution and pure water production by membrane distillation. The fracking wastewater treatment process is shown schematically in FIG. 78.

### Pre-Treatment of the Fracking Wastewater

Microfiltration for fracking wastewater water was conducted using both nanocomposite and PSf membranes in a dead-end stirred cell filtration device (Millipore stirred ultra-filtration cells, 8010, USA, effective area of 0.0003 m²) connected to a nitrogen gas cylinder. The membranes were pre-compacted using DI water at an applied pressure of 0.28 bar until a constant water flux was achieved. Then, microfiltration using the fracking wastewater as a feed was conducted for 12 h at a stirring rate of 500 rpm and an applied pressure of 0.28 bar. Turbidity, total organic carbon (TOC), conductivity and pH of the fracking wastewater after sample collection and after microfiltration were investigated using a MicroTPW Turbidimeter (HF, Scientific, Inc., USA), a TOC analyzer (TOC V_{CPH/CPN}, Shimadzu Corp., Japan), a calibrated conductivity meter (Oakton, Eutech Instruments) and a calibrated pH meter (Oakton, Eutech Instruments), respectively.

The osmotic pressure of the fracking wastewaters after microfiltration was also investigated in the following way. The van Laar equation was used to calculate the osmotic pressure of the fracking wastewater:

$${π}_{o . p . f} = - ( \frac{{R}_{i} T}{{V}_{0}} ) ln {a}_{1} \qquad ( 3.7 )$$

where π_{o.p.f} is the osmotic pressure, Rᵢ is the ideal gas constant, T is the absolute temperature, V₀ is the molar volume of solvent and a₁ is the water activity—see References 3.11 and 3.12.

The water activity was calculated using the following equation:

$${a}_{1} = \frac{P}{{P}_{0}} \qquad ( 3.8 )$$

where P and P₀ are the vapor pressures of the fracking wastewater and DI water, respectively, at 24° C. The vapor pressures of the fracking wastewater and DI water were investigated using a U-Tube Manometer (Tenaquip, Canada)—see References 3.11 and 3.13.

Water flux recovery for the MF membranes after pre-treatment of fracking wastewater was also investigated. After filtering the fracking wastewater, the membranes were cleaned by rinsing with DI water for 30 min, and the pure water flux was then measured again using the equation (3.3) at the same applied pressure (0.28 bar). Water flux recovery (FR) was calculated according to the following equation:

$$FR = \frac{{J}_{x}}{{J}_{y}} \times 100 ( \% ) \qquad ( 3.9 )$$

where J_{y} and Jₓ are the pure water flux of membrane before and after filtration of fracking wastewater, respectively—see References 3.3, 3.5, and 3.14 to 3.16.

### Treatment of the Pre-Treated Fracking Wastewater by FO

A bench-scale FO experimental setup (FIG. 43) was used to desalinate fracking wastewater using the nanocomposite as well as the PA membranes. A piece of the membrane with an effective surface area of 19.94 cm² was placed in an acrylic cross-flow cell with the active layer of the membrane facing the feed solution. The fracking wastewater was used as feed, and NaCl (4.0 M) and NaP (4.6 M) were used as draw solutions to investigate desalination of the fracking wastewater via FO. The osmotic pressures of these two draw solutions (NaCl 4.0 M and NaP 4.6 M) were determined using the OLI Stream Analyzer™ (OLI Systems, Inc.). On both sides of the membrane, the cross-flow cell had symmetric channels, which allowed for both the feed solution and the draw solution to flow tangentially to the membrane. Re-circulation of the feed solution and the draw solution on the opposite sides of the membrane was executed using two variable-speed gear pumps (Gear Pump Drive, Cole-Parmer Instrument Company). The flow rate of each solution was maintained at a constant 0.5 L/min. The feed solution temperature and the draw solution temperature were held constant at 24° C. and monitored with a thermometer. The feed solution and the draw solution were placed in two separate 4.0 L reservoirs to conduct the experiment. The feed solution container was placed on a digital analytical balance. Each experiment was conducted for six hours and the concentration of the draw solution was adjusted by adding concentrated draw solution in every 15 min. The water flux for the FO membranes was obtained from the digital analytical balance by using equation (3.5). Samples of the feed and draw solutions before and after the FO experiment were collected in order to investigate TDS and TOC. The gravimetric method was used to determine TDS while a TOC analyzer (TOC V_{CPH/CPN}, Shimadzu Corp., Japan) was used to examine TOC of the feed and draw solutions—see Reference 3.17.

### Water Flux Recovery for the FO Membranes Fouled by Fracking Wastewater

To investigate water flux recovery for the FO membranes fouled by pre-treated fracking wastewater, the weight changes of feed solution throughout the FO experiments was monitored closely (30 minute interval) using a digital weight balance. After FO, DI water (in the both feed and draw side) was applied for 2 h with a flow rate of 1 L/min to physically clean the active surface of the fouled membranes. The water flux through the cleaned membranes was finally measured using 4.6 M NaP and pre-treated fracking wastewater as draw and feed solutions, respectively, in the same FO experiment set-up in order to investigate water flux recovery for these membranes. These experiments were conducted for 6 h at the flow rate of 0.5 L/min in which the weight changes of feed solution were monitored using a digital weight balance at thirty minute intervals. The same experiment was also conducted for NaCl draw solution (4.0 M).

### Recycling of Draw Solutions in FO

Membrane distillation was used as a downstream separator to recycle the FO draw solutions. A Sterlitech membrane test cell system with a membrane active area of 34 cm² was used to conduct the membrane distillation experiment. In this experiment, the draw solutions NaCl (4.0 M) and NaP (4.6 M) (used for pre-treated fracking wastewater using nanocomposite FO membrane) were used as feed solutions and DI water (conductivity <15 μS) was used as the coolant in the permeate side. To conduct the experiment, the feed solution and the permeate were placed in two separate 2.0 L reservoirs. The permeate container was placed on a digital analytical balance. Each experiment was conducted for 3 h, maintaining the feed and permeate temperatures of 50° C. and 20° C., respectively. Weight changes and conductivity of the permeate were monitored using the digital weight balance and a calibrated conductivity meter (Oakton, Eutech Instruments), respectively, at 30 min intervals. Initial conductivity of the feed solution was also measured using the calibrated conductivity meter (Oakton, Eutech Instruments). Concentration of the feed solution was determined using the gravimetric method at 60 min intervals during the MD experiment. Permeate flux and solute rejection (in terms of conductivity) were calculated using the following equations:

$$\begin{matrix}{J}_{1} = \frac{{V}_{1}}{{A}_{m 2} Δ {t}_{2}} & ( 3.1 ) \\ R ( \% ) = \frac{{C}_{f} - {C}_{p}}{{C}_{f}} \times 100 & ( 3.11 )\end{matrix}$$

where J₁, V₁, Aₘ₂, Δt₂, R, C_{f}, and Cₚ are the permeate flux, permeated water volume, membrane effective area, measurement time, solute rejection, feed concentration and permeate concentration, respectively—see References 3.18 to 3.20.

### Results

### Characteristics of the Membranes Used for Treatment of Fracking Wastewater

The characteristics of the MF membranes used for pre-treatment of fracking wastewater are reported in Table 7. The thicknesses of the nanocomposite and PSf membranes were almost identical (thickness 155 μm for nanocomposite membrane and 160 μm for PSf membrane). The porosities of the nanocomposite and PSf membranes were also almost identical (porosity 78% for nanocomposite membrane and 75% for PSf membrane). However, the mean pore size of the nanocomposite membrane was 1.18 times lower than that of the PSf membrane (mean pore size 170 nm for nanocomposite membrane and 200 nm for PSf membrane). The water contact angle of the nanocomposite membrane was 21°, while it was 2.14 times higher for the PSf membrane (water contact angle 45°). Due to higher hydrophilicity, a much higher water permeability was obtained for the nanocomposite membrane (water permeability 4814 LMH/bar) as compared to the PSf membrane (water permeability 2728 LMH/bar).

The characteristics of the FO membranes used for desalination of fracking wastewater are also reported in Table 7. The thicknesses of the nanocomposite and the PA membranes were similar (thickness 85 μm for nanocomposite membrane and 82 μm for PA membrane). The water contact angle of the nanocomposite membrane was 14°, while it was 1.79 times higher for the PA membrane (water contact angle 25°). Due to higher hydrophilicity, higher water permeability was obtained for the nanocomposite membrane (water permeability 4.5 LMH/bar) as compared to the PA membrane (water permeability 3.25 LMH/bar).

A MD process was used downstream to recover and recycle the draw solution in the FO process. The characteristics of the membrane used in the MD process are also reported in Table 7. An hydrophobic (water contact angle 123°) and microporous (mean pore size 220 nm) PVDF membrane was used in the MD process. The thickness, porosity and tensile strength of this membrane were 158 μm, 75% and 6.5 MPa, respectively.

TABLE 7
Characteristics of the membranes in terms of thickness, porosity,
mean pore size, water contact angle and water permeability.

| | | | | Mean | Water | Pure water |
|---|---|---|---|---|---|---|
| | | Thickness | Porosity | pore size | contact angle | permeability |
| Membrane | | (μm) | (%) | (nm) | (°) | (LMH/bar) |
| MF | Nanocomposite | 155 | 78 ± 1.5 | 170 | 21 ± 1 | 4814 |
| | PSf | 160 | 75 ± 1 | 200 | 45 ± 2 | 2728 |
| FO | Nanocomposite | 85 | — | — | 14 ± 0.5 | 4.5 |
| | PA | 82 | — | — | 25 ± 1 | 3.25 |
| MD | PVDF | 158 | 75 | 220 | 123 ± 3 | — |

* Porosity and mean pore size of PVDF membrane were obtained from product specification.

### Pre-Treatment of Fracking Wastewater by Microfiltration

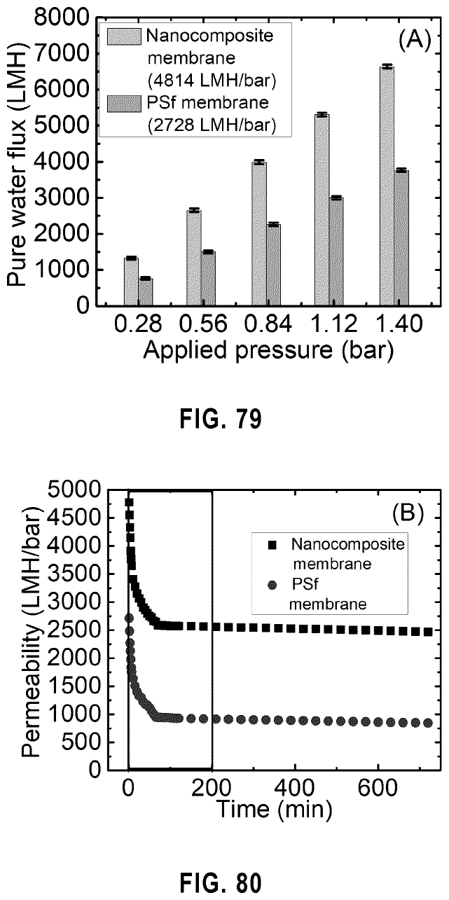

The pure water permeability values of the nanocomposite and PSf membranes are presented in FIG. 79). It was observed that the water flux increased linearly with an increase in applied pressure from 0.28 bar to 1.38 bar. This increase was gradually attained in 0.28 bar increments. It was also observed that the value of the water permeability at each applied pressure was constant for the two types of membranes (4814 and 2728 LMH/bar for the nanocomposite and PSf membranes, respectively) (FIG. 79), which indicates that no structural deformation of the membranes occurred when increasing the applied pressure. The water permeability of the nanocomposite membrane was much higher than that of the PSf membrane due to its higher hydrophilicity (Table 7).

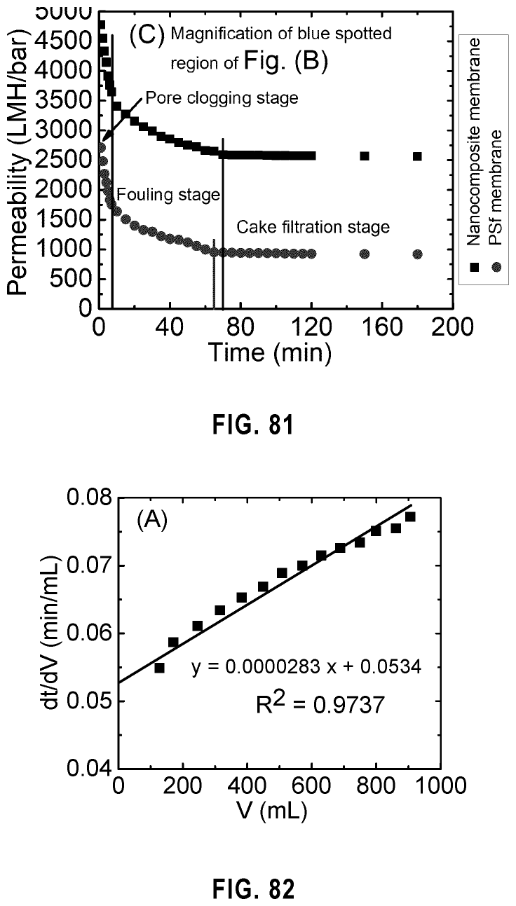

Water permeability as a function of time in pre-treatment of fracking wastewater by microfiltration is presented in FIGS. 80 and 81. (Each set of experiment was conducted three times. The average values are presented.) The initial water permeabilities were 4780 and 2710 LMH/bar for the nanocomposite and the PSf membranes, respectively (FIGS. 80 and 81). These water permeabilities decreased to 3647 LMH/bar (for the nanocomposite membrane) and 1757 LMH/bar (for the PSf membrane) at the end of the pore clogging stage. During this stage, suspended/colloidal particles block some of the pores of the membrane. During the pore clogging stage, the fouling rate largely depends on the pore size and porosity of the membrane, which cannot fully reflect the fouling properties of the membranes—see References 3.1, 3.21 and 3.22. The fouling rate in the cake filtration stage is closely related to the structure of the cake layer formed during wastewater filtration—see References 3.1, 3.21 and 3.22. In the fouling stage, the formation rate of the cake layer on the membrane surface is closely interrelated with the fouling rate of the membrane—see References 3.1, 3.21 and 3.22. During this stage (fouling stage), a 29% decline in water permeability was obtained for the nanocomposite membrane while that declined was 1.59 times higher (46%) for the PSf membrane in pre-treatment of the fracking wastewater (FIGS. 80 and FIG. 81). The lower decline in water permeability in the fouling stage was due to higher hydrophilicity for the nanocomposite membrane as compared to the PSf membrane.

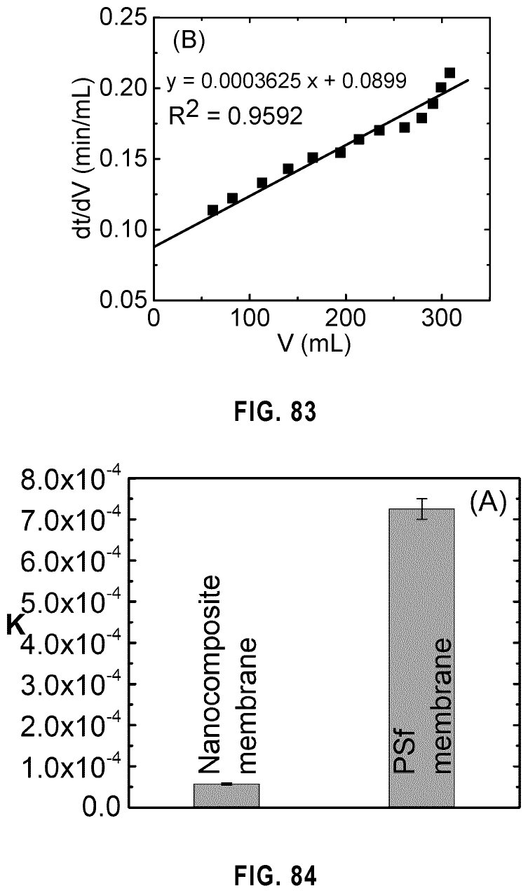

The dt/dV versus V filtration curves for the fouling stage in the microfiltration of fracking wastewater for each membrane are showed in FIGS. 82 and 83. Each set of experiments were conducted three times. The average values are presented. The specific cake resistance (K) for the fouling stage in the microfiltration of fracking wastewater was calculated from the fitted line curves of this figure. More specifically, after data calculation, the dt/dV versus V filtration curve was plotted and fitted with the linear regression method. The specific cake resistance was determined from the equation:

$$\frac{dt}{dV} = \frac{1}{q} + \frac{K}{2} V \qquad ( 3.12 )$$

where dV is the permeate volume in the time of dt and q is a constant—see References 3.1 and 3.21.

The specific cake resistances for the fouling stage for the nanocomposite and the PSf membranes in microfiltration of fracking wastewater are shown in FIG. 84. The specific cake resistances for the nanocomposite and the PSf membranes were 0.57×10⁻⁴ and 7.25×10⁻⁴, respectively, in the microfiltration of the fracking wastewater (FIG. 84). The membrane with a lower specific cake resistance or with higher hydrophilic properties shows better antifouling performance during the filtration of wastewater—see References 3.1 and 3.21. Due to higher hydrophilic properties, the nanocomposite membrane demonstrated lower values of specific cake resistances as compared to the PSf membrane.

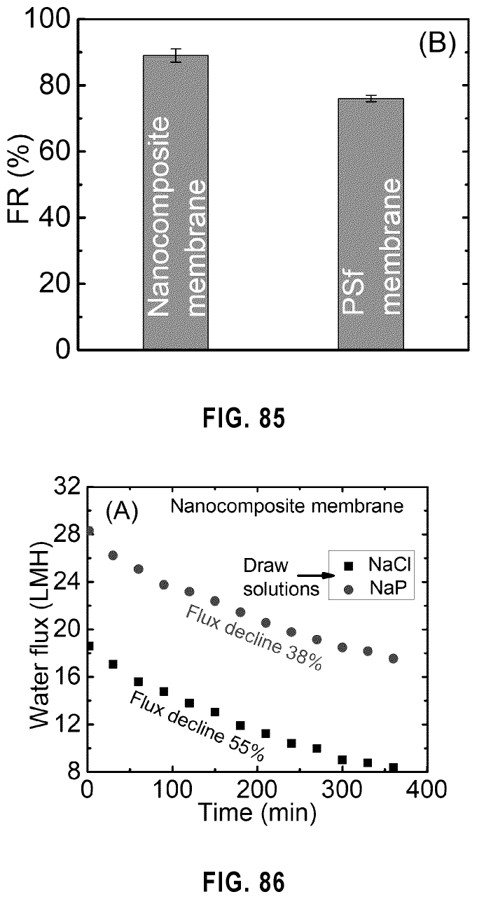

The antifouling properties, in terms of water flux recovery, of the nanocomposite and the PSf membranes in microfiltration of fracking wastewater are shown in FIG. 85 and in Table 8. The increase in water flux recovery means increased antifouling propensity of a membrane. The obtained water flux recovery of the nanocomposite and PSf membranes in microfiltration of fracking wastewater were 89% and 76%, respectively (FIG. 85). The higher water flux recovery of the nanocomposite membrane was achieved due to its more hydrophilic nature (Table 7) with very low values of specific cake resistance (FIG. 84). The high water-flux recovery of the MF membranes demonstrated their antifouling propensity—see References 3.1, 3.6, 3.7, and 3.21.

TABLE 8
Results from flux recovery test.

| | | Pure water flux (LMH) at 0.28 bar | | |
|---|---|---|---|---|
| | | Before filtration | After filtration | |
| | MF | of fracking | of fracking | FR |
| Wastewater | membrane | wastewater | wastewater | (%) |
| Fracking | Nano- | 1348 | 1200 | 89 |
| wastewater | composite | | | |
| | PSf | 764 | 581 | 76 |

The turbidity, TOC, conductivity, and pH of the fracking wastewater were 106 NTU, 853 mg/L, ˜67 mS, and ˜5.0, respectively, after collection of the sample (Table 9). The turbidity and TOC were due to the presence of oil and dissolved organic compounds in the fracking wastewater. The turbidity was reduced to 1.6 NTU and 2 NTU by the nanocomposite and PSf membranes, respectively, after conducting microfiltration. The TOC decreased to 409 mg/L and 413 mg/L after conducting microfiltration by the nanocomposite and PSf membranes, respectively. The decrease in turbidity and TOC were due to the removal of oil from the fracking wastewater by microfiltration. The TOC values of 409 mg/L (for nanocomposite membrane) and 413 mg/L (for PSf membrane) after microfiltration were due to the presence of dissolved organic compounds in the wastewater. Both of the membranes (nanocomposite and PSf) removed ˜52 TOC and ˜98% turbidity from the fracking wastewater by microfiltration process. The osmotic pressure of the fracking wastewater before and after microfiltration was measured and the value of this parameter was ˜128.3 bar (Table 9).

TABLE 9
Characteristics of fracking wastewaters before and after pre-treatment by microfiltration.

| | | | Turbidity | | TOC | | | Osmotic |
|---|---|---|---|---|---|---|---|---|
| | | Turbidity | removal | TOC | removal | Conductivity | | pressure |
| Fracking wastewater | | (NTU) | (%) | (mg/L) | (%) | (mS) | pH | (bar) |
| After collection | | 106 | — | 853 | — | 67.3 | 5.0 | 128.4 |
| After | Using | 1.6 | 98.49 | 409 | 52.05 | 67 | 4.9 | 128.3 |
| MF | Nanocomposite | | | | | | | |
| | membrane | | | | | | | |
| | Using PSf | 2 | 98.11 | 413 | 51.58 | 66.9 | 4.8 | 128.3 |
| | membrane | | | | | | | |

### FO Performance in Desalination of Fracking Wastewater

### Water Flux and Compositions of Feed and Draw Solutions

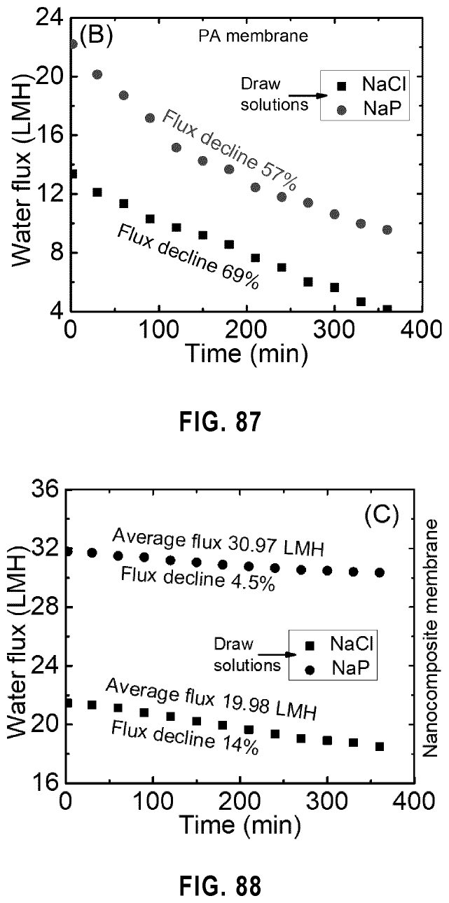

Water flux through the nanocomposite and PA membranes as a function of time for the raw fracking wastewater used as feed in FO process is shown in FIGS. 86 and 87. Each set of experiment was conducted three times and the average values obtained are reported in FIGS. 86 and 87. Initial water fluxes were 18.6 and 28.3 LMH for NaCl and NaP draw solutions, respectively, when the nanocomposite membrane was used in the FO process (FIG. 86). In FIG. 86, declines of 55% for NaCl and 38% for NaP in terms of water flux were observed, likely due to the combined effect of membrane fouling and draw solution reverse salt flux during desalination of fracking wastewater. Compared to the nanocomposite membrane, lower initial water fluxes (13.35 LMH for NaCl and 22.2 LMH for NaP) with higher declines in water flux (69% for NaCl and 57% for NaP) were obtained for the PA membrane (FIG. 87). Higher initial water fluxes with lower declines of water flux were obtained due to higher hydrophilic properties for the nanocomposite membranes as compared to the PA membrane. For both membrane, higher initial water fluxes with lower declines of water fluxes were achieved for the NaP draw solution compared to NaCl (FIGS. 86 and 87). This is likely due to higher diffusivity with lower reverse salt flux for the NaP draw solution during FO.

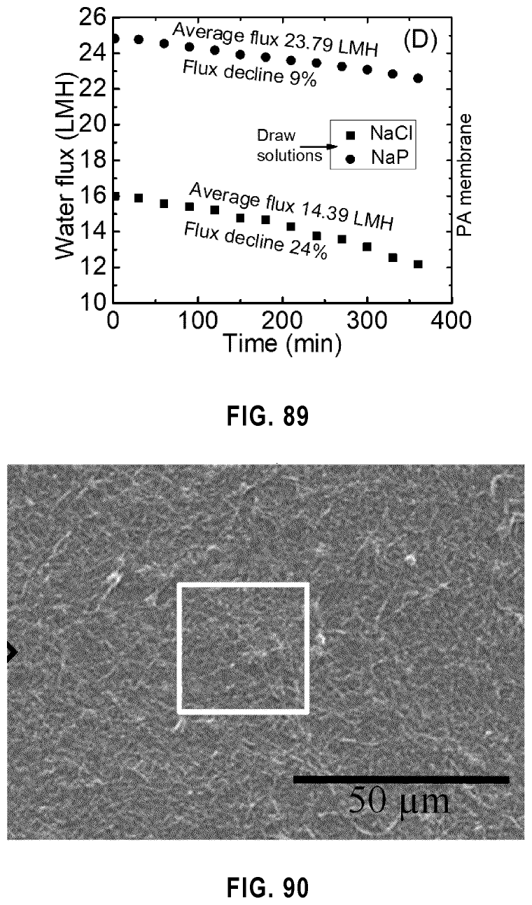

Water flux through the nanocomposite and PA membrane, as a function of time for the pre-treated fracking wastewater used as feed in FO process is exhibited in FIGS. 88 and 89. Each set of experiment was conducted three times and the average values obtained are reported in FIGS. 88 and 89. Slightly higher initial water fluxes were achieved (for both the FO membranes and draw solutions) for the pre-treated fracking wastewater as compared to the raw fracking wastewater used as feed in FO (FIGS. 86 to 89). The FO membranes may have fouled instantly with the raw fracking wastewater, something which did not occur for the pre-treated fracking wastewater. Thus, slightly higher initial water fluxes were obtained for the pre-treated fracking wastewater. In FIGS. 88 and 89), declines in water flux of 14% for NaCl and 4.5% for NaP were obtained for the nanocomposite membrane, while declines of 24% for NaCl and 9% for NaP were achieved for the PA membrane. Likely due to lower membrane fouling, lower declines of water fluxes were achieved for the pre-treated fracking wastewater as compared to the raw fracking wastewater used as feed in the FO experiment. The average water fluxes obtained were 19.98 LMH (for NaCl), 30.97 LMH (for NaP) and 14.39 LMH (for NaCl), 23.79 LMH (for NaP) for the nanocomposite and the PA membranes, respectively.

The composition of fracking wastewater and draw solutions in terms of TDS and TOC were investigated before and after desalination (Table 10. The TDS values of feed solutions were slightly higher before desalination as compared to those values after desalination when NaP was used as draw solution. The TDS values of NaP draw solution were also slightly higher after desalination as compared to those values before desalination. These observations indicate that very small quantities of solute (NaP) might pass through the membrane from feed to draw side during desalination by FO. On the other hand, TDS values of feed solutions slightly lower before desalination as compared to those values after desalination when NaCl was used as a draw solution. TDS values of the NaCl draw solution were little bit lower after desalination as compared to those values of before desalination. These scenarios might be due to higher reverse salt flux for this draw solution as compared to the organic draw solutions. The TOC values of feed solutions were slightly higher after desalination as compared to those values before desalination for NaP draw solution. The higher TOC values obtained were likely due to reverse salt flux of the organic draw solutions during FO process. However, TOC values were almost identical before and after desalination for the NaCl draw solution, indicating greater than 99% rejection of dissolved organic compounds in fracking wastewaters during FO.

TABLE 10
TDS and TOC in the feed (i.e. pre-treated fracking wastewater) and
draw solutions at the beginning and end of the FO experiment.

| | | TDS (mg/L) in feed | | TOC (mg/L) in feed | | TDS (mg/L) in draw | | TOC (mg/L) in draw | |
|---|---|---|---|---|---|---|---|---|---|
| | | solution | | solution | | solution | | solution | |
| | Draw | Start | End | Start | End | Start | End | Start | End |
| Membrane | solution | FO test | FO test | FO test | FO test | FO test | FO test | FO test | FO test |
| Nanocomposite | NaCl | 177952 | 178085 | 409 | 408 | 233983 | 233839 | 0 | 0.4 |
| | NaP | | 176899 | | 493 | 441848 | 442708 | 165600 | 165520 |
| PA | NaCl | | 178116 | | 410 | 233983 | 233796 | 0 | 0.5 |
| | NaP | | 176845 | | 511 | 441848 | 442692 | 165600 | 165502 |

### Investigation of Fouling Behaviour for FO Membranes

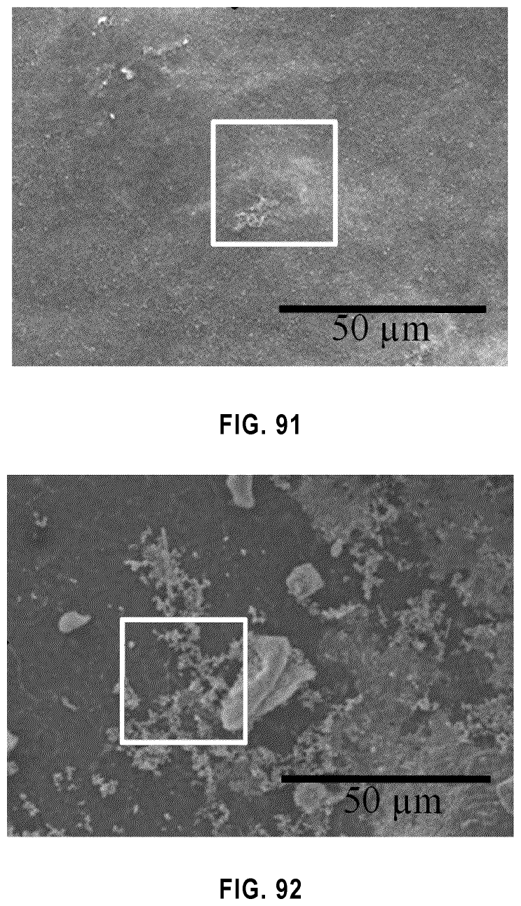

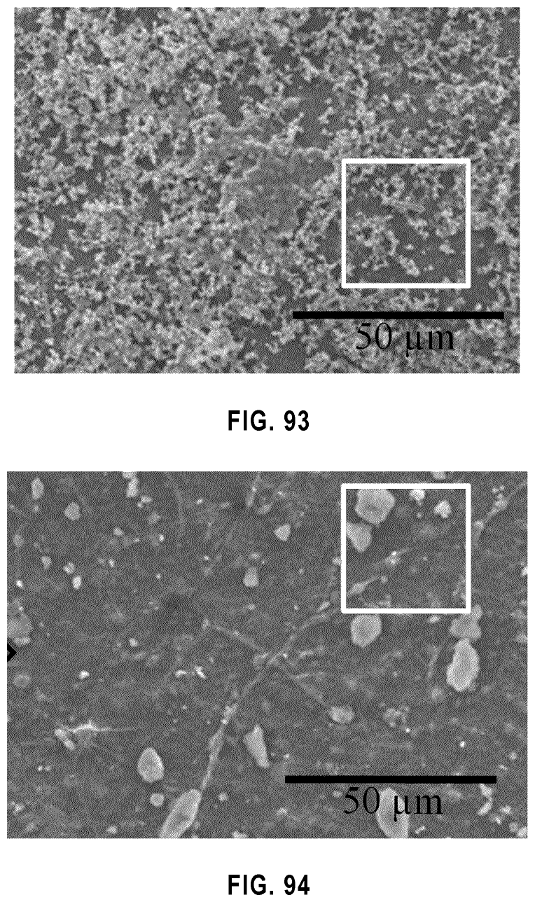

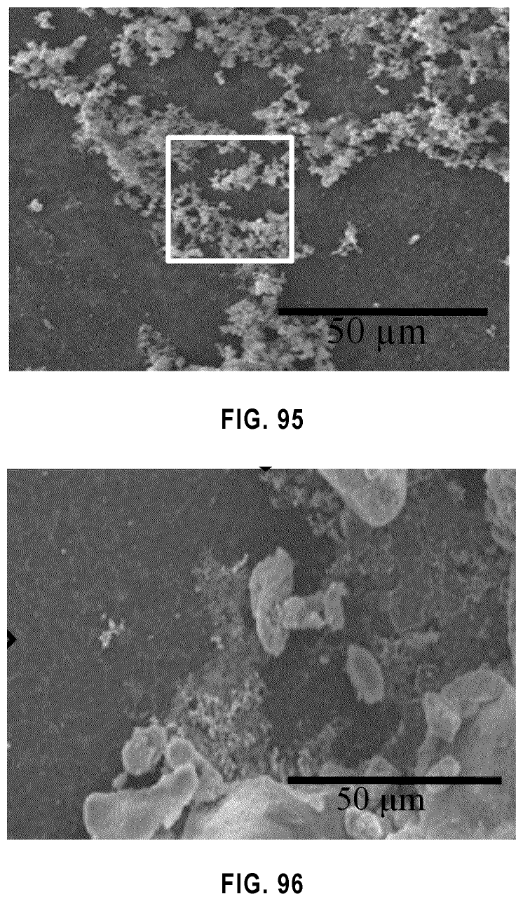

Fouling behaviours of the membranes after FO were investigated through FE-SEM. FE-SEM images of virgin nanocomposite and PA membranes are shown in FIGS. 90 and 91, respectively. Fouled nanocomposite and PA membranes when raw or pre-treated fracking wastewater and NaP solution were used as feed and draw solutions, respectively, are shown in FIGS. 92 to 95. The surfaces of the nanocomposite and PA membranes did not contain any foulant before conducting FO desalination, however, deposition of foulants was observed after conducting the FO experiment with fracking wastewater as feed (FIGS. 90 to 95). The content of foulants on the membrane surfaces was higher due to higher concentration of foulants in the raw fracking wastewater as compared to that for the pre-treated fracking wastewater (compare FIGS. 92 and 93 to FIGS. 94 and 95). It was also observed that fouling propensity for the nanocomposite membrane was lower than that for the PA membrane (compare FIGS. 92 and 94 to FIGS. 93 and 95). The lower fouling tendency for the nanocomposite membrane was likely due to its higher hydrophilicity as compared to the PA membrane.

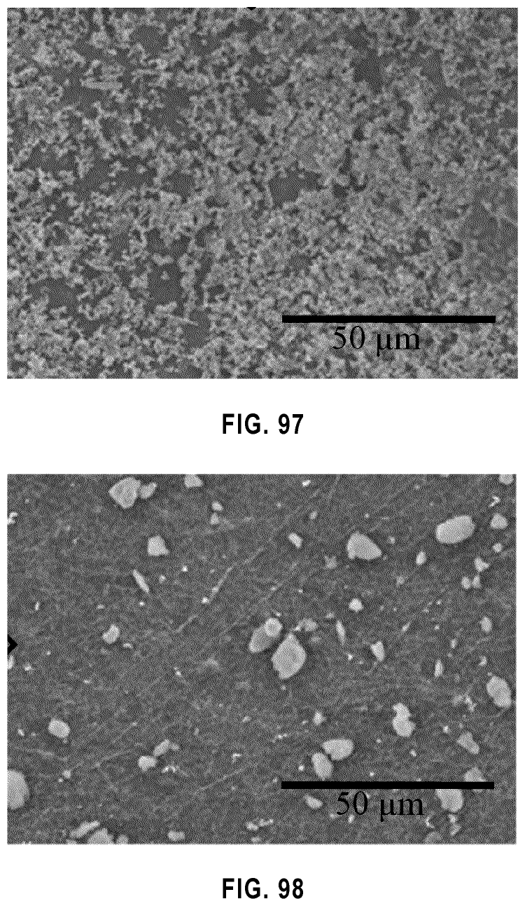

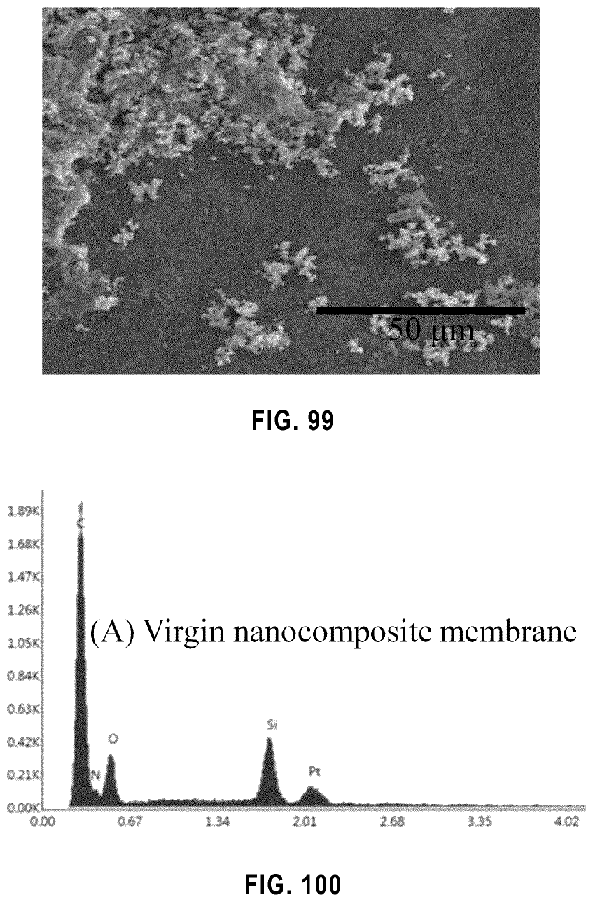

The FE-SEM images of the fouled nanocomposite and PA membranes when NaCl was used as a draw solution, are provided in FIGS. 96 to 99. The FE-SEM images demonstrate that membrane fouling trends were identical for both draw solutions (NaP and NaCl).

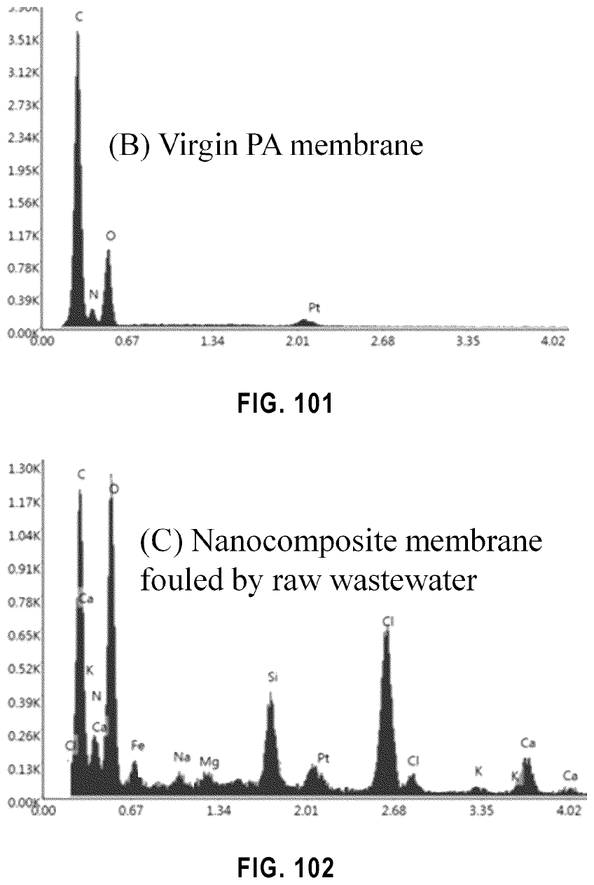

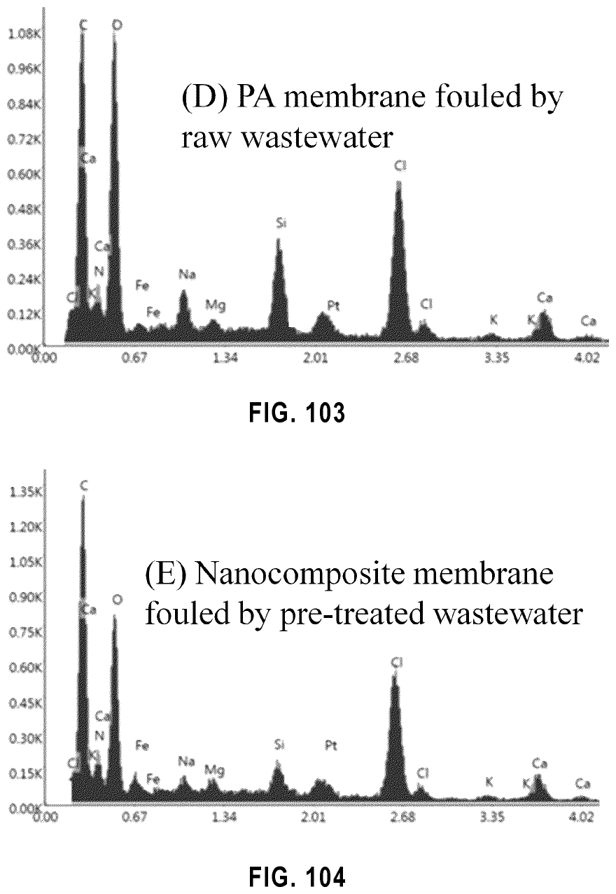

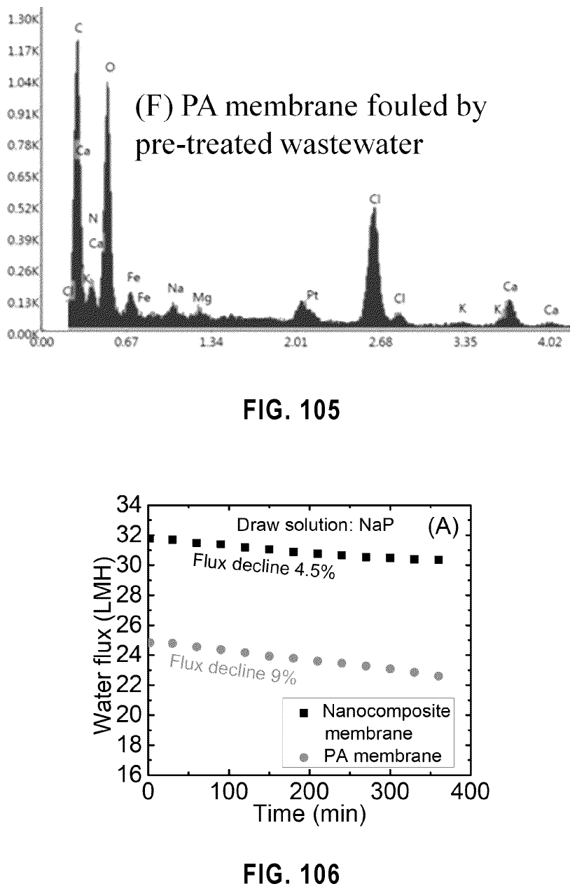

Fouling behaviours of the membranes were further investigated by SEM-EDX (spectra shown in FIGS. 100 to 105). The EDX analysis suggests the presence of C, N, O and Si atoms in the virgin nanocomposite membrane while the virgin PA membrane contained C, N and O atoms (FIGS. 100 and 101). Pt was also obtained in the EDX spectra due to the Pt coating applied to conduct the SEM analysis on the membranes. Both membranes showed additional peaks for Na, Ca, Mg, K, Fe and CI after the membrane was fouled by raw fracking wastewater (FIGS. 102 and 103). An additional peak for Si, which was not seen on the virgin PA membrane, was also obtained for the PA membrane fouled by the raw fracking wastewater (FIG. 103). These observations indicate that the membranes were likely fouled due to sand particles in wastewater, and CaCO₃ and MgCO₃ scale formation during desalination experiments. The peaks for Na, K, Fe and CI were likely due to crystallization of NaCl, KCI and FeCl₂/FeCl₃, while the membranes were dried after fouling. The membranes might also have been fouled by organic compounds (in wastewater), which EDX cannot distinguish since the membranes themselves were composed of organic compounds. The peaks for Si were not observed for the PA membrane when pre-treated wastewater was used as feed (FIG. 105). The sand particles were removed completely by pre-treatment, therefore, the Si-peak was not exhibited in the EDX spectrum (FIG. 105). However, Si-peak was observed for the nanocomposite membrane when pre-treated wastewater was used as feed (FIG. 104). The Si-peak for this membrane was due to its constituent SiO₂ nanoparticles.

### FO Water Flux Recovery for Pre-Treated Fracking Wastewater as Foulant

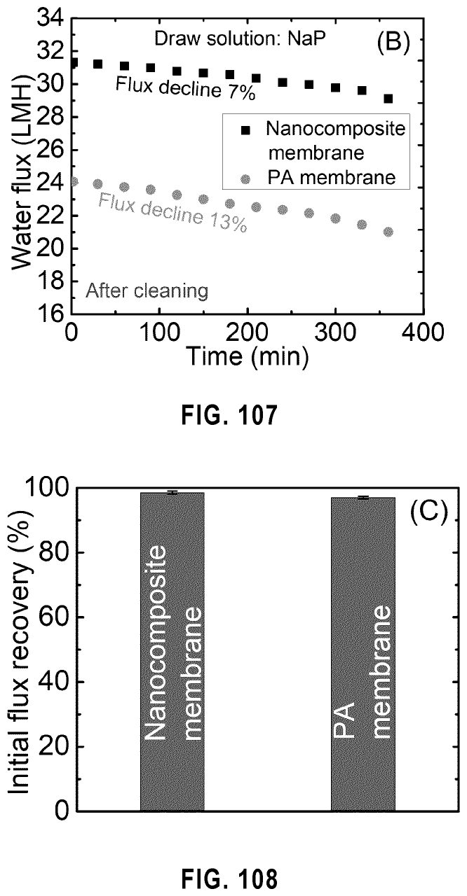

Post-desalination water flux recovery of the nanocomposite and the PA membranes was studied after treatment by FO. Water flux declined 4.5% and 9% over 6 h (with initial water fluxes of 31.78 LMH for the nanocomposite and 24.83 LMH for the PA membranes) for the nanocomposite and the PA membranes, respectively, when 4.6 M NaP was used as draw solution against pre-treated fracking wastewater (FIG. 106). These declines in water flux were mostly due to membrane fouling along with draw solution reverse salt flux. The membranes were physically cleaned after conducting the desalination of fracking wastewaters by FO. The FO water flux of the cleaned membranes was determined in order to investigate water flux recovery of the membranes. The initial water flux recovery of 98.5% (31.32 LMH) and 97% (24.08 LMH) with water flux declines of 7% and 13% over 6 h were obtained for the cleaned nanocomposite and the cleaned PA membranes, respectively (FIGS. 107 and 108). In fact, mostly inorganic fouling (scaling by CaCO₃ and MgCO₃) with only some organic fouling occurred on the membrane surface during FO desalination. Note that each set of experiment was conducted three times and the average values are reported in FIGS. 106 and 107. The draw solution was 4.6 M NaP and the feed was pre-treated fracking wastewater.

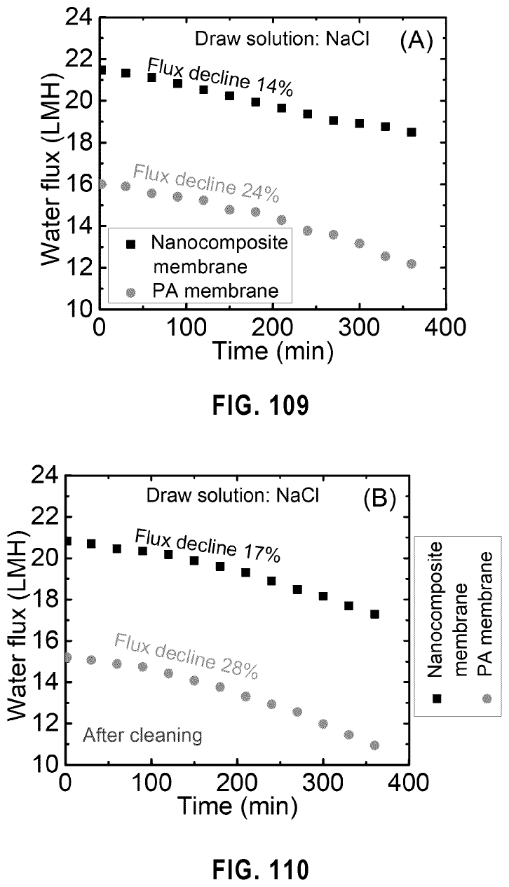

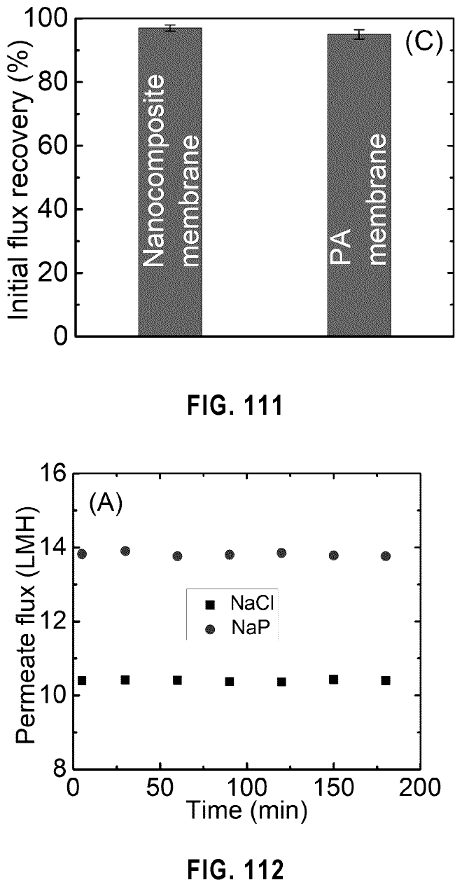

FO water flux recovery data of the nanocomposite and the PA membranes, when NaCl was used as draw solution against pre-treated fracking wastewater, are shown in FIGS. 109 to 111. Note that each set of experiments were conducted three times and the average values of the data obtained from these experiments are reported in FIGS. 109 and 110]. The feed was pre-treated fracking wastewater and the draw solution was 4.0 M NaCl.

### Recycling Draw Solution in the FO Using MD

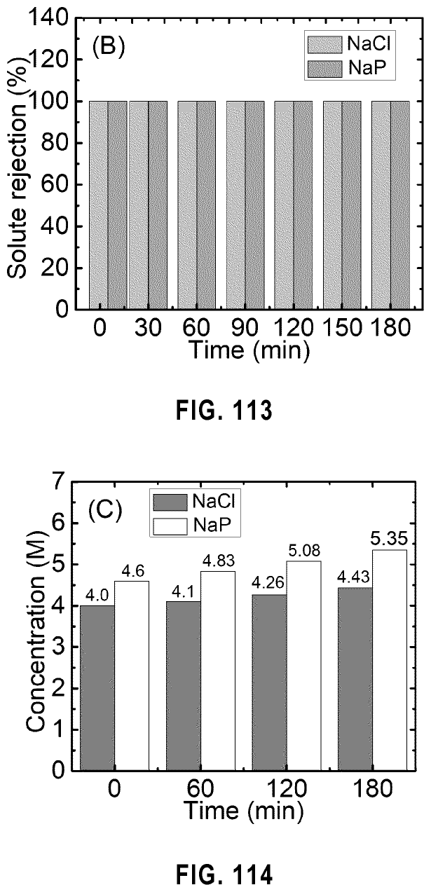

The draw solutions (obtained from FO) were used as feed solutions in the MD process, by which the separation of these draw solutions was conducted to recycle draw solute for reuse in further FO process. In the MD process, the permeate fluxes were approximately 10.40 LMH for NaCl and 13.82 LMH for NaP where a ˜99.99% solute rejection rate was obtained for both draw solution (FIGS. 112 and 113). Likely, the higher permeate flux for NaP was due to its lower interaction with water molecules as compared to the NaCl draw solution. The concentrations of the draw solutions increased over time in the MD process as demonstrated in FIG. 114. Since pure water passed from feed to permeate side, the concentration of feed solution increased as a function of time in the MD process. These concentrated feed solutions can be recycled as draw solutions in the FO process.

Note, in FIGS. 112 to 114, the feed was the draw solutions NaCl (4.0 M) and NaP (4.6 M) obtained at the end of FO experiment used for pre-treated fracking wastewater using nanocomposite FO membrane. The feed temperature was 50° C., the permeate temperature was 20° C.; and the membrane effective area was 34 cm². Each set of experiment was conducted three times and the average values obtained were reported in FIGS. 112 to 114.

The scope of the claims should not be limited by the preferred embodiments set forth in the examples but should be given the broadest interpretation consistent with the description as a whole.

### REFERENCES

The present description refers to a number of documents, the content of which is herein incorporated by reference in their entirety. These documents include, but are not limited to, the following:
American patent application publication no. US 2016/236153 A1.
Chinese patent application publication no. CN 106390764 A.
International patent application publication no. WO 2011 117443 A1.
International patent application publication no. WO 2015 084266 A1.
Korean patent no. KR 101731825 B1.
A. Achilli, T. Y. Cath, A. E. Childress, Power generation with pressure-retarded osmosis: an experimental and theoretical investigation, J. Membr. Sci. 343 (2009) 42-52.
A. C. M. Frankenm, J. A. M. Nolten; M. H. V. Mulder; D. Bargeman; C. A. Smolders, Wetting criteria for the applicability of membrane distillation. J. Membr. Sci. 1987, 33, 315-328.
A. K. Richard, Natural gas from shale bursts onto the scene, Sci. 328 (2010) 1624-1626.
A. Lafuma, D. Quere. Superhydrophobic states. Nat. Mater., 2 (2003), 457-460.
A. M. Alklaibi, N. Lior, Membrane-distillation desalination: Status and potential, Desalination 171(2005) 111-131.
A. M. Barbe, P. A. Hogan, R. A. Johnson, Surface morphology changes during initial usage of hydrophobic, microporous polypropylene membranes, J. Membr. Sci. 172(1-2) (2000)149-156.
A. Razmjou, E. Arifin, G. Dong, J. Mansouri, V. Chen. Superhydrophobic modification of TiO₂ nanocomposite PVDF membranes for applications in membrane distillation. J. Membr. Sci., 415 (2012), 850-863.
A. Tiraferri, N. Y. Yip, W. a Phillip, J. D. Schiffman, M. Elimelech, Relating performance of thin-film composite forward osmosis membranes to support layer formation and structure, J. Membr. Sci. 367 (2011) 340-352.
A. Tuteja, W. Choi, J. M. Mabry, G. H. McKinley, R. E. Cohen, Robust omniphobic surfaces. Proc. Natl. Acad. Sci. U.S.A. 105, 18200-18205 (2008)
A. K. Kota, G. Kwon, A. Tuteja, The design and applications of superomniphobic surfaces, NPG Asia Mater. 6 (2014) e109.
A. K. Kota, W. Choi, A. Tuteja, Superomniphobic surfaces: design and durability, MRS Bull. 38 (2013) 383-390.
B. Deng, M. Yu, X. Yang, B. Zhang, L. Li, L. Xie, J. Li, X. Lu, Antifouling microfiltration membranes prepared from acrylic acid or methacrylic acid grafted poly(vinylidene fluoride) powder synthesized via pre-irradiation induced graft polymerization, J. Membr. Sci. 350 (2010) 252-258.
B. G. Trewyn, J. A. Nieweg, Y. Zhao, Lin, V. S.-Y. Lin, Biocompatible mesoporous silica nanoparticles with different morphologies for animal cell membrane penetration, Chem. Eng. J. 137 (2007) 23-29.
B. Ge, Z. Zhang, X. Men, Sprayed superamphiphobic coatings on copper substrate with enhanced corrosive resistance, Appl. Surf. Sci. 293 (2014) 271-274.
B. K. Sovacool, Cornucopia or curse? Reviewing the costs and benefits of shale gas hydraulic fracturing (fracking), Renewable and Sustainable Energy Reviews, 37 (2014) 249-264.
B. Khorshidi, A. Bhinder, T. Thundat, D. Pernitsky, M. Sadrzadeh, Developing high throughput thin film composite polyamide membranes for forward osmosis treatment of SAGD produced water, J. Membr. Sci. 511 (2016) 29-39.
B. Khorshidi, T. Thundat, B. Fleck, M. Sadrzadeh, Thin film composite polyamide membranes: parametric study on the influence of synthesis conditions, RSC Adv. 5 (2015) 54985-54997.
B. Ramalingam, S. Subramanian, R. Seeram, Recent trends in nanofibrous membranes and their suitability for air and water filtrations, Membr. 1 (2011) 232-248.
B. L. Pangarkar, M. G. Sane, S. B. Parjane, M. Guddad, Status of membrane distillation for water and wastewater treatment—a review, Desalin. Water Treat. 52 (2013) 5199-5218.
C. Boo, J. Lee, M. Elimelech, Engineering surface energy and nanostructure of microporous films for expanded membrane distillation applications, Environ. Sci. Technol. 50 (2016) 8112-8119.
C. Boo, J. Lee, M. Elimelech, Omniphobic polyvinylidene fluoride (PVDF) membrane for desalination of shale gas produced water by membrane distillation. Environ. Sci. Technol. 2016,50 (22), 12275-12282.
C. Boo, Y. F. Khalil, M. Elimelech, Performance evaluation of trimethylamine-carbon dioxide thermolytic draw solution for engineered osmosis, J. Membr. Sci. 473 (2015) 302-309.
C. Boyer, B. Clark, V. Jochen, R. L. C. K. Shale gas: A global resource, 23 (3) (2011) 28-39.
C. Chiam, R. Sarbatly, Vacuum membrane distillation processes for aqueous solution treatment-a review, Chem. Eng. Process. Process Intensif. 74 (2013) 27-54.
C. H. Tan, H. Y. Ng, A novel hybrid forward osmosis-nanofiltration (FO-NF) process for seawater desalination: draw solution selection and system configuration, Desalination Water Treat. 13 (2010) 356-361.
C. Jin, Y. Jiang, T. Niu and J. Huang, Cellulose-based material with amphiphobicity to inhibit bacterial adhesion by surface modification. J. Mater. Chem., 2012,22,12562-12567
C. Klaysom, T. Y. Cath, T. Depuydt, I. F. J. Vankelecom, Forward and pressure retarded osmosis: potential solutions for global challenges in energy and water supply, Chem. Soc. Rev. 42 (2013) 6959-6989.
C. Lee and C.-J. Kim, Underwater Restoration and Retention of Gases on Superhydrophobic Surfaces for Drag Reduction. Phys. Rev. Lett., 2011, 106, 014502
C. Liao, J. Zhao, P. Yu, H. Tong, Y. Luo, Synthesis and characterization of low content of different SiO₂ materials composite poly (vinylidene fluoride) ultrafiltration membranes, Desalination 285 (2012) 117-122.
C. S. Ong, P. S. Goh, W. J. Lau, N. Misdan, A. F. Ismail, Nanomaterials for biofouling and scaling mitigation of thin film composite membrane: A review, Desalination 393 (2016) 2-15.
C. Zhao, X. Xu, J. Chen, F. Yang, Optimization of preparation conditions of poly(vinylidene fluoride)/graphene oxide microfiltration membranes by the Taguchi experimental design, Desalination 334 (2014) 17-22.
C. T. Hsieh, J. M. Chen, R. R. Kuo, T. S. Lin, C. F. Wu. Influence of surface roughness on water- and oil-repellent surfaces coated with nanoparticles. Appl. Surf. Sci., 240 (2005), 318-326
D. Emadzadeh, W.J. Lau, T. Matsuura, M. Rahbari-Sisakht, A. F. Ismail, A novel thin film composite forward osmosis membrane prepared from PSfi-TiO₂ nanocomposite substrate for water desalination, Chem. Eng. J. 237 (2014) 70-80.
D. L. Shaffer, L. H. A. Chavez, M. Ben-Sasson, S. R.-V. Castrillon, N. Y. Yip, M. Elimelech, Desalination and reuse of high-salinity shale gas produced water: Drivers, Technologies, and Future Directions, Environ. Sci. Technol. 47 (2013) 9569-9583.
D. Liu, J. Zhu, M. Qiu, C. He, Antifouling performance of poly(lysine methacrylamide)-grafted PVDF microfiltration membrane for solute separation, Separa. Purifi. Technol. 171 (2016) 1-10.
D. Rana, T. Matsuura, Surface modifications for antifouling membranes, Chem. Rev. 110 (2010) 2448-2471.
D. Hou, D. Lin, C. Ding, D. Wang, J. Wang, Fabrication and characterization of electrospun superhydrophobic PVDF-HFP/SiNPs hybrid membrane for membrane distillation, Separation and Purification Technology 189 (2017) 82-89.
E. Fontananova, J. C. Jansen, A. Cristiano, E. Curcio, E. Drioli, Effect of additives in the casting solution on the formation of PVDF membranes, Desalination 192 (1-3) (2006) 190-197
E. Shaulsky, S. Nejati, C. Boo, F. Perreault, C. O. Osuji, M. Elimelech, Post-fabrication modification of electrospun nanofiber mats with polymer coating for membrane distillation applications, J. Membr. Sci. 530 (2017) 158-165.
E. Yüksel, I. A. Sengil, M. Ozacar, The removal of sodium dodecyl sulfate in synthetic wastewater by peroxi-electrocoagulation method, Chem. Eng. J. 152 (2009) 347-353.
F. Cirisano, A. Benedetti, L. Liggieri, F. Ravera, E. Santini, M. Ferrari. Amphiphobic coatings for antifouling in marine environment Colloids Surf. A Physicochem. Eng. Aspects, 505 (2016), 158-164
F. Liu, N.A. Hashim, Y. Liu, M. R. M. Abed, et al. Progress in the production and modification of PVDF membranes. J. Membr. Sci., 375 (1-2) (2011), 1-27
F. A. Banat, J. Simandl, “Desalination by membrane distillation for dilute ethanol: Seperation from aqueous streams,” J. Membrane Sci., 163, pp 333-348, 1999
G. B. Kelvin, V. D. Radisav, D. A. David, Water management challenges associated with the production of shale gas by hydraulic fracturing, Elements 7 (2011) 181-186.
G. Chen, X. Yang, Y. Lu, R. Wang, A. G. Fane, Heat transfer intensification and scaling mitigation in bubbling-enhanced membrane distillation for brine concentration, J. Membr. Sci. 470 (2014) 60-69.
G. D. Mehta, S. Loeb, Internal polarization in the porous substructure of a semipermeable membrane under pressure-retarded osmosis, J. Membr. Sci. 4 (1978) 261-265.
G. Han, Q. Ge, T.-S. Chung, Conceptual demonstration of novel closed-loop pressure retarded osmosis process for sustainable osmotic energy generation, Appl. Energy 132 (2014) 383-393.
G. Han, T. S. Chung, M. Toriida, S. Tamai, Thin-film composite forward osmosis membranes with novel hydrophilic supports for desalination, J. Membr. Sci. 423-424 (2012) 543-555.
G. Zuo, R. Wang. Novel membrane surface modification to enhance anti-oil fouling property for membrane distillation application. J. Membr. Sci., 447 (2013), 26-35.
G.-B. Yin, Analysis of Electrospun Nylon 6 Nanofibrous Membrane as Filters, J. Fiber Bioeng. Informat. 3 (2010) 137-141.
H. Dong, P. Ye, M. Zhong, J. Pietrasik, R. Drumright, K. Matyjaszewski, Superhydrophilic surfaces vis polymer-SiO₂ nanocomposites, Langmuir 26 (2010) 15567-15573.
H. Li, W. Shi, Y. Zhang, R. Zhou, H. Zhang, Preparation of hydrophilic PVDF/PPTA blend membranes by in situ polycondensation and its application in the treatment of landfill leachate, Appl. Surf. Sci. 346 (2015) 134-146.
H. Meng, S. Wang, J. Xi, Z. Tang, L. Jiang. Facile means of preparing superamphiphobic surfaces on common engineering metals, J. Phys. Chem. C 112 (2008) 11454-11458.
H. R. Pant, M. P. Bajgai, C. Yi, R. Nirmala, K. T. Nam, W. Baek, H. Y. Kim, Effect of successive electrospinning and the strength of hydrogen bond on the morphology of electrospun nylon-6 nanofibers, Colloid Surf. A: Physicochem. Eng. Asp. 370 (2010) 87-94.
H. Shi, Y. He, Y. Pan, H. Di, G. Zeng, L. Zhang, C. Zhang, A modified mussel-inspired method to fabricate TiO₂ decorated superhydrophilic PVDF membrane for oil/water separation, J. Membr. Sci. 506 (2016) 60-70.
H. Zhou, H. Wang, H. Niu, A. Gestos, T. Lin. Robust self-healing superamphiphobic fabrics prepared by two-step coating of fluoro-containing polymer, fluoroalkyl silane, and modified silica nanoparticles. Adv. Funct. Mater., 23 (2013), 1664-1670.
I. C. Scotchman, Shale gas and fracking: exploration for unconventional hydrocarbons, Proceedings of the Geologists' Association, Accepted 1 Sep. 2016.
I. Pinnau, B. D. Freeman, Formation and modification of polymeric membranes: overview, in: I. Pinnau, B. D. Freeman (Eds.), Membrane Formation and Modification, American Chemical Society, Washington, D.C., 1999, pp. 1-22.
J. Ahmad, M.-B. Hagg, Preparation and characterization of polyvinyl acetate/zeolite 4A mixed matrix membrane for gas separation, J. Membr. Sci. 427 (2013) 73-84.
J. Ju, C. Wang, T. Wang, Q. Wang, Preparation and characterization of pH-sensitive and antifouling poly(vinylidene fluoride) microfiltration membranes blended with poly(methyl methacrylate-2-hydroxyethyl methacrylate-acrylic acid), J. Colloid Interf. Sci. 434 (2014) 175-180.
J. Lee, C. Boo, W. H. Ryu, A. D. Taylor, M. Elimelech, Development of omniphobic desalination membranes using a charged electrospun nanofiber scaffold, ACS Appl. Mater. Interfaces 8 (2016) 11154-11161.
J. Ren, J. R. McCutcheon, A new commercial thin film composite membrane for forward osmosis, Desalination 343 (2014) 187-193.
J. Ren, B. O'Grady, G. deJesus, J. R. McCutcheon, Sulfonated polysulfone supported high performance thin film composite membranes for forward osmosis, Polymer 103 (2016) 486-497.
J. T. Arena, B. McCloskey, B. D. Freeman, J. R. McCutcheon, Surface modification of thin film composite membrane support layers with polydopamine: enablinguse of reverse osmosis membranes in pressure retarded osmosis, J. Membr. Sci. 375 (2011) 55-62.
J. W. Krumpfer, T. Schuster, M. Klapper, K. Müllen, Make it nano—keep it nano, Nano Today 8 (2013) 417-438.
J. Wei, C. Qiu, C. Y. Tang, R. Wang, A. G. Fane, Synthesis and characterization of flat-sheet thin film composite forward osmosis membranes, J. Membr. Sci. 372(2011) 292-302.
J. Xu, J. Sun, Y. Wang, J Sheng, F. Wang. M. Sun, Application of Iron Magnetic Nanoparticles in Protein Immobilization, Molecules 2014, 19(8), 11465-11486.
J. Yang, J. Zhao, Preparation and mechanical properties of silica nanoparticles reinforced composite hydrogels, Mater. Lett. 120 (2014) 36-38.
J. Yin, J. Zhou, Novel polyethersulfone hybrid ultrafiltration membrane prepared with SiO₂-g-(PDMAEMA-co-PDMAPS) and its antifouling performances in oil-in-water emulsion application, Desalination 365 (2015) 46-56.
J. Zhang, Z. Song, B. Li, Q. Wang, S. Wang. Fabrication and characterization of superhydrophobic poly (vinylidene fluoride) membrane for direct contact membrane distillation. Desalination, 324 (2013), 1-9.
J. A. Prince, S. Bhuvana, V. Anbharasi, N. Ayyanar, K. V. K. Boodhoo, G. Singh, Ultra-wetting graphene-based PES ultrafiltration membrane—A novel approach for successful oil-water separation, Water research 103 (2016) 311-318.
J. E. Efome, M. Baghbanzadeh, D. Rana, T. Matsuura, C. Q. Lan, Effects of superhydrophobic SiO2 nanoparticles on the performance of PVDF flat sheet membranes for vacuum membrane distillation. Desalination 373 (2015) 47-57.
J.-F. Li, Z.-L. Xu, H. Yang, L.-Y. Yu, M. Liu, Effect of TiO₂ nanoparticles on the surface morphology and performance of microporous PES membrane, Appl. Surf. Sci. 255 (2009) 4725-4732.
J. M. Ortiz de Zárate, C. Rincón, J. I. Mengual, Concentration of bovine serum albumin aqueous solutions by membrane distillation, Sep. Sci. Technol. 33 (1998), 283-296.
K. L. Hickenbottom, J. Vanneste, T. Y. Cath, Assessment of alternative draw solutions for optimized performance of a closed-loop osmotic heat engine, J. Membr. Sci. 504 (2016) 162-175.
K. Lum, D. Chandler, J. D. Weeks, Hydrophobicity at small and large length scales, J. Phys. Chem. B 103 (1999) 4570-4577.
K. Lutchmiah, A. R. D. Verliefde, K. Roest, L. C. Rietveld, E. R. Cornelissen, Forward osmosis for application in wastewater treatment: a review, Water Res. 58(2014) 179-197.
K. S. Pitzer, Thermodynamics, McGraw-Hill Inc., New York 1995.
K. Y. Wang, T. S. Chung, G. Amy, Developing thin-film-composite forward osmosis membranes on the PES/SPSf substrate through interfacial polymerization, AIChE J. 58 (2012) 770-781.
Kim, Y.-D.; Thu, K.; Ghaffour, N.; Choon Ng, K. Performance investigation of a solar-assisted direct contact membrane distillation system. J. Membr. Sci. 2013, 427, 345-364.
L. Huang, J. R. McCutcheon, Hydrophilic nylon 6,6 nanofibers supported thin film composite membranes for engineered osmosis, J. Membr. Sci. 457(2014)162-169.
L. Huang, J. T. Arena, J. R. McCutcheon, Surface modified PVDF nanofiber supported thin film composite membranes for forward osmosis, J. Membr. Sci. 499 (2016) 352-360.
L. Shen, S. Xiong, Y. Wang, Graphene oxide incorporated thin-film composite membranes for forward osmosis applications, Chem. Eng. Sci. 143 (2016) 194-205.
Le Han, Tong Xiao, Yong Zen Tan, Anthony G. Fane, Jia Wei Chew, Contaminant rejection in the presence of humic acid by membrane distillation for surface water treatment, J. Membr. Sci. 541 (2017) 291-299.
Leng, B.; Shao, Z.; de With, G.; Ming, W. Superoleophobic cotton textiles. Langmuir 2009, 25, 2456-2460.
M. Bhadra, S. Roy, S. Mitra, Desalination across a graphene oxide membrane via direct contact membrane distillation, Desalination 378 (2016) 37-43.
M. El-Bourawi, Z. Ding, R. Ma, M. Khayet, A framework for better understanding membrane distillation separation process, J. Membr. Sci. 285 (2006) 4-29.
M. Gryta, Effect of iron oxides scaling on the MD process performance, Desalination 216 (1-3) (2007) 88-102.
M. Guo, B. Ding, X. Li, X. Wang, J. Yu, M. Wang, Amphiphobic nanofibrous silica mats with flexible and high-heat-resistant properties, J. Phys. Chem. C 114 (2010) 916-921.
M. Hamdan, A. O. Sharif, G. Derwish, S. Al-Aibi, A. Altaee, Draw solutions for Forward Osmosis process: Osmotic pressure of binary and ternary aqueous solutions of magnesium chloride, sodium chloride, sucrose and maltose, J. Food Eng. 155 (2015) 10-15.
M. J. Blandamer, J. B. Engberts, P. T. Gleeson, J. C. Reis, Activity of water in aqueous systems; A frequently neglected property, Chem. Soc. Rev. 34 (2005) 440-458.
M. J. Park, R. R. Gonzales, A. Abdel-Wahab, S. Phuntsho, H. K. Shon, Hydrophilic polyvinyl alcohol coating on hydrophobic electrospun nanofiber membrane for high performance thin film composite forward osmosis membrane, Desalination 426 (2018) 50-59.
M. Khayet, A. Vela'zquez, J.I. Mengual, Direct contact membrane distillation of humic acid solutions, J. Membr. Sci. 240 (2004) 123-128.
M. Li, D. Wang, R. Xiao, G. Sun, Q. Zhao, H. Li, A novel high flux poly (trimethylene terephthalate) nanofiber membrane for microfiltration media, Sep. Purif. Technol. 116 (2013) 199-205.
M. M. Pendergast, E. M. V. Hoek, A review of water treatment membrane nanotechnologies, Energy Environ. Sci. 4 (2011) 1946-1971.
M. Qasim, F. Mohammed, A. Aidan, N. A. Darwish, Forward osmosis desalination using ferric sulfate draw solute, Desalination 423 (2017) 12-20.
M. S. El-Bourawi, Z. Ding, R. Ma, M. Khayet, A frame work for better understanding membrane distillation separation process, J. Membr. Sci. 285(1-2) (2006) 4-29.
M. S. Islam, J. R. McCutcheon, M. S. Rahaman, A high flux polyvinyl acetate-coated electrospun nylon 6/SiO₂ composite microfiltration membrane for the separation of oil-in-water emulsion with improved antifouling performance, J. Membr. Sci. 537 (2017) 297-309.
M. S. Islam, M. S. Rahaman, J. H. Yeum, Electrospun novel super-absorbent based on polysaccharide-polyvinyl alcohol-montmorillonite clay nanocomposites, Carbohydrate Polym. 115 (2015) 69-77.
M. S. Islam, M. S. Rahaman, J. H. Yeum, Phosphine-functionalized electrospun poly(vinyl alcohol)/silica nanofibers as highly effective adsorbent for removal of aqueous manganese and nickel ions, J. Colloid Sur. A: Physicochem. Eng. Asp. 484 (5) (2015) 9-18.
M. Sadrzadeh, S. Bhattacharjee, Rational design of phase inversion membranes by tailoring thermodynamics and kinetics of casting solution using polymer additives, J. Membr. Sci. 441 (2013) 31-44.
M. Tao, L. Xue, F. Liu, L. Jiang, An Intelligent superwetting PVDF membrane showing switchable transport performance for oil/water separation, Adv. Mater. 26 (2014) 2943-2948.
M. Tian, C. Qiu, Y. Liao, S. Chou, R. Wang, Preparation of polyamide thin film composite forward osmosis membranes using electrospun polyvinylidenefluoride (PVDF) nanofibers as substrates, Sep. Purif. Technol. 118 (2013)727-736.
M. Tomaszewska, L. Bialończyk, Influence of proteins content in the feed on the course of membrane distillation, Desalin. Water Treat. 51 (10-12) (2012), 2362-2367.
M. Yasukawa, S. Mishima, M. Shibuya, D. Saeki, T. Takahashi, T. Miyoshi, T. Miyoshi, H. Matsuyama, Preparation of a forward osmosis membrane using a highly porous polyketone microfiltration membrane as a novel support, J. Membr. Sci. 487 (2015) 51-59.
M. Zhua, G. Xua, M. Yua, Y. Liva, R. Xiaoa, Preparation, properties, and application of polypropylene micro/nanofiber membranes, Polym. Adv. Technol. 23 (2012) 247-254.
N. M. Mazlan, P. Marchetti, H. A. Maples, B. Gu, S. Karan, A. Bismarck, A. G. Livingston, Organic fouling behaviour of structurally and chemically different forward osmosis membranes—A study of cellulose triacetate and thin film composite membranes, J. Membr. Sci. 520 (2016) 247-261.
N. Ma, J. Wei, R. Liao, C. Y. Tang, Zeolite-polyamide thin film nanocomposite membranes: towards enhanced performance for forward osmosis, J. Membr. Sci. 405-406 (2012) 149-157.
N. Niksefat, M. Jahanshahi, A. Rahimpour, The effect of SiO₂ nanoparticles on morphology and performance of thin film composite membranes for forward osmosis application, Desalination, 343, (2014), 140-146.
N. Valipour-Motlagh, F. C. Birjandi, J. Sargolzaei, N. Shahtahmassebi. Durable, superhydrophobic, superoleophobic and corrosion resistant coating on the stainless steel surface using a scalable method, Appl. Surf. Sci., 283 (2013), 636-647.
N. Widjojo, T. S. Chung, M. Weber, C. Maletzko, V. Warzelhan, The role of sulphonated polymer and macro void-free structure in the support layer for thin-film composite (TFC) forward osmosis (FO) membranes, J. Membr. Sci. 383 (2011) 214-223.
N. Y. Yip, A. Tiraferri, W. A. Phillip, J. D. Schiffman, M. Elimelech, High performance thin-film composite forward osmosis membrane, Environ. Sci. Technol. 44 (2010) 3812-3818.
N.-N. Bui, J. R. McCutcheon, Nanofiber Supported Thin-Film Composite Membrane for Pressure-Retarded Osmosis, Environ. Sci. Technol. 48 (2014) 4129-4136.
N.-N. Bui, J. R. McCutcheon, Nanoparticle-embedded nanofibers in highly permselective thin-film nanocomposite membranes for forward osmosis, J. Membr. Sci. 518 (2016) 338-346.
P. Cay-Durgun, C. McCloskey, J. Konecny, A. Khosravi, M. L. Lind, Evaluation of thin film nanocomposite reverse osmosis membranes for long-term brackish water desalination performance, Desalination 404 (2017) 304-312.
P. Lu, S. Liang, L. Qiu, Y. Gao, Q. Wang, Thin film nanocomposite forward osmosis membranes based on layered double hydroxide nanoparticles blended substrates, J. Membr. Sci. 504 (2015) 196-205.
P. Roach, N. J. Shirtcliffe, M. I. Newton. Progess in superhydrophobic surface development. Soft Matter, 2008, 4, 224-240.
Paramita Das, Helga Thomas, Martin Moeller, Andreas Walther. Large-scale, thick, self-assembled, nacre-mimetic brick-walls as fire barrier coatings on textiles. Scientific Reports 7 (2017) 39910.
Q. Shi, N. Vitchuli, L. Ji, J. Nowak, M. McCord, M. Bourham, X. Zhang, A Facile Approach to Fabricate Porous Nylon 6 Nanofibers Using Silica Nanotemplate, J. Appl. Polym. Sci. 120 (2011) 425-433.
R. D. Vidic, S. L. Brantley, J. M. Vandenbossche, D. Yoxtheimer, J. D. Abad, Impact of shale gas development on regional water quality, Sci. 340 (6134) (2013) 826-835.
R. J. Petersen, Composite reverse osmosis and nanofiltration membranes, J. Membr. Sci. 83 (1993) 81-150.
R. J. Peterson, J. E. Cadotte, Thin Film Composite Reverse Osmosis Membrane. In Handbook of Industrial Membrane Technology, Porter, M.C., Ed.; Noyes Publications: Westwood, N.J., 1990.
R. Nirmala, K. T. Nam, S. J. Park, Y. S. Shin, R. Navamathavan, H. Y. Kim, Formation of high aspect ratio polyamide-6 nanofibers via electrically induced double layer during electrospinning, Appl. Surf. Sci. 256 (2010) 6318-6323.
R. Schwantes, A. Cipollina, F. Gross, J. Koschikowski, D. Pfeifle, M. Rolletschek, V. Subiela. Membrane distillation: solar and waste heat driven demonstration plants for desalination Desalination, 323 (2013), 93-106.
R. Wang, Y. Liu, B. Li, B. S. Hsiao, Electrospun nanofibrous membranes for high flux microfiltration, J. Membr. Sci. 392-393 (2012) 167-174.
S. Kumar, A. Mandal, C. Guria, Synthesis, characterization and performance studies of polysulfone and polysulfone/polymer-grafted bentonite based ultrafiltration membranes for the efficient separation of oil field oily wastewater, Process Safety Environ. Protection 102 (2016) 214-228.
S. Liang, Y. Kang, A. Tiraferri, E. P. Giannelis, X. Huang, M. Elimelech, Highly Hydrophilic Polyvinylidene Fluoride (PVDF) Ultrafiltration Membranes via Post-fabrication Grafting of Surface-Tailored Silica Nanoparticles, ACS Appl. Mater. Interf. 5 (2013) 6694-6703.
S. Lin, N. Y. Yip, M. Elimelech, Direct contact membrane distillation with heat recovery: thermodynamic insights from module scale modeling, J. Membr. Sci. 453 (2014) 498-515.
S. Loeb, L. Titelman, E. Korngold, J. Freiman, Effect of porous support fabric on osmosis through a Loeb-Sourirajan type asymmetric membrane, J. Membr. Sci. 129 (1997) 243-249.
S. M. Olmstead, L. A. Muehlenbachs, J.-S. Shih, Z. Chu, A. J. Krupnick, Shale gas development impacts on surface water quality in Pennsylvania, Proceedings of the National Academy of Sciences of the United States of America 110 (13) (2013) 4962-4967.
S. Mandi, S. Shahabadi, H. Rabiee, S. M. Seyedi, A. Mokhtare, J. A. Brant, Superhydrophobic dual layer functionalized titanium dioxide/polyvinylidene fluoride-co-hexafluoropropylene (TiO2/PH) nanofibrous membrane for high flux membrane distillation, J. Membr. Sci. 2017, 537(1), 140-150.
S. Meng, J. Mansouri, Y. Ye, V. Chen, Effect of templating agents on the properties and membrane distillation performance of TiO2-coated PVDF membranes, J. Memb. Sci. 450 (2014) 48-59.
S. Meng, Y. Ye, J. Mansouri, V. Chen. Fouling and crystallisation behaviour of superhydrophobic nano-composite PVDF membranes in direct contact membrane distillation. J. Membr. Sci., 463 (2014), 102-112.
S. Pan, A. K. Kota, J. M. Mabry and A. Tuteja, Superomniphobic Surfaces for Effective Chemical Shielding. J. Am. Chem. Soc., 2013, 135, 578-581.
S. Srisurichan, R. Jiraratananon, A.G. Fane, Humic acid fouling in the membrane distillation process, Desalination 174 (1) (2005) 63-72.
S. Xiong, J. Zuo, Y. G. Ma, L. Liu, H. Wu, Y. Wang, Novel thin film composite forward osmosis membrane of enhanced water flux and anti-fouling property with N-[3-(trimethoxysilyl) propyl] ethylenediamine incorporated, J. Membr. Sci. 520 (2016) 400-414.
S. Zhao, L. Zou, C. Y. Tang, D. Mulcahy, Recent developments in forward osmosis: opportunities and challenges, J. Membr. Sci. 396 (2012) 1-21.
S.-F. Pan, Y. Dong, Y.-M. Zheng, L.-B. Zhong, Z.-H. Yuan, Self-sustained hydrophilic nanofiber thin film composite forward osmosis membranes: Preparation, characterization and application for simulated antibiotic wastewater treatment, J. Membr. Sci. 523 (2017) 205-215.
S. M. Kang, S. M. Kim, H. N. Kim, M. K. Kwak, D. H. Tahk, K. Y. Suh, Robust superomniphobic surfaces with mushroom-like micropillar arrays, Soft Matter 8 (2012) 8563-8568.
S. T. Wang, L. Feng, L. Jiang, One-step solution-immersion process for the fabrication of stable bionic superhydrophobic surfaces, Adv. Mater. 18 (6) (2006) 767.
Shaffer, D. L.; Arias Chavez, L. H.; Ben-Sasson, M.; Romero-Vargas Castrillón, S.; Yip, N. Y.; Elimelech, M. Desalination and reuse of high-salinity shale gas produced water: Drivers, technologies, and future directions. Environ. Sci. Technol. 2013, 47 (17), 9569-9583.
Sun, T. Paul, C. L. Meyer, C. Kuijvenhoven, S. Padmasiri, V. Fedotov, “Treatment of water from fracturing operation for unconventional gas production,” in Contemporary Technologies for Shale-Gas Water and Environmental Management, Ronald D. Neufeld, editor. Alexandria, Va.: Water Environment Federation (2012) 61-81.
T. D. Naylor, Polymer Membranes—Materials, Structures and Separation Performance; Dolbey, R. T. L., Ed.; Rapra Technology Limited: Billingham, UK, 1996.
T. M. Ting, M. M. Nasef, K. Hashim, Modification of nylon-6 fibres by radiation-induced graft polymerisation of vinylbenzyl chloride, Radia. Phy. Chem. 109 (2015) 54-62.
T. Rajasekhar, M. Trinadh, P. V. Babu, A. V. S. Sainath, A.V.R. Reddy, Oil-water emulsion separation using ultrafiltration membranes based on novel blends of poly(vinylidene fluoride) and amphiphilic tri-block copolymer containing carboxylic acid functional group, J. Membr. Sci. 481 (2015) 82-93.
T. S. Chung, X. Li, R. C. Ong, Q. Ge, H. Wang, G. Han, Emerging forward osmosis(FO) technologies and challenges ahead for clean water and clean energy applications, Curr. Opin. Chem. Eng. 1 (2012) 246-257.
T. Y. Cath, A. E. Childress, M. Elimelech, Forward osmosis: principles, applications, and recent developments, J. Membr. Sci. 281 (2006) 70-87.
T. L. Liu, C.-J. C. Kim, Turning a surface superrepellent even to completely wetting liquids, Science 346 (2014) 1096-1100.
U.S. Energy Information Administration, Annual Energy Outlook, Washington, D.C. (2012).
U. Zulfiqar, S. Z. Hussain, M. Awais, M. M. J. Khan, I. Hussain, S. W. Husain, T. Subhani, In-situ synthesis of bi-modal hydrophobic silica nanoparticles for oil-water separation, Colloids Surfaces A: Physicochem. Eng. Aspects 508 (2016) 301-308.
V. A. Ganesh, S. S. Dinachali, H. K. Raut, T. M. Walsh, A. S. Nair and S. Ramakrishna, Electrospun SiO2 nanofibers as a template to fabricate a robust and transparent superamphiphobic coating. RSC Adv., 2013, 3, 3819-3824
V. Dutschk, K. G. Sabbatovskiy, M. Stolz, K. Grundke, V. M. Rudoy, Unusual wetting dynamics of aqueous surfactant solutions on polymer surface, J. Colloid Interface Sci. 267 (2003) 456-462.
V. T. Granik, B. Smith, S. C. Lee, M. Ferrari, Osmotic pressures of binary solutions of non-electrolytes, Biomed. Microdevices 4 (2002) 309-321.
V. V. Tomina, G. R. Yurchenko, A. K. Matkovsky, Y. L. Zub, A. Kosak, A. Lobnik, Synthesis of polysiloxane xerogels with fluorine-containing groups in the surface layer and their sorption properties, J. Fluor. Chem. 132 (2011) 1146-1151.
W. Cao, I. M. Mujtaba, Simulation of vacuum membrane distillation process for desalination with Aspen Plus, Ind. Eng. Chem. Res. 54 (2) (2015) 672-680.
W. Guo, H.-H. Ngo, J. Li, A mini-review on membrane fouling, Bioresour. Technol. 122 (2012) 27-34.
W. J. Lau, A. F. Ismail, N. Misdan, M. A. Kassim, A recent progress in thin film composite membrane: a review, Desalination 287 (2012) 190-199.
X. Zhang, J. Tian, Z. Ren, W. Shi, Z. Zhang, Y. Xu, S. Gao, F. Cui, High performance thin-film composite (TFC) forward osmosis (FO) membrane fabricated on novel hydrophilic disulfonated poly(arylene ether sulfone) multiblock copolymer/polysulfone substrate, J. Membr. Sci. 520 (2016) 529-539.
X. Li, K. Y. Wang, B. Helmer, T. S. Chung, Thin-film composite membranes and formation mechanism of thin-film layers on hydrophilic cellulose acetate propionate substrates for forward osmosis processes, Ind. Eng. Chem. Res. 51(2012) 10039-10050.
X. Li, T.-S. Chung, Thin-film composite P84 co-polyimide hollow fiber membranes for osmotic power generation, Appl. Energy 114 (2014) 600-610.
X. Song, Z. Liu, D. D. Sun, Nano gives the answer: breaking the bottleneck of internal concentration polarization with a nanofiber composite forward osmosis membrane for a high water production rate, Adv. Mater. 23 (2011)3256-3260.
X. Yao, Y. Song and L. Jiang, Superoleophobic Surfaces with Controllable Oil Adhesion and Their Application in Oil Transportation. Adv. Funct. Mater., 2011, 21, 4270-4276
X. M. Lu, Y. L. Peng, R. J. Lin, Z. H. Zhu, S. M. Liu. Amphiphobic PVDF composite membranes for anti-fouling direct contact membrane distillation. J. Membr. Sci., 505 (2016), 61-69.
X. An, Z. Liu, Y. Hu, Amphiphobic surface modification of electrospun nanofibrous membranes for anti-wetting performance in membrane distillation. Desalination 432 (2018) 23-31.
X. Li, X. Yu, C. Cheng, L. Deng, M. Wang, X. Wang, Electrospun Superhydrophobic Organic/Inorganic Composite Nanofibrous Membranes for Membrane Distillation, ACS Appl. Mater. Interfaces 2015, 7, 21919-21930.
Y. C. Kim, M. Elimelech, Potential of osmotic power generation by pressure retarded osmosis using seawater as feed solution: analysis and experiments, J. Membr. Sci. 429 (2013) 330-337.
Y. Li, E. J. Lee, S. O. Cho, Superhydrophobic coatings on curved surfaces featuring remarkable supporting force, J. Phys. Chem. C 111 (2007) 14813-14817.
Y. Liang, J. Ju, N. Deng, X. Zhou, J. Yan, W. Kang, B. Cheng. Super-hydrophobic self-cleaning bead-like SiO2@PTFE nanofiber membranes for waterproof-breathable applications. Appl. Surf. Sci., 442 (2018), 54-64.
Y. Liao, R. Wang, A. G. Fane, Engineering superhydrophobic surface on poly (vinylidene fluoride) nanofiber membranes for direct contact membrane distillation, J. Memb. Sci. 440 (2013) 77-87
Y. Liao, R. Wang, A. G. Fane, Fabrication of bioinspired composite nanofiber membranes with robust superhydrophobicity for direct contact membrane distillation, Environ. Sci. Technol. 48 (2014) 6335-6341.
Y. Liao, R. Wang, A. G. Fane. Engineering superhydrophobic surface on poly (vinylidene fluoride) nanofiber membranes for direct contact membrane distillation. J. Membr. Sci., 440 (2013), 77-87.
Y. Tsao, D. Evans, H. Wennerstrom. Long-range attractive force between hydrophobic surfaces observed by atomic force microscopy. Science, 262 (1993), 547-550.
Y. Yang, Q. Liu, H. Wang, F. Ding, G. Jin, C. Li, H. Meng, Superhydrophobic modification of ceramic membranes for vacuum membrane distillation, Chinese J. Chem. Eng. 25 (2017) 1395-1401.
Y.-X. Huang, Z. Wang, D. Hou, S. Lin, Coaxially electrospun super-amphiphobic silica-based membrane for anti-surfactant-wetting membrane distillation, J. Membr. Sci. 531 (2017) 122-128.
Y. Liao, C. Loh, R. Wang, A. G. Fane, Electrospun Superhydrophobic Membranes with Unique Structures for Membrane Distillation, ACS Appl. Mater. Interfaces 2014, 6, 16035-16048.
Z. Caineng, Unconventional petroleum geology, Shale gas, London: Elsevier (2013) 149-190.
Z. Ma, Y. Hong, L. Ma, M. Su. Superhydrophobic membranes with ordered arrays of nanospiked microchannels for water desalination. Langmuir, 25 (2009), 5446-5450.
Z. Q. Dong, B. J. Wang, X. H. Ma, Y. M. Wei, Z. L. Xu, FAS Grafted Electrospun Poly (vinyl alcohol) Nanofiber Membranes with Robust Superhydrophobicity for Membrane Distillation, ACS Appl. Mater. Interfaces 7(2015) 22652-22659.
Z. Wang, J. Jin, D. Hou, S. Lin. Tailoring surface charge and wetting property for robust oil-fouling mitigation in membrane distillation. J. Membr. Sci., 516 (2016), 113-122
Z. Wang, S. Lin. Membrane fouling and wetting in membrane distillation and their mitigation by novel membranes with special wettability. Water Res., 112 (2017), 38-47.
Z. Wang, S. Lin. The impact of low-surface-energy functional groups on oil fouling resistance in membrane distillation. J Membr Sci, 527 (2017), 68-77.
Z. Xue, M. Liu, L. Jiang, Recent developments in polymeric superoleophobic surfaces, J. Polym. Sci. B Polym. Phys. 50 (2012) 1209-1224.

1. A membrane for membrane distillation comprising a microporous mat of electrospun nanofibers,
wherein the nanofibers are made of a nanocomposite comprising reduced graphene oxide dispersed in a hydrophobic polymer, and
wherein the surface of the nanofibers is grafted with a silane coupling agent or with hydrophobic nanoparticles.

2. The membrane of claim 1, wherein the microporous mat has a surface presenting asperities and reentrant structures, the mat comprising the nanofibers randomly arranged in an interconnected open microporous structure.

3. (canceled)

4. (canceled)

5. (canceled)

6. The membrane of claim 1, wherein the reduced graphene oxide is in the form of single-layer reduced graphene oxide nanosheets.

7. (canceled)

8. (canceled)

9. (canceled)

10. The membrane of claim 1, wherein the hydrophobic nanoparticles are silica nanoparticles with a silane coupling agent grafted on the surface of the silica nanoparticles.

11. The membrane of claim 1, wherein the silane coupling agent, grafted on the surface of the nanofibers or on to the surface of the nanoparticles, is of formula Rₘ—Si—Xₙ, wherein:
R is alkyl, alkenyl, haloalkyl, or haloalkenyl,
X is alkoxy or halogen, and
m and n are integers between 1 and 4, such that m+n=4.

12. (canceled)

13. (canceled)

14. (canceled)

15. (canceled)

16. The membrane of claim 1, wherein the silane coupling agent is perfluorooctyltriethoxysilane (POTS), dimethyldichlorosilane (DDS), vinyltrimethoxysilane (VTS), methyltriethoxysilane (MTES), perfluorododecyltrichlorosilane, or perfluorodecyltrimethoxysilane.

17. A method of manufacturing the membrane for membrane distillation of claim 1, the method comprising:
a) electrospinning a dope solution of the hydrophobic polymer in which the reduced graphene oxide is suspended to produce the mat of electrospun nanofibers, and
b) grafting the silane coupling agent or the hydrophobic nanoparticles on the surface of the nanofibers.

18. (canceled)

19. The method of claim 17, wherein step b) comprises:
immersing the mat of electrospun nanofibers in a solution of the silane coupling agent or in a suspension of the hydrophobic nanoparticles and allowing grafting on the surface of the nanofibers,
rinsing, and
heating to complete grafting on the surface of the nanofibers.

20. (canceled)

21. A membrane distillation process comprising the steps of:
a) providing a membrane for membrane distillation as defined in claim 1,
b) contacting a heated feed containing water with the membrane, thereby causing diffusion of water vapor from the feed through the membrane into a condensation chamber, and
c) condensing the water vapor in the condensation chamber.

22. A forward osmosis membrane comprising a microporous support layer and a rejection layer formed on one side of the support layer,
wherein the support layer is a microporous mat of electrospun nanofibers,
wherein the nanofibers are made of a nanocomposite of hydrophilic nanoparticles dispersed in a hydrophilic polymer, and
wherein the rejection layer is made of nanocomposite of hydrophilic nanoparticles dispersed in a crosslinked meta-aramid of formula (I):

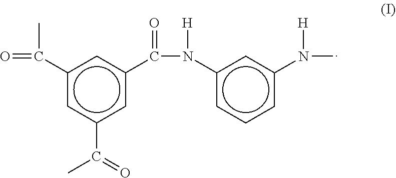

23. The forward osmosis membrane of claim 22, wherein the rejection layer is interfacially polymerized on the support membrane.

24. (canceled)

25. The forward osmosis membrane of claim 22, wherein the support layer has a porosity of more than 90%.

26. (canceled)

27. (canceled)

28. (canceled)

29. The forward osmosis membrane of claim 22, wherein the hydrophilic nanoparticles are graphene oxide, montmorillonite, carboxylated gold, carboxylated silver, zinc oxide, titanium dioxide, or silica nanoparticles.

30. (canceled)

31. A method of manufacture of the forward osmosis membrane of claim 22, the method comprising:
a) electrospinning a dope solution of the hydrophilic polymer in which the hydrophilic nanoparticles are suspended, thereby forming the support layer, and
b) forming the rejection layer on one side of the support layer by interfacial polymerization of one or more aromatic di- or polyfunctional amines and one or more aromatic di- or polyfunctional acyl chlorides in the presence of the hydrophilic nanoparticles.

32. (canceled)

33. (canceled)

34. A forward osmosis process comprising the steps of:
a) providing a forward osmosis membrane as defined in claim 22, the forward osmosis membrane having an active layer side and a support layer side,
b) contacting a feed containing water with the rejection layer side of the forward osmosis membrane, and
c) contacting a draw solution having a salinity higher than the salinity of the feed with the support layer side of the forward osmosis membrane, thereby causing diffusion of water from the feed through the forward osmosis membrane into the draw solution.

35. (canceled)

36. A process for treating a high-salinity and/or high-strength feed, such as fracking wastewater, comprising:
a) subjecting the high-salinity and/or high-strength feed to microfiltration or ultrafiltration to produce a pre-treated feed as a filtrate,
b) subjecting the pre-treated feed to forward osmosis using a draw solution to produce a water-diluted draw solution, and
c) subjecting the water-diluted draw solution to membrane distillation to produce water and regenerate the draw solution.

37. The process of claim 36, wherein step a) comprises:
a.1) providing a microfiltration or ultrafiltration membrane, and
a.2) contacting the high-salinity and/or high-strength feed with one side of the microfiltration or ultrafiltration membrane and applying pressure to the feed so that materials to be separated from the feed pass through said microfiltration or ultrafiltration membrane as said filtrate.

38. (canceled)

39. The process of claim 36, wherein step b) comprises:
b.1) providing a forward osmosis membrane having a rejection layer side and a support layer side, and
b.2) contacting the pre-treated feed with the rejection layer side of the forward osmosis membrane, and
b.3) contacting a draw solution having a salinity higher than the salinity of the pre-treated feed with the support layer side of the forward osmosis membrane, thereby causing diffusion of water from the feed through the forward osmosis membrane into the draw solution and producing the water-diluted draw solution.

40. (canceled)

41. The process of any one of claims 36 to 40, wherein the draw solution is an aqueous sodium propionate (NaP) solution.

42. The process of claim 36, wherein step c) comprises:
c.1) providing a membrane for membrane distillation,
c.2) heating the water-diluted draw solution,
c.3) contacting the water-diluted draw solution with the membrane for membrane distillation, thereby causing diffusion of water vapor from the water-diluted draw solution through the membrane into a condensation chamber, thereby regenerating the draw solution, and
c.4) condensing the water vapor in the condensation chamber, thereby producing water.

43. (canceled)

44. The process of claim 36, further comprising the step of reusing the draw solution regenerated in step c) in the forward osmosis treatment of step b).
